(19) United States
(12) Patent Application Publication
(10) Pub. No.: US 2005/0144114 A1
(43) Pub. Date: Jun. 30, 2005

(54) System and method for providing global information on risks and related hedging strategies

(76) Inventors: Thomas P. Ruggieri, New York, NY (US); David K. Bradford, Bedford, NY (US); Edward Forer, Chicago, IL (US)

Correspondence Address: SOFER & HAROUN LLP., 317 MADISON AVENUE, SUITE 910, NEW YORK, NY, 10017, US

(21) Appl. No.: 10/949,112

(22) Filed: Sep. 24, 2004

Related U.S. Application Data
(63) Continuation of application No. 09/969,493, filed on Oct. 1, 2001, now abandoned.
(60) Provisional application No. 60/242,483, filed on Sep. 30, 2000.

(51) Int. Cl. G06F 17/60

(52) U.S. Cl. 705/37; 705/38

(57) ABSTRACT

The present invention provides a system and method for information and data aggregation and analysis which provides risk managers, benefits managers, brokers, insurers and other insurance professional to have access to information resources, knowledge management tools, and powerful analytical models needed to increase their value and productivity. In accordance with one embodiment of the invention, the system and method provided is designed for information and data aggregation that allows for the compilation of data for mining and categorization by a knowledge management system, which stores all retrieved information in accordance with categories provided by a categorization engine referred to as a Taxonomy module. A contextualization module is configured to retrieve relevant information, based on various factors, including the user's profile, and the user's particular task. The system dynamically provides relevant information as the user interacts and conducts various tasks. The stored information is analyzed by a concept clustering module, so that various concepts relating to a particular topic can be uncovered and stored. In accordance with another embodiment of the invention, the system provides for various analytical tools that allow users to carry on with highly complex analysis of insurance related topics. The range of available analytical tool dynamically varies based on the user's needs and research topics. In accordance with yet another embodiment of the invention, the system provides for a unique interactive workspace that combines the features explained above in a logical manner. To this end, the system interface provides for various job templates, so as to enable the user's to carry various projects by a template driven task assignments. As the user navigates through the workspace, the range of available information to the user changes, based on the user's profile and navigation pattern.

This application is a Continuation Application of U.S. patent application Ser. No. 09/969,493, filed on Oct. 1, 2001, which in turn claims the benefit of priority from U.S. Provisional Patent Application No. 60/242,483, filed on Sep. 30, 2000, the entirety of which are incorporated herein by reference.

### FIELD OF THE INVENTION

This invention relates to a system for retrieving and processing information related to a specified industry so as to provide subject specific information and analytical tools, for example to the insurance industry.

### BACKGROUND OF THE INVENTION

Although, the technology underlying information gathering has drastically advanced within the past decade, there are many industries that have not benefited from such advances. In the fields of insurance and risk management, and in the related fields of information gathering for insurance and risk management, there are currently no systems in place today that provide all of the necessary information, services and tools necessary for the insurance industry. There are many sources of information available to members of the insurance industry, however, these sources are not well integrated, nor are they organized so as to provide a comprehensive tool risk management officers. Furthermore, there are also many sources of invaluable information that up to now have not been available to the members of the insurance industry.

Survey data confirms that clients are dissatisfied with the current level of service and information that they receive from agents, brokers, and underwriters. Various publications have also documented client's desire for new services.

The current products available to the industry suffer from low service quality, low client workspace enhancements, no standardization and no automation. Furthermore, these systems also suffer from lack of standardization, and high costs. Recently, some on-line products have become available. However, they also suffer for failure to support complex insurance products, and lack of capability to intelligently gather relevant information and process it in accordance with clients' needs.

Various members of the industry including but not limited to risk managers, benefits managers, brokers, insurers and other insurance professionals require information resources, knowledge management tools, and analytical models to increase their value and productivity. Advisory services via the world-wide-web are needed to inform customers of current industry trends, events and financial alternatives. Additionally, up-to-date portfolio evaluations, greater exposures details and wider access to the risk environment permits more exactly priced and newer products for insurance companies to provide to their clients. Thus, there is a need for an improved system that provides comprehensive information and analytical and administrative tools to professionals, specifically those involved in the insurance industry.

### SUMMARY OF THE INVENTION

The present invention looks to provide advantages over the currently available services by integrating into a single system, the ability to access all of the available information on risk management in any given field by providing a data-base which stores and analyzes risk management data from a large quantity of sources.

The present invention provides a system and method for information and data aggregation and analysis which provides risk managers, benefits managers, brokers, insurers and other insurance professional to have access to information resources, knowledge management tools, and powerful analytical models needed to increase their value and productivity. The system provides a means for insurance industry professionals, to access current industry trends, financial alternatives and advisory services. The system also provides a means for accessing up-to-date portfolio valuations, exposure details and access to the risk environments. This system and method provides users with a novel full spectrum of administrative, information, and knowledge tools.

In accordance with one embodiment of the invention, the system and method provided is designed for information and data aggregation that allows for the compilation of data for mining and categorization by a knowledge management system, which stores all retrieved information in accordance with categories provided by a categorization engine referred to as a Taxonomy module.

In accordance with another embodiment of the invention, the process of gathering information extends beyond, traditional on-line sources. Thus, the system is configured to access private and semi-private databases to gather relevant information from various organizational resources.

The stored information can be retrieved in accordance with various embodiments of the invention. Therefore, in accordance with one embodiment of the invention, a contextualization module is configured to retrieve relevant information, based on various factors, among other things, including the user's profile, and the user's particular task at any time the system is employed. As such, the system dynamically provides relevant information as the user interacts and conducts various tasks.

The stored information is also analyzed by a concept clustering module, so that various concepts relating to a particular topic can be uncovered and stored. The concept clustering module is configured to analyze specific word patterns to uncover concepts that originally were not known to have a relationship with the underlying user's search. These uncovered concepts can be employed to enhance the taxonomy module as the system continues to adapt by increased usage.

In accordance with another embodiment of the invention, the system provides for various analytical tools that allow users to carry on with highly complex analysis of insurance related topics. The range of available analytical tool dynamically varies based on the user's needs and research topics.

In accordance with yet another embodiment of the invention, the system provides for a unique interactive workspace that combines the features explained above in a logical manner. To this end, the system interface provides for various job templates, so as to enable the user's to carry various projects by a template driven task assignments. As the user navigates through the workspace, the range of available information to the user changes, based on the user's profile and navigation pattern.

### BRIEF DESCRIPTION OF THE DRAWINGS

FIG. 1a illustrates a block diagram of an information management system in accordance with one embodiment of the invention.

FIG. 1b illustrates a block diagram of various components of a knowledge management module in accordance with one embodiment of the invention.

FIG. 1c illustrates a block diagram of an information management system in accordance with another embodiment of the invention.

FIGS. 2a-2d illustrate block diagrams of various data sources employed by information management system and different interfacing arrangements in accordance with one embodiment of the invention.

FIG. 3a illustrates a query definition table used by the taxonomy module that defines a query related to a category in accordance with one embodiment of the invention.

FIG. 3b illustrates a flow chart that defines the guidelines for defining a search query for a given category in accordance with one embodiment of the invention.

FIG. 4 is a block diagram of a contextualization module in accordance with one embodiment of the present invention.

FIG. 5a illustrates a user graphical interface as displayed by the knowledge management system in accordance with one embodiment of the present invention.

FIG. 5b illustrates an advanced search page in accordance with one embodiment of the invention.

FIG. 6 illustrates a concept clustering process in accordance with one embodiment of the invention.

FIGS. 7a and 7b illustrate the steps in the workflow provided in response to a user selecting a claims and loss analysis template in accordance with one embodiment of the invention.

FIGS. 8a and 8b illustrate the steps in the workflow provided in response to a user selecting a mergers and acquisitions template, in accordance with one embodiment of the present invention.

FIGS. 9a and 9b illustrate the steps in the workflow provided in response to a user selecting a renewal of insurance template, in accordance with one embodiment of the invention.

FIGS. 10a and 10b illustrate a workspace and more specifically, a key practice portion 304, after a user selects exposure analysis template in FIG. 5a, in accordance with one embodiment of the invention.

FIG. 11 illustrates a workspace and more specifically, a key practice portion 304, after a user selects client research template in FIG. 5a in accordance with one embodiment of the invention.

FIG. 12 illustrates a workspace and more specifically, a key practice portion 304, after a user selects new product development template in FIG. 5a, in accordance with one embodiment of the invention.

FIG. 13 illustrates a workspace and more specifically, a key practice portion 304, after a user selects the reference button of FIG. 5a, in accordance with one embodiment of the invention.

FIG. 14 is a block diagram of various components of an analytical module in accordance with one embodiment of the invention.

FIG. 15 is a block diagram of various components of administrative efficiency tool module, in accordance with one embodiment of the invention.

FIG. 16 illustrates an exemplary coverage chart for a single period specified by the user, in accordance with one embodiment of the invention.

FIG. 17 illustrates an exemplary coverage chart for a multiple period single insurance program specified by the user in accordance with one embodiment of the invention.

FIG. 18 illustrates an exemplary coverage chart for a single period portfolio insurance view in accordance with one embodiment of the invention.

FIG. 19 illustrates the format that user policy data input module collects insurance information from the user, and the format that illustrates the graphic displays in accordance with one embodiment of the invention.

FIG. 20 illustrates a work space for look up table comparison function in accordance with one embodiment of the invention.

FIG. 21 illustrates an example of a look up table that enables the user to view a treatment of a topic in all available jurisdictions in accordance with one embodiment of the invention.

### DETAILED DESCRIPTION OF THE DRAWINGS

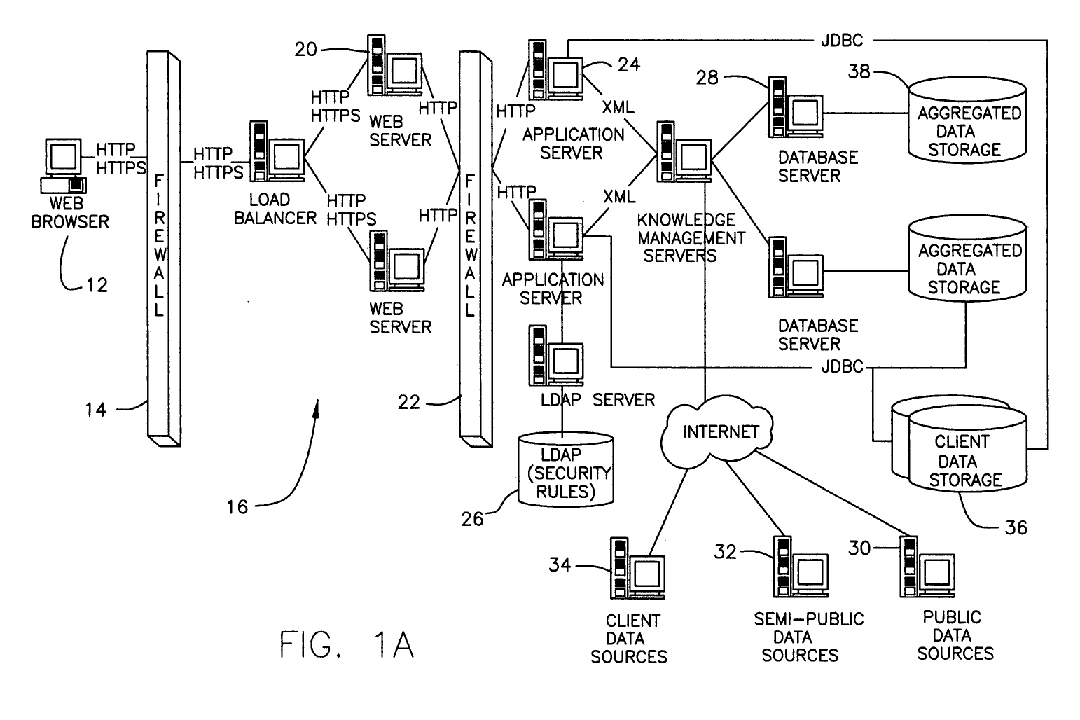

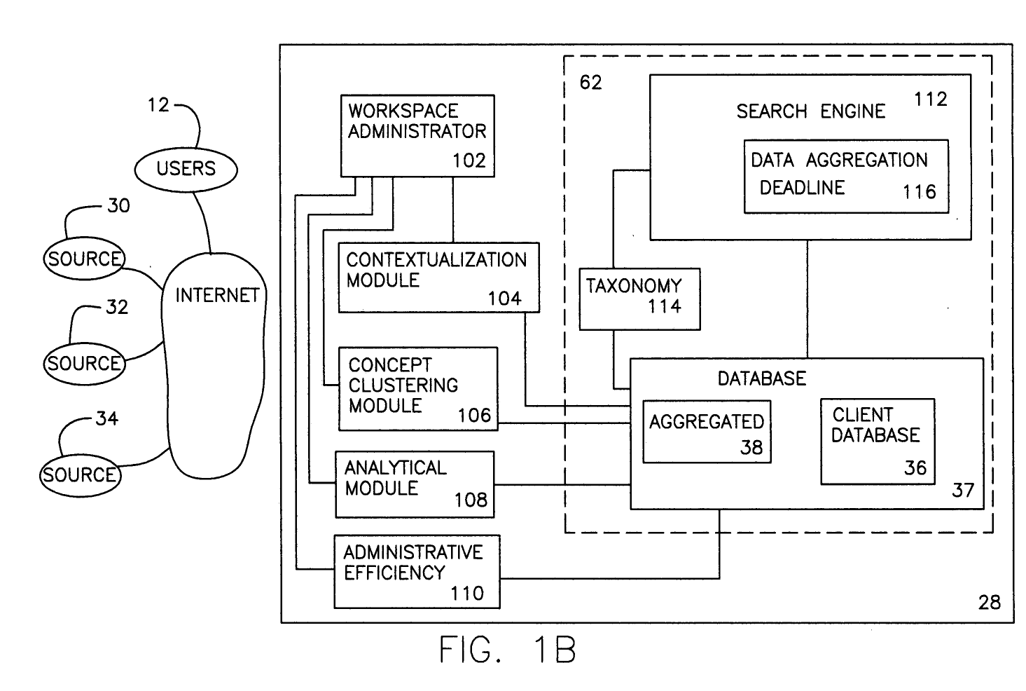

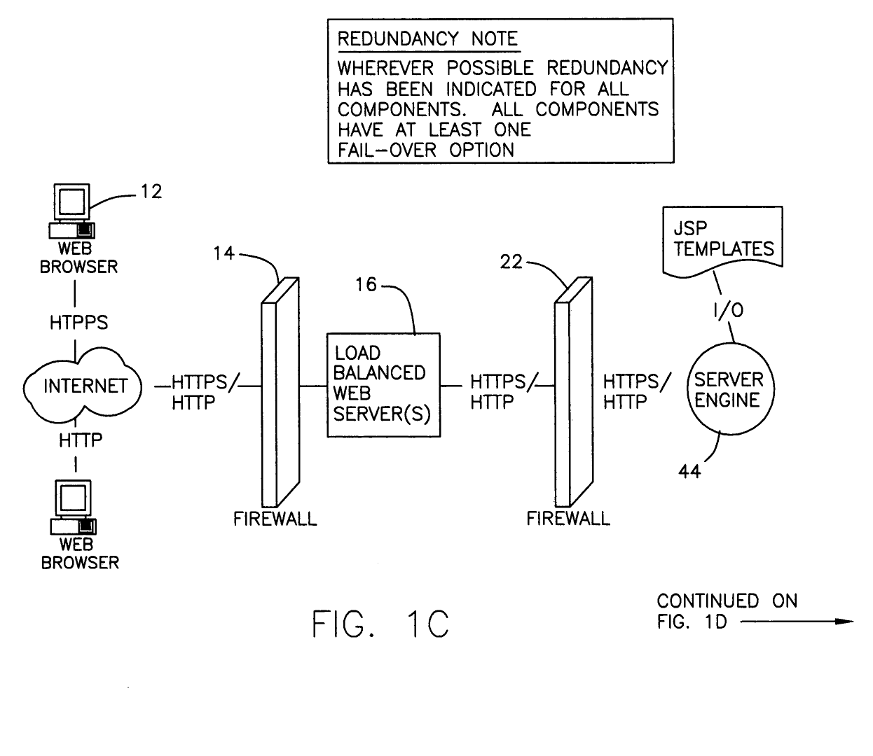

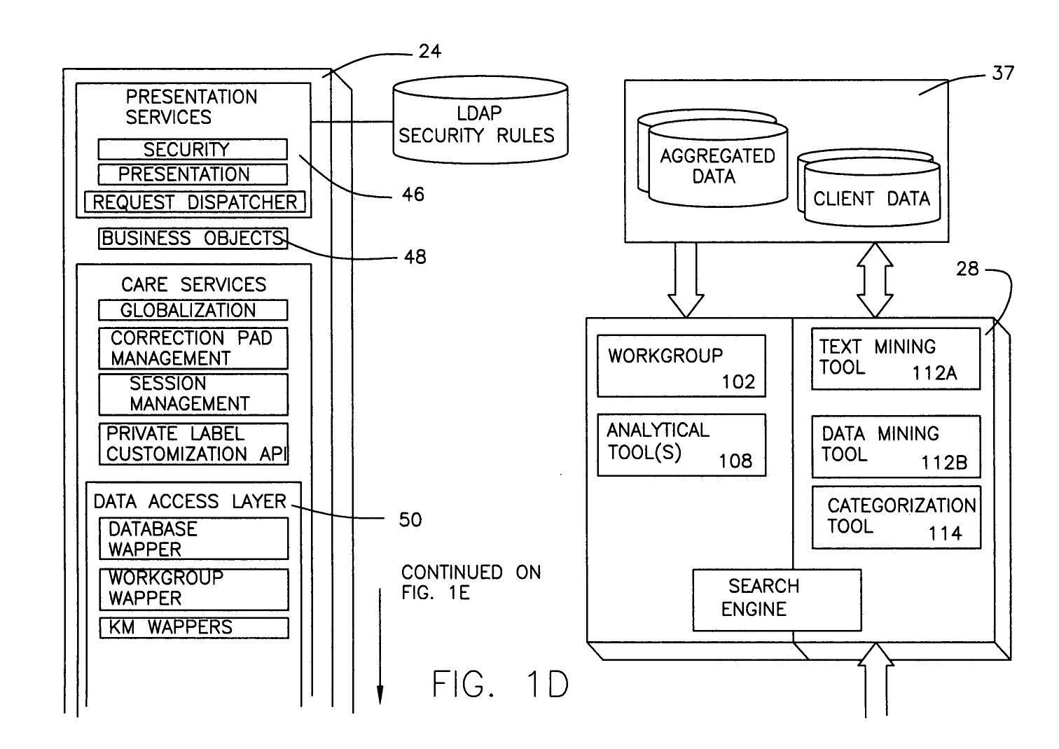

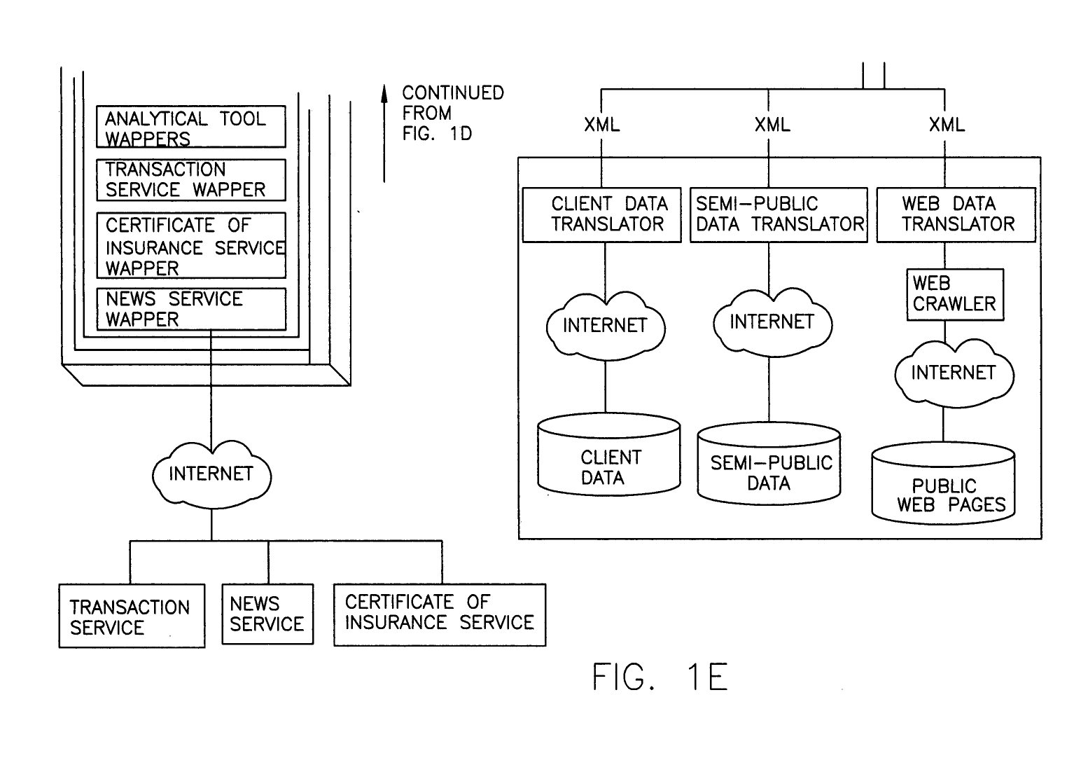

In accordance with one embodiment of the invention, as illustrated in FIG. 1a, an information management system 10 enables users to collect and access all data necessary for their business from a centralized location. As such users can perform searches and conduct research. System 10 also enables users to employ additional analytical tools, based on the research they are conducting. System 10 also enables users to employ administrative tools to automate their entire insurance processes.

Also, system 10 provides an information and data aggregation capability that allows for the compilation of the data for mining and categorization by a knowledge management module. The combination of these services in conjunction with the formed partnerships with current on-line service offerings make the present invention a unique and novel approach to the providing of full spectrum administrative, information and knowledge tools.

In one embodiment of the present invention, as illustrated in FIG. 1a, an overview of the structure of the system includes a user web browser 12 connected to a web server via HTTP or HTTPS connection, through a first fire wall 14. Within the web server area 16 the initial communication is received at a load balancing module 18, which directs web traffic to one of a plurality of web servers 20.

Next, web server 20 directs communications through a second firewall 22 and into the main processing and data storage area of the system. Communications are first received at an application server module 24. An LDAP (Lightweight-Directory-Access-Protocol) server 26 is attached to application server modules 24 to control login applications of the clients. After the communications are processed by application server module 24, the communications are directed to a knowledge management server module 28. Knowledge management server module 28 maintains control over the flow of information into and out of system 10.

In the case of entering new data, knowledge management server module 28 is connected to the Internet and thus to public data sources 30, semi-public data sources 32 and client data sources 34. These data sources provide information via Internet to knowledge management server module 28, so as to store processed information in data storage units 36 and aggregated data storage units 38.

In the case of information retrieval at the request of a user, knowledge management server module 28 connects to a database server module 40, which acts an intermediary between data storage modules 36, 38 and knowledge management server module 28. The database server module 40 searches the appropriate data storage module 36, 38 and retrieves the requested information and sends it to knowledge management server module 28. Although the storage modules appear as single units in FIG. 1a any amount of actual components used to store aggregated data or client data is within the contemplation of the present invention.

In accordance with one embodiment of the present invention system 10 includes a system wide server configuration with conventional storage systems for data storage and access that satisfies the load and bandwidth requirements. Examples of such storage systems include Storage Area Network (SAN) and Network Attached Storage (NAS). NAS refers to the use of a large amount of fiber channel RAIDS (Redundant Array of Independent Disks) on a system and sharing the data either through NSF (Network File System) or database access. The use of either SAN or NAS is within contemplation of this invention. Preferably, the network is organized as RAID 5, to support the transport of and access to the large data sheets.

Furthermore the operating system of system 10 uses any operating system, which meets the system's requirements. In one embodiment of the present invention the operating system is a UNIX operating system.

In one embodiment of the present invention, the implementation language of system 10 is Java, running on a Java 1.2×compliant Java Virtual Machine (JVM). Alternatively, Java 1.1x can be used with the option to upgrade to Java 1.2x. The web content is written in JSP (Java Script Protocol), which contains embedded HTML (Hyper-Text-Markup-Language) text along with JSP scripting commands for populating the page with dynamic content. Oracle's PL/SQL (Programming Language/Structured Query Language) is preferably used for database administration purposes on the database server modules. However, any implementation language, which fulfills the requirements of system 10, is within the contemplation of the present invention.

In the present invention, web server area 16 consists of multiple web servers 20 with the flow of traffic controlled by way of a load-balancing module 18. Web server area 16 is preferably disposed between first and second firewalls 14, 22 such that web server area 16 is separated from outside web traffic by way of first firewall 14, and it also separated from the system hardware by way of second firewall 22. First firewall 14 allows only HTTP, HTTPS, S-HTTP, and FTS (File Transfer Protocol) through to web server area 16. Second firewall 22 allows only IP addresses of web servers 20, possibly routing requests from a single user to same web server 20 to simplify session management. A servlet (not shown) works to interface between web servers 20 and application server modules 24 in JSP (Java Script Protocol).

Application server modules 24 serve two primary functions, session management and connection management. Session management is useful for access control and achieving state in an otherwise stateless environment. Connection management is for keeping a pool of resource connections (such as databases), useful for performance applications maintained by the system and providing the interface between the system and web servers 20.

As illustrated in FIG. 1c, application server 24 is described in more detail. Application server 24 includes presentation services modules 46, business objects module 48, data access layer module 50 in accordance with one embodiment of the invention. Application module 46 is configured to handle presentation services, including: security module, presentation module and the request dispatcher. Business objects module includes: core services, globalization module, connection pool management and session management. Data access layer module 50 includes: database wrapper, workgroup wrapper, knowledge management wrapper, analytical wrappers, transaction service wrappers, and new service wrappers. In addition to these modules the application server modules include direct outside Internet connections to transactional services and news services.

FIG. 1b illustrates a block diagram of a knowledge management system 28 in accordance with one embodiment of the invention, although the invention is not limited in scope in that respect. As mentioned before, knowledge management system 28 is coupled to users 12 and data sources 30 through 34 via the Internet.

System 28 includes a search engine 112 that is configured to search information based on search queries provided to it. Search engine 112 includes a data aggregation module 116, which is configured to access various type of data sources, such as sources 30, 32 and 34.

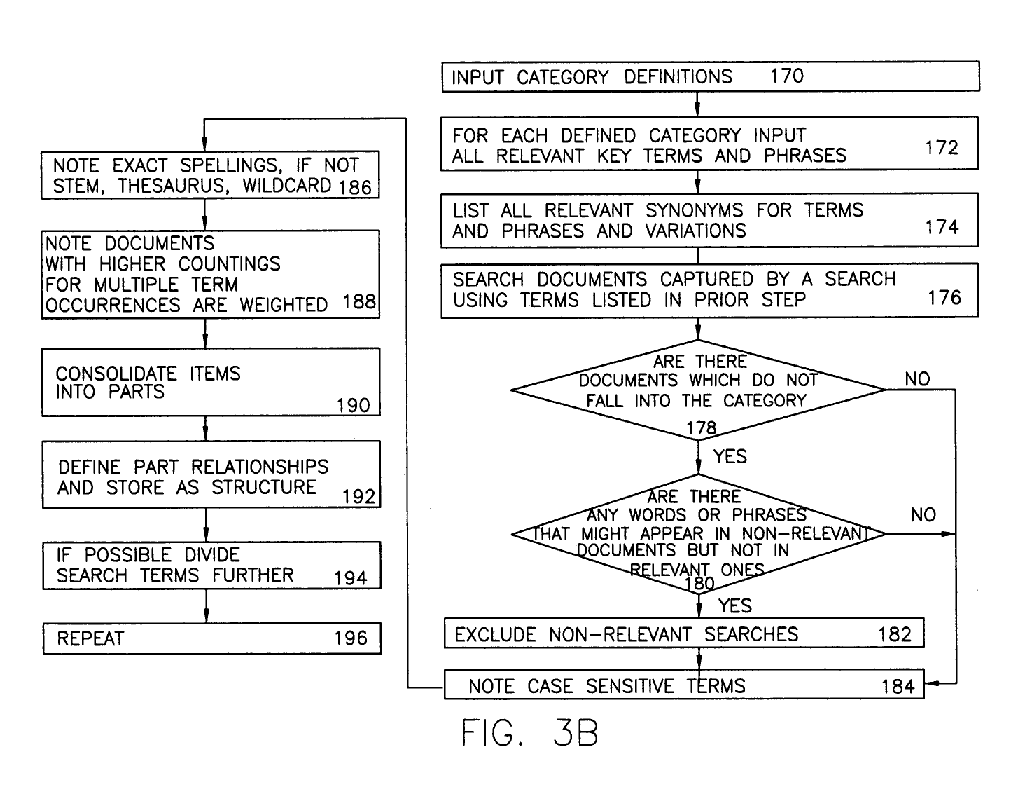

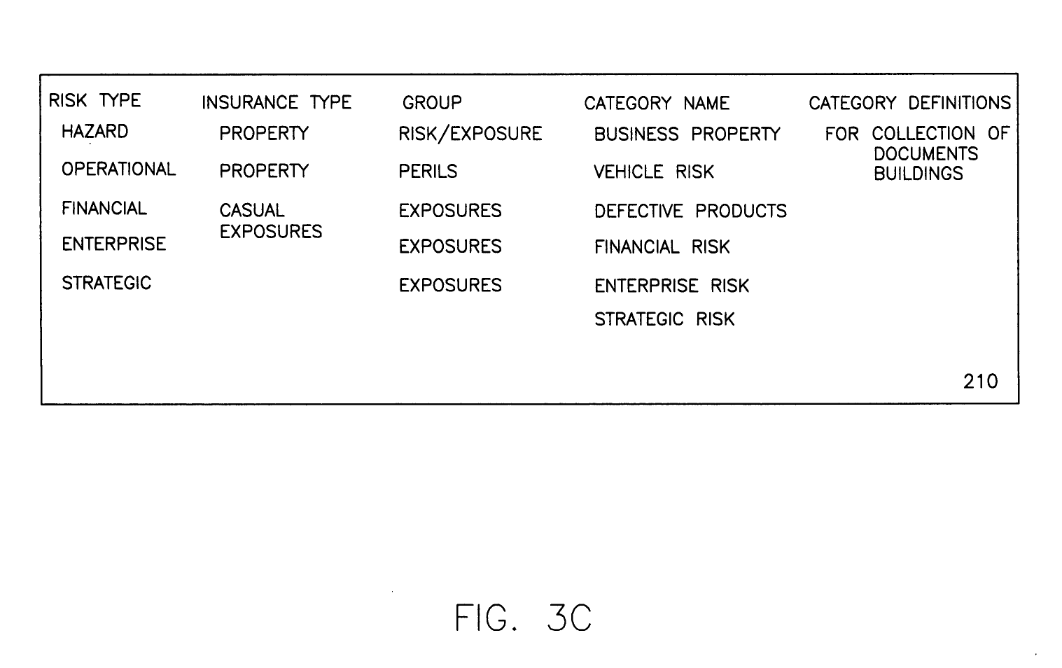

A taxonomy module 114 is coupled to search engine 112. Taxonomy module 114 is configured to store a list of categories related to the information collected and maintained by knowledge management system 28, as will be explained in more detail in reference with FIG. 3 and Appendix I.

Taxonomy module 114 is coupled to a database 37, which includes aggregated database 38 and client data storage 36. Database 37 stores filtered information as processed via taxonomy module 114.

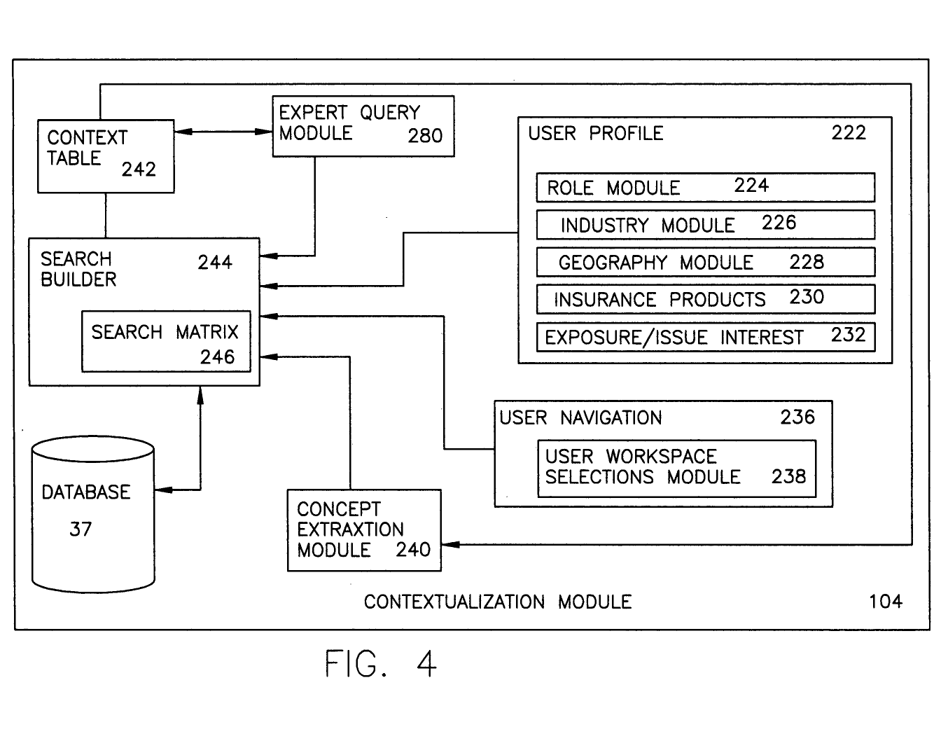

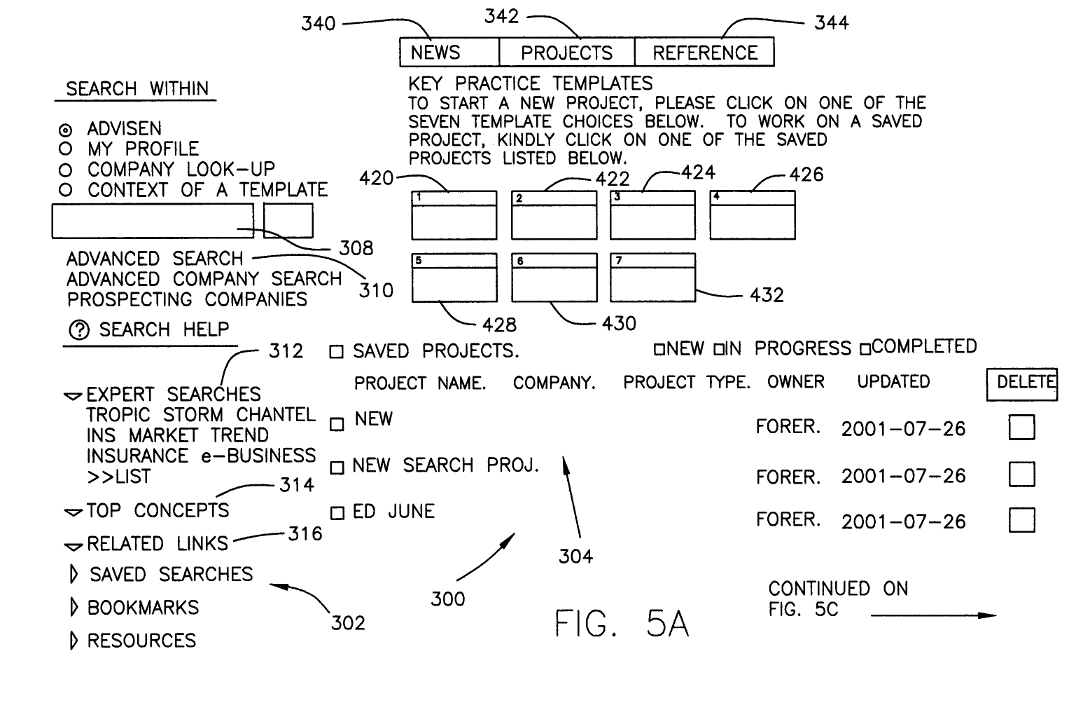

Knowledge management system 28 also includes a contextualization module 104, which is configured to conduct contextual and role based searches as will be explained in more detail later in reference with FIG. 4. Contextualization module 104 generates search queries corresponding to, among other things, the user's profile and user's navigation through the system, such as the page type that the user is viewing, and the prior page the user was viewing. Contextualization module 104 is configured to store all search queries created dynamically during a user's session with knowledge management system 20.

Knowledge management system 28 also includes a concept-clustering module 106 coupled to database unit 37. Concept clustering module is configured to identify top concepts that are present among a group of documents retrieved during a user's research session. Concept clustering module provides information so as to display a specified number of concepts contained and identified within those documents.

Knowledge management system 28 also includes an analytical module 108, coupled to database unit 37. The analytical module is configured to perform various analytical functions, such as property and casualty benchmarking, company comparisons, insurance financial analysis, league table calculations, risk mapping, risk accounting, claims data, loss triangles, loss development analysis, severity Monte Carlo simulations, financial modeling of cost structure, safety administration reports, engineering reports and financial summary links.

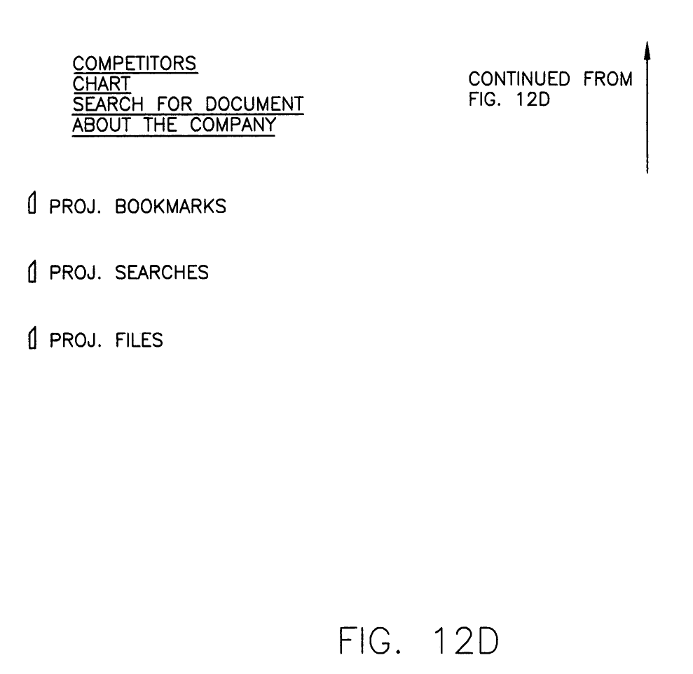

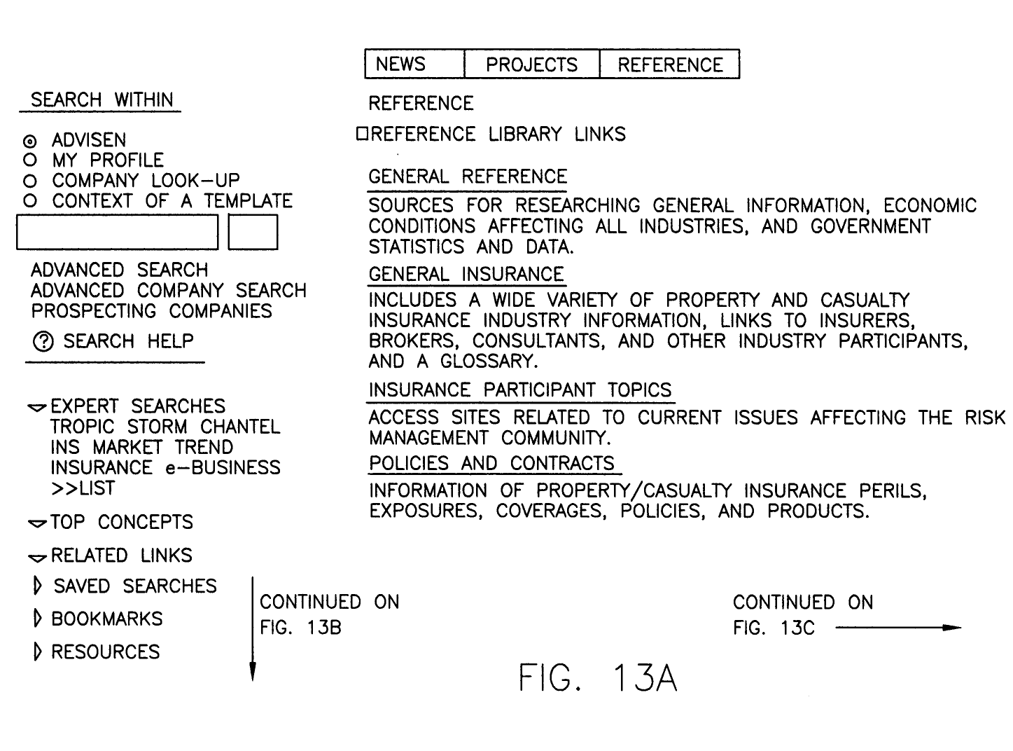

Knowledge management system 28 also includes an administrative efficiency tool module 110, which is also coupled to database unit 37. The administrative efficiency tool module is configured to provide a plurality of chart drawing functionalities that enable the user to asses various insurance programs, as will be explained in more detail in reference with FIG. 15. Module 110 also includes a look-up table processor that enables users to compare various insurance related characteristics in different given jurisdictions. For example, module 110 can provide a look-up chart to a user that desires to compare the rules and regulations relating to captive domiciles arrangements in various jurisdictions, displaying the requirements in each jurisdiction. The look-up processor module is an effective and powerful research tool that provides comparison analysis to users.

Knowledge management system 28 also includes a workspace administration module 102 that is coupled to contextualization module 104, concept clustering module, analytical module 108 and administration efficiency tools module 110. Workspace administration module 102 is configured to control user interface functionalities, including the display of various workspaces on users' terminals, and tracking users' navigation throughout the workspace, dividing the user's terminal into various display portions with corresponding group of interactive commands for users to employ, as will be discussed in more detail.

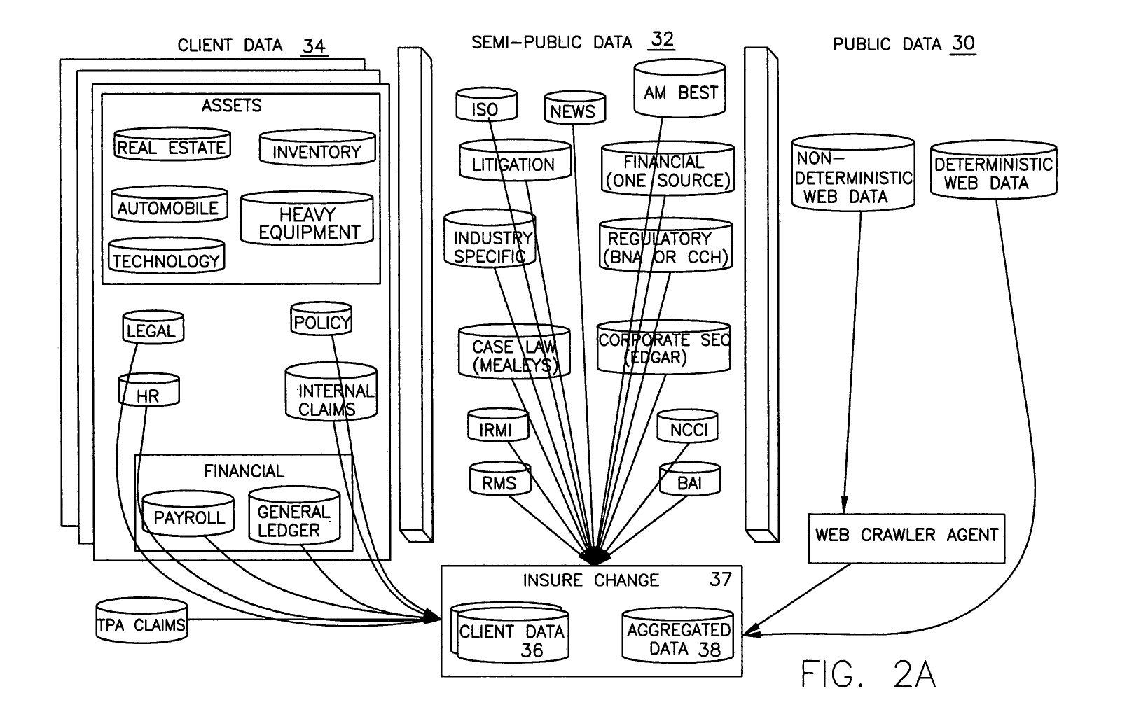

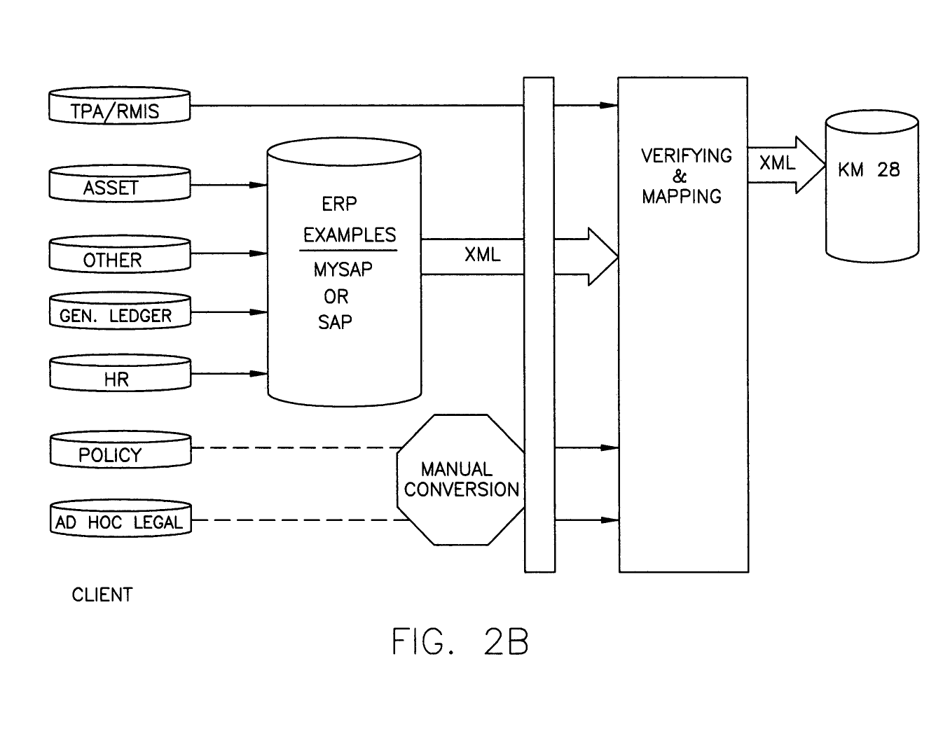

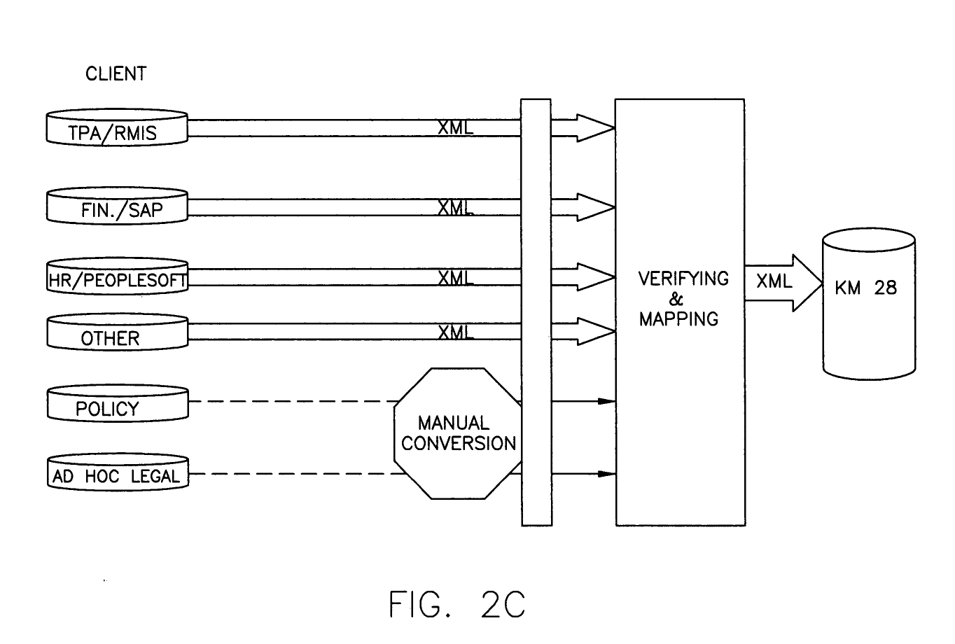

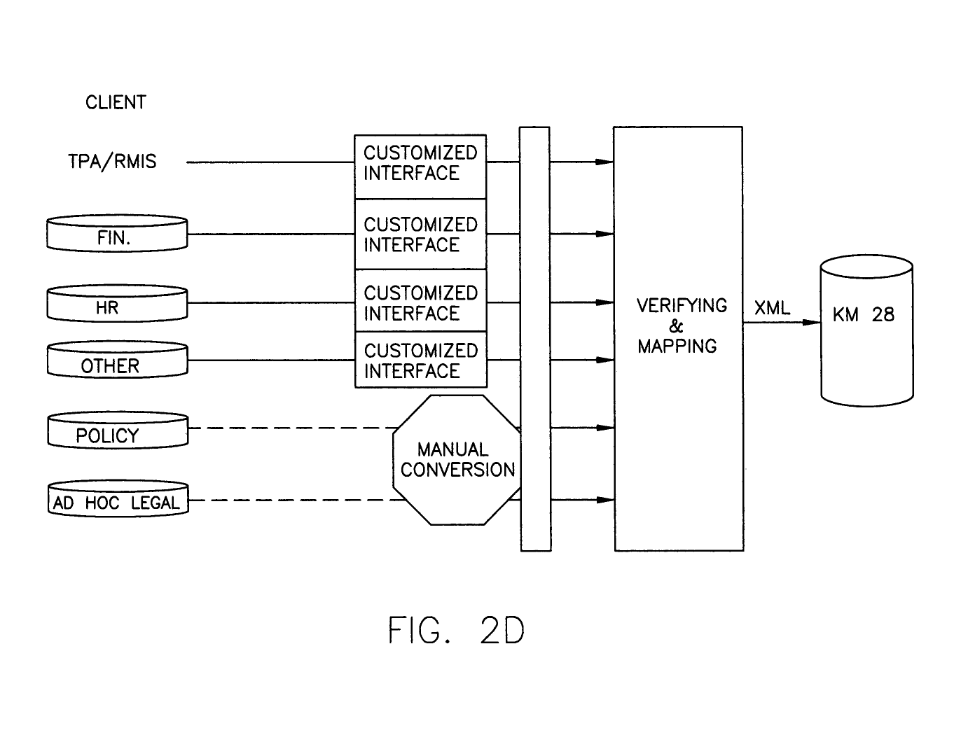

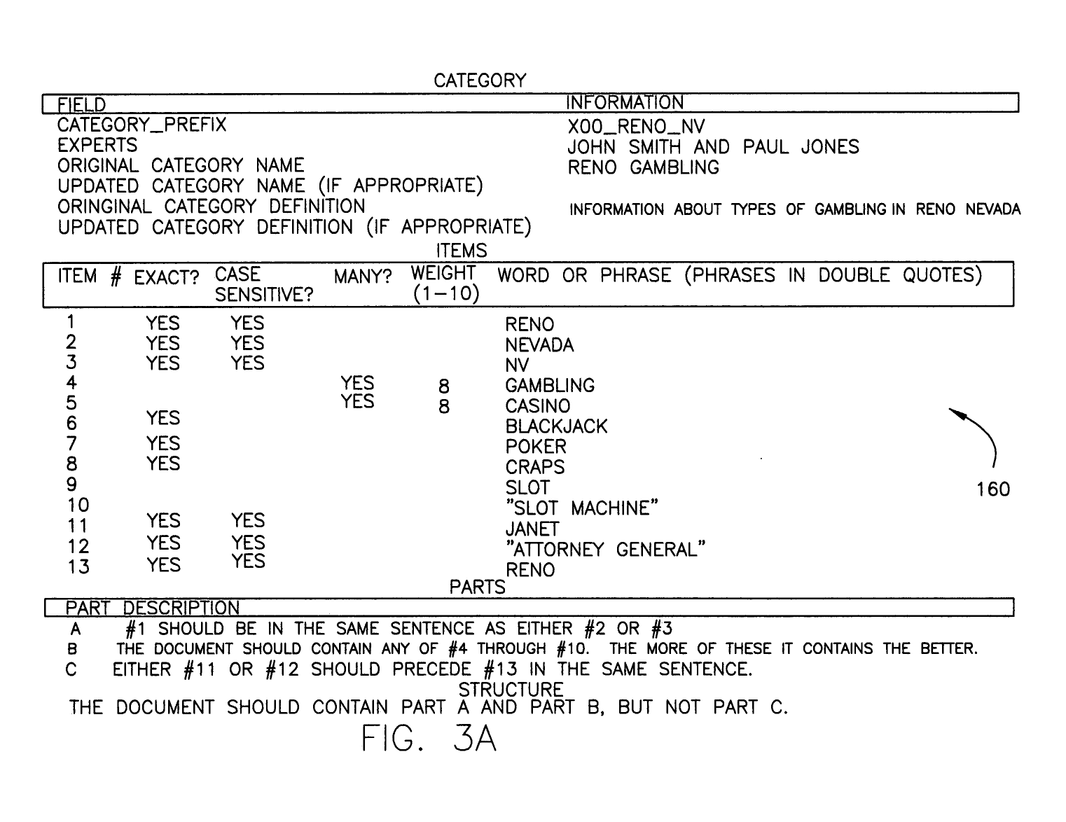

FIG. 2a illustrates a block diagram of various data sources employed by information management system 10. In accordance with one embodiment of the present invention, the data sources are divided into three principal sections, client data 34, semi-public data 32 and public data 30, as illustrated in FIG. 2a.

Client data 34 consists of information derived from the client's own records used to create a client specific database. Information included in this database includes but is not limited to the asset information including: real estate, automotive, inventory, technology and heavy equipment, industry specific material, legal material, policy material, internal claims and human resources information (HR), and financial information including: payroll and general ledger information.

In one embodiment of the present invention, client data 34 is also used to create a collective client information database 36. To increase the amount of source information, system 10 also collects client data not only in a standard client data database, but also it creates a collective database, based on the aggregated data of all clients of the system. To maintain client security and anonymity, the data collective client information database 36 is striped of all client proprietary and confidential material. Therefore database 36 provides an additional source for clients and the system analysts to use for comparisons. The large client data volume of system 10 provides another useful index for analysis, and as more information is gathered by system 10 the usefulness of collective client information database 36 increases.

Semi-public data 32 includes but is not limited to information consisting of news, AM best, litigation, financial (OneSource), Regulatory, (BNA or CCH) case law, corporate SEC (EDGAR), IRMI, NCCI, RMS, and BAI.

Public data sources 30 include non-deterministic web data and deterministic web data, captured through the use of a commercial web crawler agent.

Although FIG. 2a depicts the client data as being stored in separate modules for each different type of information, it is within the contemplation of the present invention to be compatible with clients with data stored in a single ERP system, which would house all of their information.

With regard to client data 34, in one embodiment of the present invention, as illustrated in FIG. 2b, the client has an ERP system which internally combines the clients data regarding TPA/RMIS, Assets, General Ledger, HR, and other materials. This allows system 10 to upload this data from a single source, thus requiring only a single interface with that client. Policy and Ad hoc materials are usually manually converted.

In another embodiment of the present invention, as illustrated in FIG. 2c the client has separate XMLs (extensible Markup Language) for each of its data types. Because the client has not already integrated its own data into a ERP. In this case each XML transfer will require a separate port for data transfer to system 10, and possibly requires mapping and translating from the clients XML to system 10 XML.

In another embodiment of the present invention, as illustrate in FIG. 2d, the client has neither an ERP system or an XML interface to its own data. In this case, a customized interface is developed that maps and translates the client data from the client's proprietary formats to system 10 XML.

In system 10, the use of a standard XML (Extensible Markup Language) interface that insures continuity in the client data storage modules. An example of an XML that uses standard XML format is the IFX (Interactive Financial Exchange) developed by by ACORD. The EDI (Electronic Data Interchange) specification is called Automation Level 3 (AL3), with mapping between itself and the XML specifications. Other XMLS modules, which can operate in system 10 to properly store client data is within the contemplation of this invention.

In accordance with one embodiment of the invention, system 10 communicates with data storage modules via (JDBC) Java Database Connectivity, as well the use of an object to relational mapping tool for avoiding SQL (Structured Query Language) in the application code.

In one embodiment of the present invention, system 10 provides the ability for users to share data and track tasks. In the insurance industry, data is often shared between client and broker and within the client organization via paper or verbal communication. The present invention provides an electronic medium for more efficient communication through the use of a workgroup/workflow or collaboration software tool 48. System 10 provides the capability for implementing insurance recommendations, to track the recommendation form to its introduction through the client modifications to the impact on risks and insurance. Although the software used for workgroup/workflow software 48 preferably supports Java API (Application Protocol Interface), any such workgroup/workflow software 48 used to facilitate group projects that is found compatible with system 10 is within the contemplation of this invention.

The operation and functionality of knowledge management system 28 is described in more detail hereinafter. It is noted that in accordance with one embodiment of the invention, search engine 112 is configured to locate information on specific topics from web sites on the Internet, and other semi-public and private sources as explained before. In accordance with one embodiment of the invention, system 28 employs search engine 112 to search all available resources for any topic related to the insurance industry. Typical search engines include those provided by Inktomi, WebRefiner and Google.

Once data is loaded into system 28 via search engine 112, data aggregator module 116 normalizes the data so that it is compatible with database 37 specifications. The data obtained by engine 112 is then processed via taxonomy module 114, which categories each document based on categories contained in the taxonomy module.

The categories in the taxonomy module are related to the types of products that business, organizations and individuals desire to hedge associated risks. These risk, include among other things, hazard risks, such as property and casualty losses; operational risks, such as breakdown in business processes or operations; Financial risks, such as capital market fluctuations, or loan defaults; and strategic risks, such as product marketing failures, or new product development failures.

In accordance with one embodiment of the invention, taxonomy 114 includes approximately 300 insurance-related categories. It is appreciated by those skilled in the art that category definitions in taxonomy 114 may expand over time. Although the taxonomy has more than one level (it is hierarchical, not flat), “categories” are only defined at the lowest level (the “leaves” of the “tree”). Higher levels of the taxonomy are only used for organizational purposes.

Thus, for example, if a taxonomy had a hierarchy:

| Level 1 | Level 2 | Level 3 |
|---|---|---|
| Sports | Baseball | Minor League Baseball |
| | | Major League Baseball |
| | Football | College Football |
| | | Professional Football |

Then only the categories at level 3 are true “categories” that require a definition. The other levels would simply be used for organizational purposes.

Further, the information in taxonomy module 114 is overlapping, not orthogonal. Thus, a low-level category could fit into more than one place in the hierarchy. For example, the taxonomy could include the following high-level categories: “Sports” and “Education,” and “College Football” would fall into both categories (either directly or indirectly).

As documents are fed into system 28 via search engine 112, they are analyzed and classified into one or more of the categories in the taxonomy. For each category a corresponding rule is created in accordance with one embodiment of the invention. (These are referred to as “rule-based queries.”) For example, a simple rule could be (in lay terms): “If the word ‘environmental’ appears in the same sentence as the word ‘contamination’ in a document, classify the document in the Environmental_Contamination category.

Because the taxonomy module in accordance with one embodiment is focused solely on insurance, a category may bear a close relationship to other categories (for example, long-term disability insurance and short-term disability insurance). For this reason, when developing rules, it is necessary to clearly differentiate each of the categories, in order to minimize potential overlaps.

In accordance with another embodiment of the invention, insurance domain experts develop the substantive foundation for the creation of rule-based queries. As described above, the ultimate format of these queries are used to automatically categorize documents in the applicable insurance categories.

It is noted that various embodiments of the invention have various approaches to automating the categorization of documents. However, in accordance with one embodiment, preferably a rule-based query arrangement is employed. Rule-based queries utilize a Boolean like structure and proprietary grammar, which “define” which documents should be classified in which categories.

Generally speaking, a rule states that if a document contains certain words or phrases then it should be included in a given category. This simple concept—categorizing documents based on the existence of certain terms—is reinforced through the use of modifiers and operators, in which the system examines a number of additional features of search terms and how they appear in a document. These features include:
how often a term appears in a document
whether all of the terms appear
whether any of the terms, or one or more of the terms, appears
how close the terms are to each other
whether the terms appear in a certain order
whether the case of the search terms matches the case of the terms found in the document
whether the precise format of the term is found in the document, or, on the other hand, whether a variation or synonym of the term is found
whether certain terms appear that would cause the document to be excluded from a given category

Further, the ranking of documents must also be considered. Because only a limited number of all of the matching documents are returned to a user (for example, there may be thousands of documents of all of the documents stored by system 28 that contain the words “environmental” and “contamination” in the same sentence, but only 250 will be returned to the user), and because a typical user will only look at the first fraction of all of the returned documents, the documents need to be ranked based on how well they match the category. Thus, each query includes a method for ranking documents by giving each document a numeric confidence rating. This ranking method may include giving greater (or lesser) weight to the existence of certain terms and phrases, and also giving greater weight to the number of appearances each term and phrase makes in a document. This may be coupled with the use of a numeric threshold, which only permits a document to be returned to the user if the document's confidence rating exceeds the threshold.

Other, more generalized considerations also must be taken into account, which varies from category to category. For example, it may be preferable to risk returning many “irrelevant” documents in order to ensure that as many “relevant” documents as possible are returned (this is known as “recall”). Alternatively, it may be preferable to risk not returning many “relevant” documents so that minimum number of “irrelevant” documents are returned (this is known as “precision”).

In accordance with one embodiment of the invention, Verity Query Language (VQL) is the language that is used to create the rule-based queries that are utilized by taxonomy module 114, to analyze and classify documents.

FIG. 3a illustrates a query definition table 160 used by taxonomy module 114 that defines a query related to a category. As illustrated each field in the table relates to a definition of rules that generate a query. As such, each query definition includes a filed that defines the category prefix. Another field of the query definition includes the name of experts who were involved in developing the category and its related search query. A third and forth field define the original category name, and an updated category name correspondingly. Other fields include original category definition and updated category definitions.

Query definition table 160 also includes an item section, which contains all the keyterms and phrases relevant to a category. For each item, a field is provided that identifies the category number. Another field specifies whether a term should be used in its exact format. Yet another field specifies whether the term is case sensitive. Another term specifies whether multiple incidents of the same term exist in the document. Another field specifies the weight associated with a document because of presence of a corresponding term. Another field defines the terms.

Query definition table 160 also includes a parts section, which divides the items into logical parts, each part defining a relationship among its member items.

Finally, query definition table 160 includes a structure section that defines a rule governing the relationship of the parts defined in the part section.

Each query may be composed of the following:
a name for the rule (optional)
a weight (optional)
one or more operators (at least one is required)
one or more modifiers (optional)
the search terms, which can be a word or a sub-rule (at least one is required)

A rule (including a sub-rule) returns a score for every document in every category. The score will be between 0.01 and 1.00 (with 1.00 the highest). If a rule scores a document as 0.00 for a given category, it will be ignored. For a simple rule, a document that satisfies the rule will return a score of 1.00. This score can be adjusted by applying a weight to the search terms or by using the MANY modifier, as described below. For purposes of the example of FIG. 3a, as described below, VQL contains the following classes of operators and modifiers (the use of word in the descriptions below could mean any search term: a word, phrase or sub-rule).

Evidence Operators

WORD word—The WORD operator checks whether the document contains an exact match for word.

STEM word—The STEM operator checks whether the document contains word and its variations (such as plurals, different verb tenses, etc.).

WILDCARD word*—The WILDCARD operator checks whether the document contains word as well as any word which has word as its prefix, such as “disab*”, which would match “disability,” “disabled”, etc. (Other wildcards are permitted, such as ?, which allows a variation for any single character, etc.)

THESAURUS word—The THESAURUS operator checks whether the document contains word as well as certain predefined synonyms of word.

Proximity Operators

NEAR [word1, word2 . . . ]—The NEAR operator checks whether the document contains both word1 and word2 (and any other listed words). If all search terms are located, a score is returned based on how close together in the document the listed words are (the closer together, the higher the score).

NEAR/N [word1, word2 . . . ]—The NEAR/N operator is similar to NEAR, except the listed words must be within N words of each other for the document to match. As for NEAR, if all search terms are located (within N words of each other), a score is returned based on how close together in the document the listed words are.

PARAGRAPH [word1, word2 . . . ]—The PARAGRAPH operator checks whether the document contains both word1 and word2 (and any other listed words) in the same paragraph. Due to limitations on the format of the documents being fed into our system, a paragraph is simply a certain number of words and not a true paragraph.

SENTENCE [word1, word2 . . . ]—The SENTENCE operator checks whether the document contains both word1 and word2 (and any other listed words) in the same sentence.

PHRASE [word1, word2 . . . ]—The PHRASE operator checks whether the document contains both word1 and word2 (and any other listed words) in the same phrase, meaning one directly after the other.

Concept Operators

-Intersection Type

ALL [word1, word2 . . . ]—The ALL operator checks whether the document contains both word1 and word2 (and any other listed words). If all of the words are found, a score of 1.00 is returned.

AND [word1, word2 . . . ]—The AND operator checks whether the document contains both word1 and word2 (and any other listed words). Unlike ALL, the score returned by AND may be adjusted based on the weight given certain search terms and the number of times (using MANY) certain search terms are found in the document.

-Union Type

ANY [word1, word2 . . . ]—The ANY operator checks whether the document contains either word1 or word2 (and any other listed words). If any of the words are found, a score of 1.00 is returned.

OR [word1, word2 . . . ]—The OR operator checks whether the document contains either word1 or word2 (and any other listed words). Unlike ANY, the score returned by OR may be adjusted based on the weight given certain search terms and the number of times (using MANY) certain search terms are found in the document.

ACCRUE [word1, word2 . . . ]—The ACCRUE operator checks whether the document contains either word1 or word2 (and any other listed words). Unlike ANY, the score returned by ACCRUE may be adjusted based on the weight given certain search terms and the number of times (using MANY) certain search terms are found in the document. Unlike OR, the score returned by ACCRUE is further adjusted by the number of terms on the list that appear. Thus, if three words are searched for, documents containing all three words will score higher than documents containing less than three, although documents that contain any of the terms will always return a score above 0.00.

Modifiers

MANY word—The MANY modifier checks whether the document contains word and, if so, returns a score based on the density of that word in the document (i.e., the number of times the word appears divided by the length of the document). Thus, the more times a word appears, the higher the score. If two documents contain word the same number of times, the shorter document will get a higher score, because the word density is greater.

CASE word—The CASE modifier will only match word against a word in the document with the exact case.

NOT word/operator—The NOT modifier will exclude a document if it contains word or the search operator that follows.

ORDER [word1, word2 . . . ]—The ORDER modifier checks whether the document contains both word1 and word2 (and any other listed words) in the order provided, although not necessarily one right next to the other. This is typically used with a proximity operator, to ensure both that a certain order is followed and that the words appear near each other.

Weights

A weight can be applied to sub-parts of a rule to affect the overall score given a document. The weight can be any number between 0.01 and 1.00. By default, the weight of most items is 1.00, but the elements searched for by ACCRUE have a default weight of 0.5.

### Example of a Simple Rule

FIGS. 3a and 3b describe a simple rule that looks for documents that discuss gambling in Reno, Nev., in accordance with one embodiment of the invention. The rule has been named “Reno_Gambling.” Table 3a can be described in accordance to VQL as follows, although the invention is not limited in scope in that respect.

| Reno_Gambling <AND> | |
|---|---|
| (1) | <SENTENCE> |
| | <CASE><WORD> Reno |
| | <ANY> |
| | <CASE><WORD> Nevada |
| | <CASE><WORD> NV |
| (2) | <ACCRUE> |
| | 0.80 <MANY> <THESAURUS> gambling |
| | 0.80 <MANY> <THESAURUS> casino |
| | <WORD> blackjack |
| | <WORD> poker |
| | <WORD> craps |
| | <WILDCARD> slot* |
| | <PHRASE> |
| | <WORD> slot |
| | <STEM> machine |
| (3) | <NOT><ORDER><SENTENCE> |
| | <ANY> |
| | <CASE><WORD> Janet |
| | <PHRASE> |
| | <CASE><WORD> Attorney |
| | <CASE><WORD> General |
| | <CASE><WORD> Reno |

Translated, here is what it is happening: By using the AND operator, the rule is looking to match any document that includes all of (1), (2) and (3). It does not matter how close to each other these three search items are.

Search term (1) is a sentence that includes the word “Reno” with initial cap and either the word “Nevada” with initial cap or “NV” in all caps.

Search term (2) contains a list of gambling terms. We have provided greater weight to terms such as “gambling” and “casino” (the default weight is 0.50, we have provided a weight of 0.80) over more specific forms of gambling. Also, documents that mention “gambling” or “casino” more often will be given a greater weight than those that mention it less often, through the MANY modifier. Notice that we have used the THESAURUS operator for “gambling” and “casino,” so that we pick up synonyms of these terms. For “slot” we have used a WILDCARD, so that words like “slots”, “slotmachine” and “slot-machine” will be caught. We have separately asked to look for the PHRASE “slot machine.” The term “machine” has been STEM-med so that plurals of this term are also retrieved. Also the use of the ACCRUE operator is noted.

Documents that contain more of the terms on the list: gambling, casino, blackjack, poker, craps, slot*, and slot machine, will rank higher than documents that only refer to one or a fewer terms on this list.

Finally, the query definition would not include any documents that actually concern Janet Reno, such as might discuss a crackdown on illegal gambling by the Justice Department. Thus, search term (3) specifies that documents not only need to contain gambling terms and a reference to Reno, Nev., but they may not contain a reference to the word “Janet” with initial cap or the phrase “Attorney General” with initial caps, followed by the word “Reno” with initial cap, with both in the same sentence.

FIG. 3b illustrates a flow chart that defines the guidelines for defining a search query for a given category. Thus, a rule for each category can be written in a search language such as VQL based on the guidelines provided and illustrated in FIG. 3b.

Initially a team of experts are provided with a file, such as Excel containing worksheet templates in the form of table 160 (FIG. 3a) for the categories for which they are responsible. Each worksheet is named with the Category_Prefix for the category, and contains a template that is completed so that it may be later converted into a an appropriate language such as VQL. The template already has certain information filled in, such as the definition of each category from the categories listed in taxonomy module 114.

Taxonomy module 114 begins at step 170 to receive a category name from taxonomy category definitions. For each category, the following steps are taken.

In accordance with one embodiment of the invention during the phase of developing category terms, designers of system 28 consider sample articles and documents that relate to the category. Doing so helps the designers to prepare a substantially complete list of the key words and phrases (and their synonyms) that are found in documents about the category, and gives them more insight into the structure of these documents, such as how often words and phrases are repeated, how close to each other they are found, etc. This process also helps the designers to identify documents that do not fit within the category but that may be found in a key word search.

In accordance with one embodiment of the invention, at step 172, all relevant key terms and phrases are provided. Various ways to locate relevant articles includes the step of performing a search for documents on the Web, each using a different general-purpose search engine (such as Yahoo and Northern Light), or by going to an insurance news Web site (such as www.AIGonline.com, www.insurancenewsnet.com, www.riskandinsurance.com, www.newsre.com, www.Itcnewsandcomment.com, www.disabilitynews.com, www.insurancejrnl.com, www.claimsmag.com, www.propertyandcasualty.com, www.re-world.com, etc.), based on the defined key terms and phrases. It is noted that certain categories are general purpose, not insurance related, such as “Earthquakes,” and do not require articles with an insurance slant. In accordance with one embodiment of the invention retrieving around five unique articles about each category, provides a sufficient basis for building rules.

Furthermore a list of all relevant synonyms for the defined terms and phrases are created at step 174. Variations of the key terms that are not readily apparent (different verb endings for verbs, plurals for nouns, and adjectival and adverbial formats of nouns are all considered to be apparent) are also noted at step 174.

Next, at step 176 all documents based on terms generated at step 174 are retrieved. At step 178, those documents, which do not fall into the category are considered. The documents are analyzed to determine whether there are any words or phrases that might appear in such “irrelevant” documents (but not in “relevant” documents), which would provide a basis for excluding such documents from the category. For example, a search for documents about Reno, Nev. could search just for the initially capitalized word “Reno,” but this would likely also include documents about Janet Reno. Thus, the search could be enhanced to exclude any documents that contain the word “Janet” or the phrase “Attorney General” in the same sentence as the word “Reno” as illustrated in steps 180 and 182.

Next key terms, which should be searched for in a case sensitive manner are preferably considered at step 184. This would include proper nouns (company names, place names, people) and abbreviations.

Next, words or phrases that need to be searched for in the exact spelling format are considered (for example, no plurals for nouns) at step 186. If exact spelling is not specified then a STEM, THESAURUS or WILDCARD search will be performed on the item.

Next, at step 188, whether a document should be ranked higher is considered, because certain words or search terms appear multiple times in the document. Also whether any words or search terms should be given a higher (or lower) weight than others is noted. For example, if a document would match if it includes any of four gambling words, such as “poker,” “slots,” “blackjack,” and “roulette,” the word “slots” may be given less weight, because “slots” can have a meaning besides a gambling device or game. If terms appearing at the same “part” in a search should be given different weights, then a weight for each of these terms on a scale of 1 (lowest) to 10 (highest) is provided. Thus, poker, blackjack and roulette might each get a 10, and slots 5. If weights for items in a part of a search are not important, the “Weight” value remains blank.

Next, at step 190, if necessary, the items are consolidated into parts, identifying each group with a letter. This may only be necessary for a search with many sub-parts. For simpler searches, each item is treated as a part. For example, many items are synonyms for each other. These items are put in a part indicating that “any” of them would be useful, and as such are noted by a number. If certain terms must appear in proximity to each other, a part and a corresponding proximity criteria is noted (such as the maximum number of words that should separate the items, that they should be in the same sentence or paragraph, or simply that the closer the terms are in a document, the better). Also whether the order of the terms is important and the order itself is indicated.

In the Structure section, the relationship of the parts to each other is noted at step 192. Parts that must appear in conjunction with other parts are noted (for example, “Reno, Nev.” must appear with “gambling”). If a conjunction is required, whether the proximity of these parts matter is noted. Also, whether the order of the parts matter is noted. Furthermore, whether the existence of a part in a document indicates that the document should be excluded from the search is noted. The Structure section should contain a single sentence explaining the high level structure of the rule.

Next, at step 196, each rule is considered so as to whether the search terms should be broken up for greater accuracy. Thus, two (or more) completely unrelated search terms can be employed to classify documents in the same category. Because separate rules can be joined together with an ANY operator, such a structure is allowed and would be easier to understand and maintain in accordance with one embodiment of the invention.

FIG. 3c illustrates a taxonomy table 210, with categories defined in accordance with query definitions explained in reference with FIGS. 3a and 3b. Generally, taxonomy table 210 has a field that defines the types of risks the documents retrieved by search module 112 are related. As explained before, such risk types include, among other things, hazard risks, operational risks, financial risks, enterprise risks, and strategic risks. A second field defines the insurance types, such as property, casualty and benefits. A third field relate to various insurance groups. Another field relates to category name and category prefix as described above in reference with FIGS. 3a and 3b. The last field includes the category definitions for collection of documents. In accordance with one embodiment of the invention, this last field relates to the query rules developed in accordance with the steps described in accordance with FIG. 3b.

Thus, each document retrieved by search engine 112 is filtered in accordance with the category rules defined in taxonomy module 114. As such each document is also tagged in accordance with the query rules, for further research and retrievals by the users of knowledge management system 28. Appendix I, discloses a list of all categories defined in accordance with the best mode embodiment of the present invention.

The operation of contextualization module 104 is described in more detail hereinafter in reference with FIG. 4. As mentioned earlier, contextualization module 104 is configured to provide relevant research information as a user navigates through various screens provided by knowledge management system 28 via its workspace administrator module 102. Contextualizatoin module 104 dynamically builds search queries that retrieve relevant information.

Contextualization module 104 includes a user profile module 222 that is configured to retrieve the profile of the user navigating through various pages provided by knowledge management system 28. User profile module 222 in accordance with one embodiment of the invention is a table containing various fields relating to the profile.

For example these fields in accordance with one embodiment of the invention include, the user's role field 224 that stores the role of the user within the insurance industry, for example, an insurance administrator, a broker or an underwriter. Industry field 226 defines the industry within which the user operates, for example, high technology, construction, real estate, etc. Geography field 228 contains the location of the user, or the location within which the user is active. Insurance products 230 field contains the information representing the insurance products that the user is interested. Finally, exposure/issues of interest field 232 contains the information relating to the types of risk exposures and insurance related issues that the user is interested.

Contextualization module 104, also includes a user navigation table 236, which is configured to track the navigation of the user within the workspace provided by knowledge management system 28. As such, user navigation module 104 includes a field or a buffer user workspace selections 238 that is configured to store every location within the workspace navigated by the user. As such, contextualization module 104 has access to information relating to the current and prior location of the user's navigation.

Contextualization module 104, also includes a concept extraction module 240, which is configured to identify top concepts relating to the documents retrieved in connection with a user's research. Concept extraction module 240 operates such that various concepts relating to a particular topic are uncovered and stored. Concept extraction module 240 analyzes the text or document that is being viewed by the user to extract the top concepts within it.

The concept extraction module is configured to analyze specific word patterns to uncover concepts that originally were not known to have a relationship with the underlying user's search.

Contextualization module 104 also includes an expert query module 220, which is configured to store search queries that are considered timely or news breaking and have not been defined within taxonomy module 114 yet. Expert query module 220 is periodically and constantly updated in accordance with one embodiment of the invention. Furthermore, expert query module may be maintained with various experts on each related topic, who are constantly recent topics and ground breaking news and define new categories and associated rules to update expert query module 220. These categories and associated query rules are provided in accordance with the same steps explained in reference with FIG. 3b.

Contextualization module 104 also includes a context table 242 coupled to expert query module 220, and concept extraction module 240, which is configured to provide the appropriate expert queries based on the context of the user's research.

Contextualization module 104 also includes a search builder module 244, which is coupled to context table 242, expert query module 220, user profile module 222, user navigation module 236 and concept extraction module 240. Search builder module is also coupled to database 37. Search builder module 244 is configured to provide search queries corresponding to the type of a research a user desires. To this end, search builder 244 includes a search matrix 246, which is configured to provide search queries within the context of a user's research.

Thus, based on the information provided by user profile module 222, user navigation module 236, expert query module 220, concept extraction module 240, search matrix 246 generates a query string that can be used to obtain relevant information from database 37. It is noted that the query string provided by search matrix 246 includes the categories defined in taxonomy module 114. To this end the searches conducted by search builder 244 employ the same query search rules defined in taxonomy module 114 as explained in reference with FIG. 3b.

In accordance with one embodiment of the invention, context table 242 receives the appropriate context of the user from user profile module 222 and user navigation module 236 via a search builder module 244.

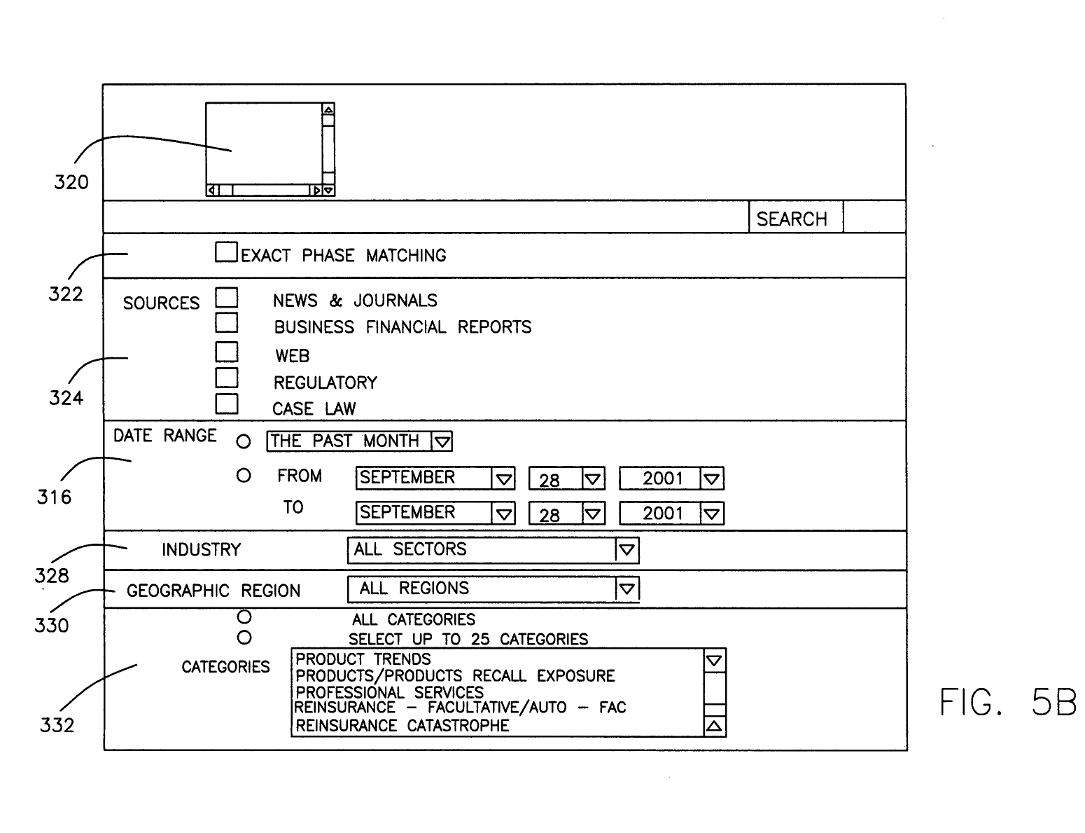

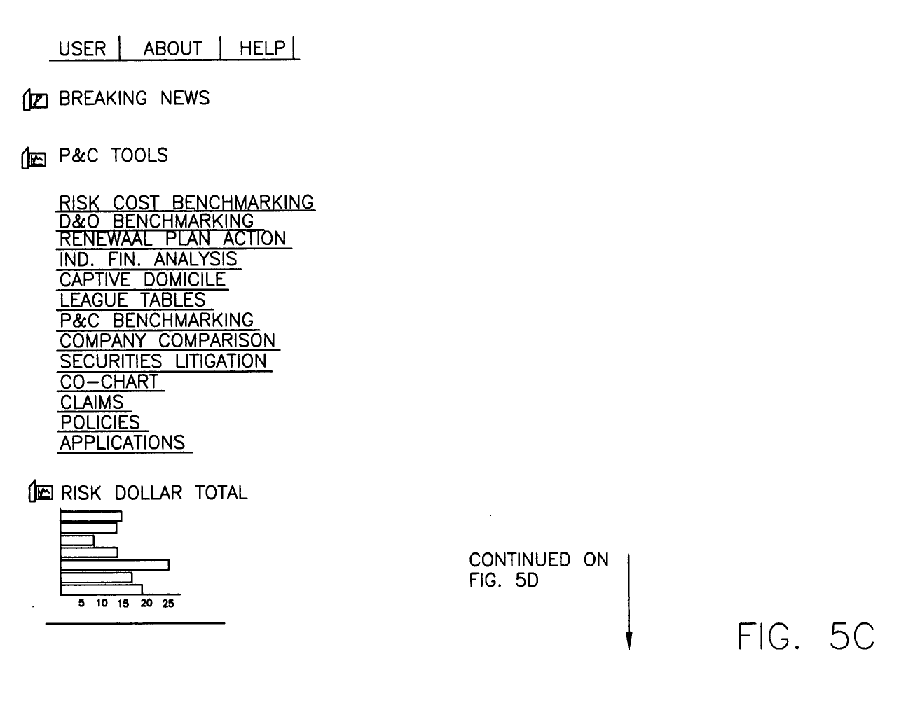

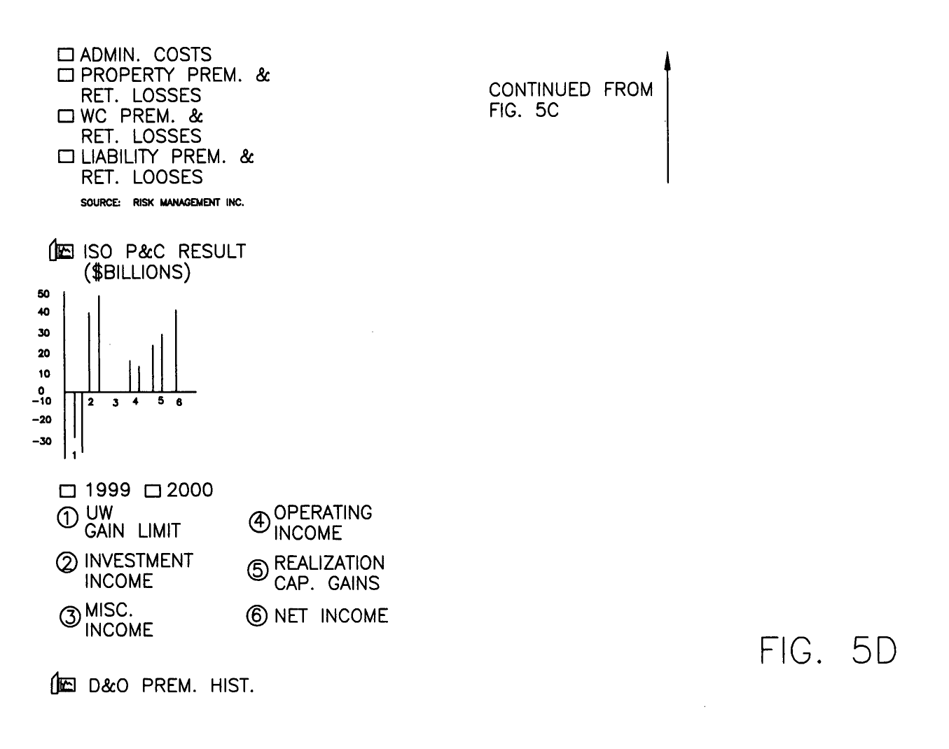

The operation of contextualization module 104 is explained in more detail in reference with FIG. 5a, which illustrates a sample workspace generated by workspace administrator 102 (FIG. 1b). As illustrated workspace 300 is displayed to a user who has visited a site provided by knowledge management system 28. In accordance with one embodiment of the invention, workspace 300 is divided into three separate portions, including a search portion 302, a key practice portion 304 and an analytical tool portion 306. It is noted that these portions may change depending on the page the user is visiting within the knowledge management system.

The functions provided within search portion 302 are governed among other things, by contextualization module 104. Accordingly, the “search within” field includes “advisen” field, “my profile” field, “company look-up” field and “context of a template” field. Below these fields, there is a search box field 308 that enables users to provide their own key words and phrases and to conduct desired searches within a specified field.

To this end, a user after entering the desired key words in search box field 308, selects one of the available fields. If the user selects a search within advisen, search builder 244 retrieves the key words and conducts a search of all available data with database system 37.

If the user selects a search within “my profile” field, search builder 244 obtains the profile information from user profile 222, so as to generate a search query in response to the profile information and the desired keywords provided by the user. Thus, the search is conducted within the documents that are not only related to the desired keywords but also the categories that are related to the user's profile.

If the user selects a search within “company look-up” field, search builder 244 generates a search query relating to the company name provided by the user in box 308.

If the user selects a search within “context of a template” field, search builder 244 obtains information from user navigation module 236 so as to generate a search query relating to one of the key practice templates in the projects section 304 of workspace 300. Thus, the search is conducted within the document that are not only related to the desired keywords, but also categories that are related to the template the user is operating.

The advanced search option 310 responds by providing an interface page as illustrated in FIG. 5b. Advanced search page includes a keywords box 320 that enables the user to enter the terms that best describe the desired search. The keyword box allows for Boolean searches, similar to conventional search engines.

The advanced search page also includes an “exact phrase match” option 322, so as to enable a user to treat all of the words entered in the keyword box as a phrase. Sources field option 324, allows the user to specify the information sources that can be used for conduction the search specified in the keyword box.

Similarly, data range field 326 allows the user to restrict the search results to documents published within a certain time frame. By default, the system searches for documents published within the previous 30 days. Industry field 328 allows the user to restrict the search results to documents that concern a particular industry by selecting an industry from a pull-down menu. Only one industry at a time may be selected. If the user does not select an industry, the search includes all industries. The list of 30 industry categories, corresponds to the RIMS (Risk and Insurance Management Society) industry categories, making them useful for insurance professionals.

Geographic region field 330 allows the user to retrieve only those documents that refer to a particular geographic region by selecting a region from a pull-down menu. Only one region may be selected at a time. If no region is selected, the search will include all regions.

Finally category field 332 allows the user to search for information based on the categories defined within taxonomy module 114. The user may restrict the results of a search by talking advantage of these pre-defined categories. By default, the system searches for documents in every category. To restrict a search to a subset of categories, the user can select the option of “select up to 25 categories” radio button. Next, the user clicks on the category for which the search is restricted. Otherwise, the search can be restrict to a set of the available categories or to all of them.

Referring back to FIG. 5a, search portion 302 also includes in-context preformatted searches as provided by contextualization module 104. Thus, when a user selects expert searches field 312, search builder module 244 retrieves the categories defined and stored in expert query module 220, so as to generate a pre-formatted search query, based on recent topics and issues.

In accordance with another embodiment of the invention, context table 242 provides the user's context information to expert query module 220. This information includes the user's profile and/or user's navigation within the workspace. In response, expert query module 220 generates only the categories that are relevant to the user's information, among all the categories available within expert query module 220.

When a user selects top concepts field 314, search builder module 244 retrieves the categories provided by concept extraction module 240. Concept extraction module 240 provides the top concepts that are identified in-context. To this end, all documents relating to the user's profile and navigation are first obtained based on the query generated by search builder 244. Afterwards, concept extraction module identifies top concepts within those retrieved documents and makes those concepts available for further research by the user. As such, those additional concepts are presented in the form of additional new categories, against which database 37 could be searched.

When a user selects related links field 316, search builder module 244 generates a group of links related to the user's research work. Clicking on a suggested link takes the user to the specific web page where the relevant information is. The links are presented “in context” based on the user's profile and the user's navigation information, such as the products/industries/exposures on which the user is working, and the location of the user in the system.

Contextualization module 104 is an effective search tool that enables the user to retrieve documents that are related to the context of the research being handled and to the profile of the user who is conducting the research. To this end, module 104 dynamically generates a list of categories obtained from taxonomy module 114 that are relevant to the context of the research.

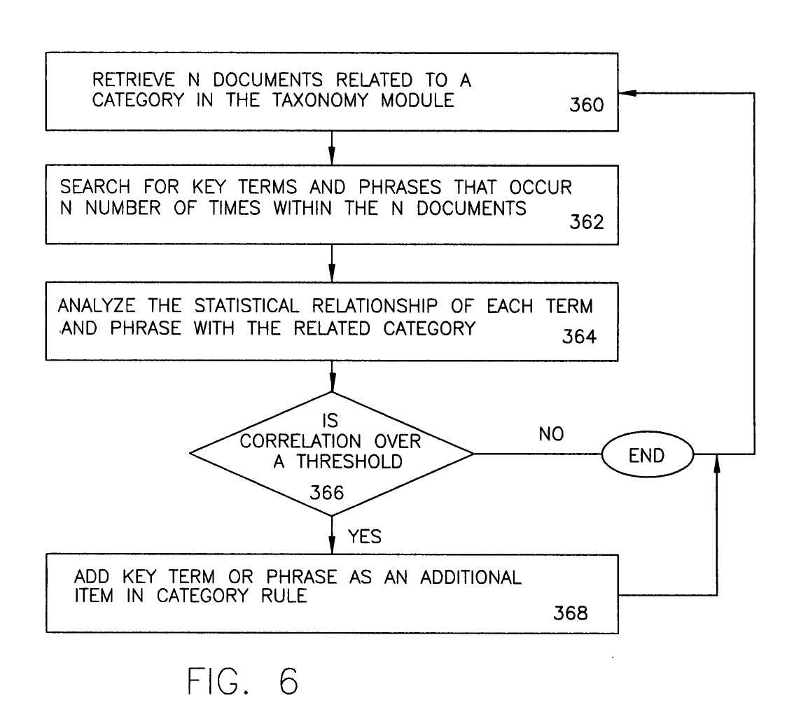

The operation of concept clustering module 106 of FIG. 1b is now described in more detail in reference with FIG. 6. Generally, concept clustering module 106 is configured to find terms or phrases that are related to a category defined in taxonomy module 114, which have not been previously identified as a related item, within the item list illustrated in table 160 in reference with discussion of FIG. 3a.

To this end, “concept clustering” module 106 at step 360 retrieves n number of documents related to a selected category defined in taxonomy module 114, where n is a sufficiently reliable integer. In accordance with one embodiment of the invention, n is about 20 documents.

At step 362, concept clustering module 106 searches for key terms and phrases that occur m number of times within the retrieved documents, where m is a sufficiently reliable integer.

At step 364, concept clustering module 106 analyzes each of the key terms and phrases and determines the statistical correlation between the key terms and phrases with the selected category.

At step 366, module 106 determines whether the correlation between the key terms and phrases are larger than a specified threshold. If so, module 106 provides the key term and phrases to taxonomy module 114 as additional items in category rule table 160 of FIG. 3a.

Referring back to FIG. 5a, key practice portion 304 is described in more detail. In accordance with one embodiment of the invention, knowledge management system 28, and specifically work space administrator 102 (FIG. 1), includes options for various predefined projects that are employed by those involved in the insurance industry.

The top section of key practice portion 304, provides three buttons for users to select, such as news button 340, projects button 342 and reference button 344. In response to the selection of the news button, work space administrator 102 retrieves the most recent news form database 37 (FIG. 1). It is noted that in accordance with one embodiment of the invention, the news retrieval function is based on the context, depending on the choice of the search criteria specified by the user as set forth in the search portion 302 of the workspace. Therefore, the news content retrieved may be based on the entire database, or user's profile, or context of a template as described above in reference with FIG. 5a.

In response to the selection of the projects button, workspace administrator 102 displays key practice templates. To this end, key practice portion 304 provides for a choice of various templates, including claims and loss analysis template 420, mergers and acquisitions template 422, renewal of insurance template 424, exposure analysis template 426, insurance administration 428, client research template 430, new product development template 432. For each of these templates, workspace administrator 102 provides a list of actions that a user can follow, similar to a workflow management arrangement.

It is noted that in accordance with another embodiment of the invention, each user is enabled to create a user specific template that defines a desired workflow management, whereby a specific key practice area can be automated.

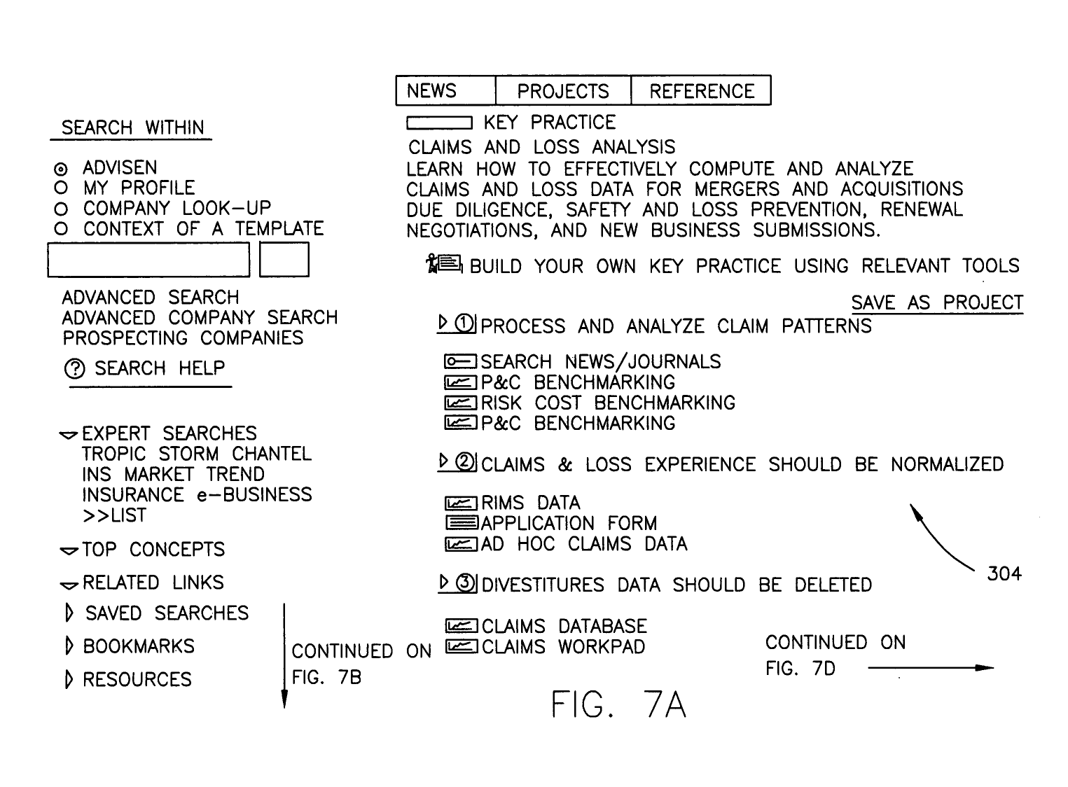

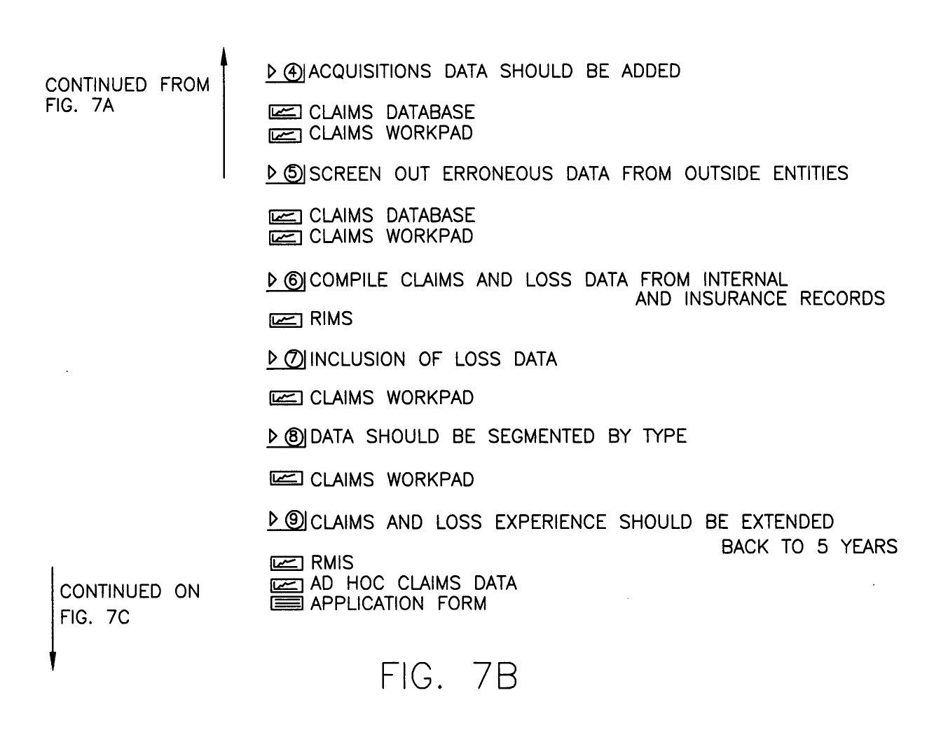

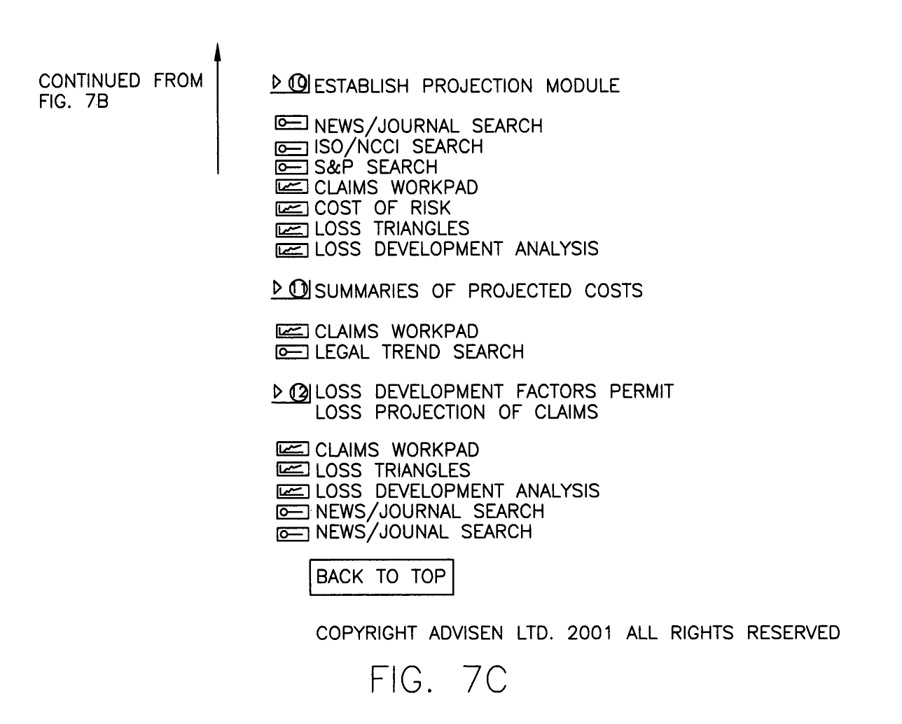

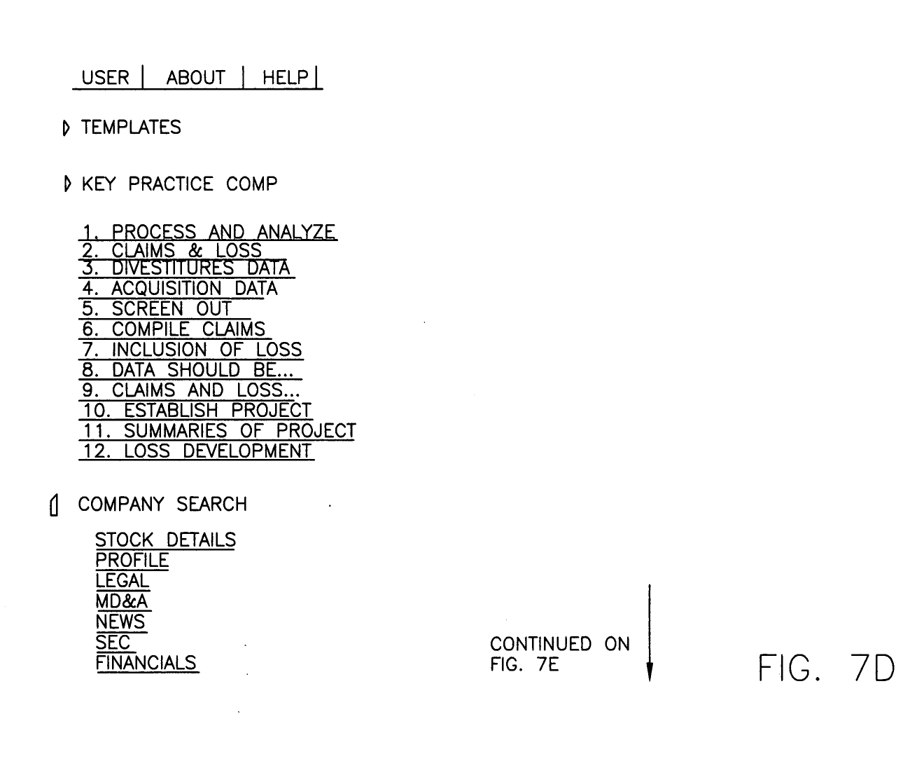

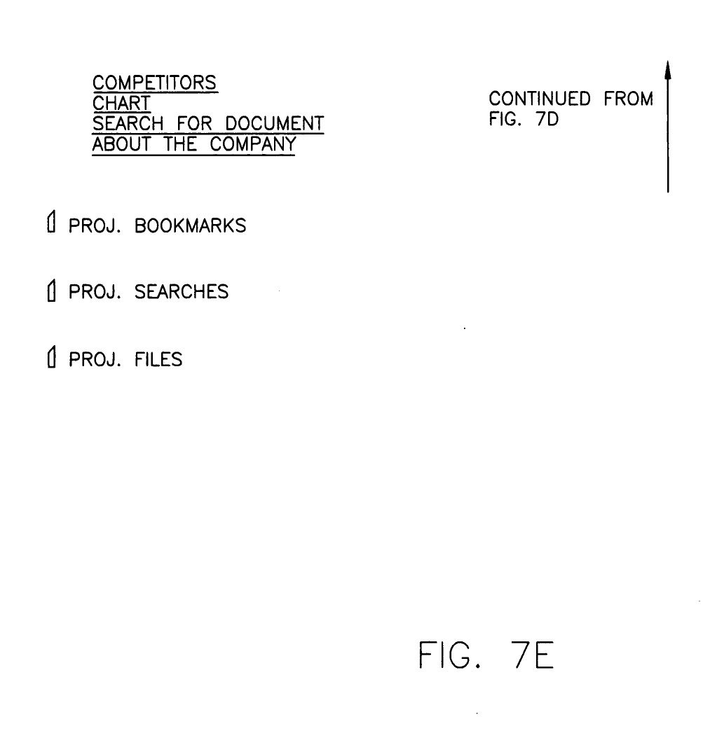

FIGS. 7a and 7b illustrate a workspace and more specifically, a key practice portion 304, after a user selects claims and loss analysis template in FIG. 5a. As a result, workspace administrator module 102 displays the workflow associated with the claims and loss analysis template. An exemplary workflow as illustrated in FIG. 7a includes the first step of processing and analyzing claim patterns, followed by the step of normalizing claims and loss experiences. The next step includes deleting divestitures data, followed by the step of adding acquisitions data. The next step includes screening out erroneous data from outside entities, followed by compiling claims and loss data from Internet and insurance records. The next step is inclusion of loss data followed by the step of segmenting data by their type. The next step is extending back claims and loss experience up to five years.

FIG. 7b illustrates the remaining steps of establishing a projection module followed by generating summaries of projected costs. The last step refers to loss development factors that permit loss projection of claims.

It is noted that for each of the steps mentioned above, additional sub steps are also defined. Thus, for example, for the first step of processing and analyzing claim patterns, the workflow specifies three steps of searching news and journals, Property and Casualty (P&C) benchmarking, Risk Cost benchmarking. The benchmarking functionalities are provided by analytical module 108 as explained before.

It is further noted that as a user navigates throughout this workflow illustrated in key practice portion, the contextualization module explained above, modifies predefined searches available in the search portion 302.

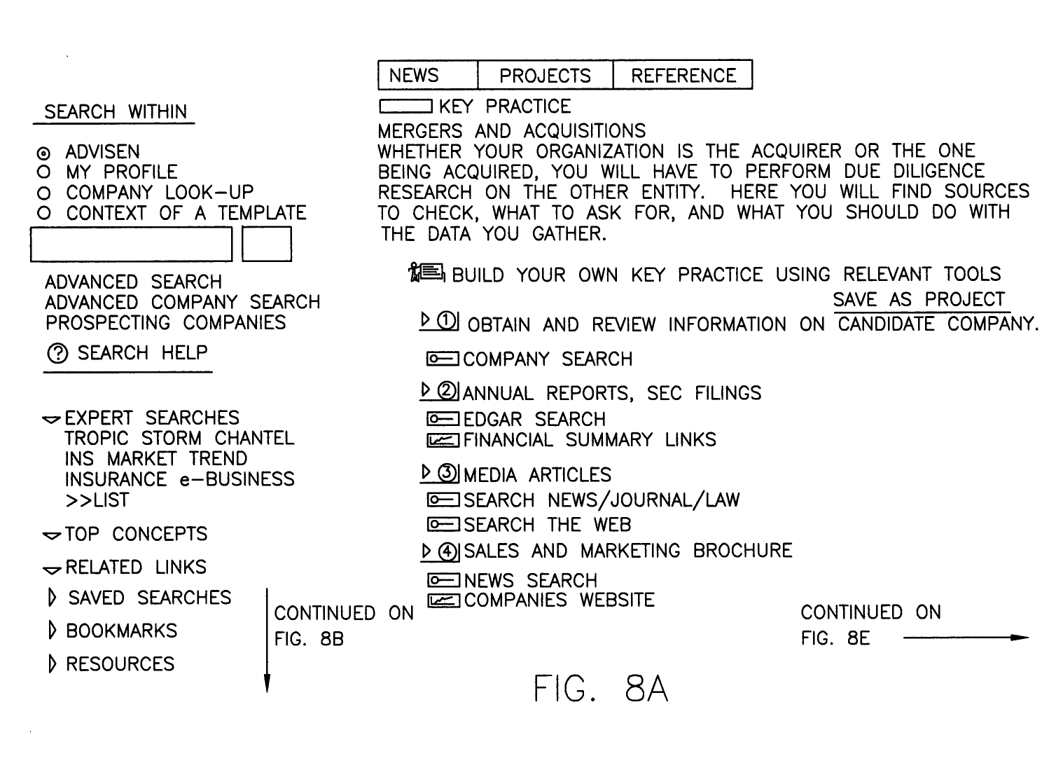

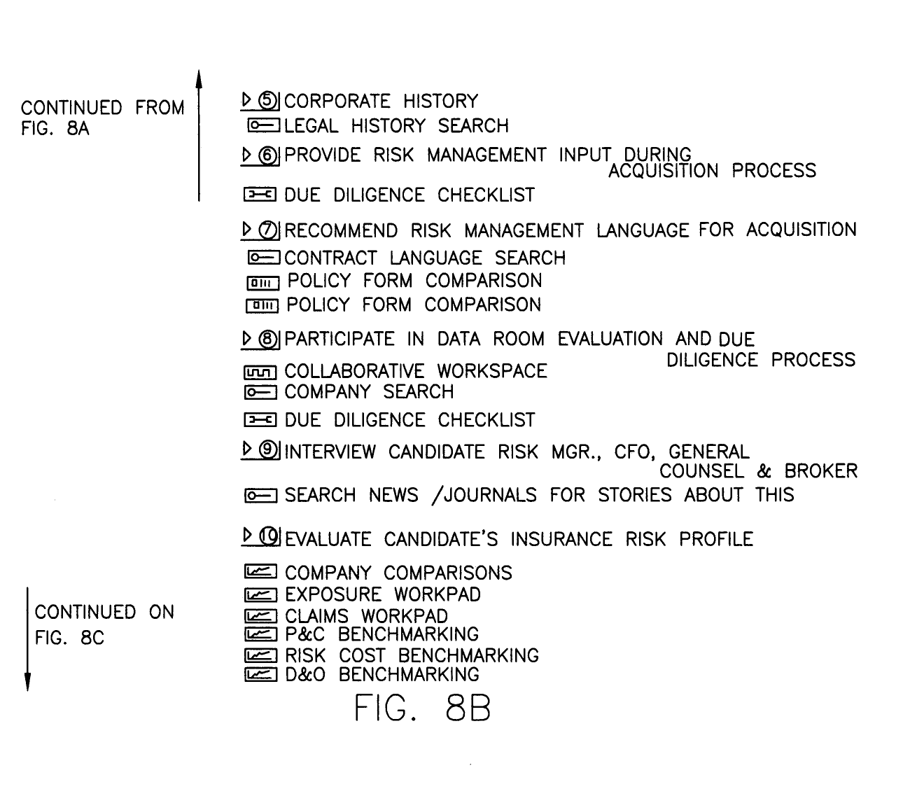

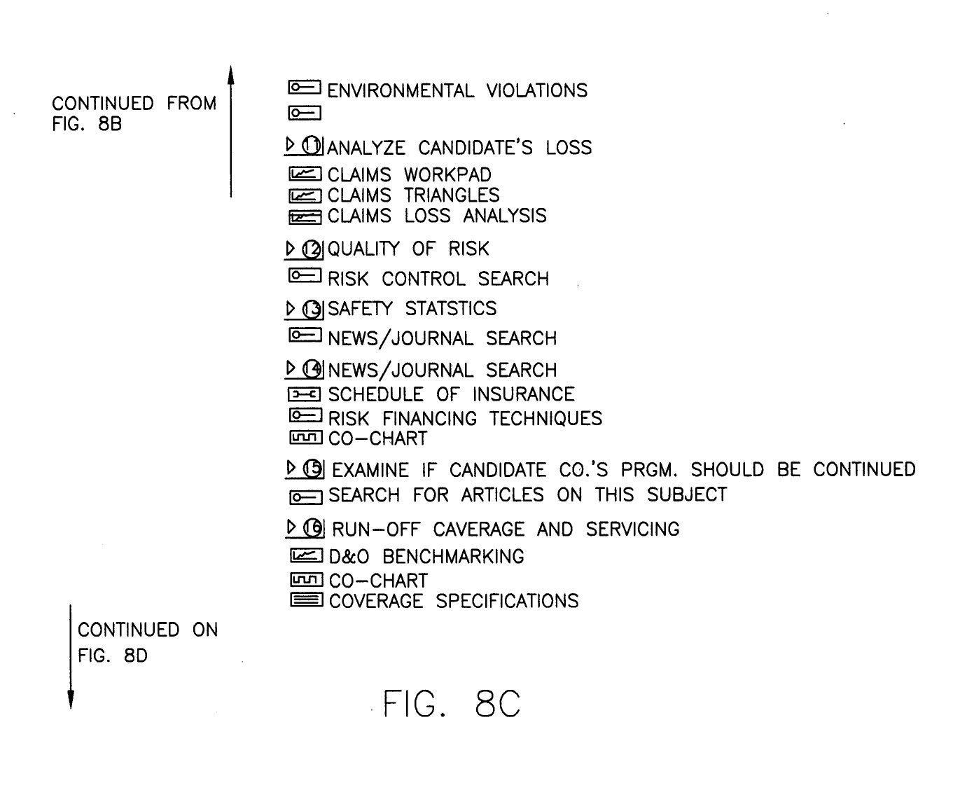

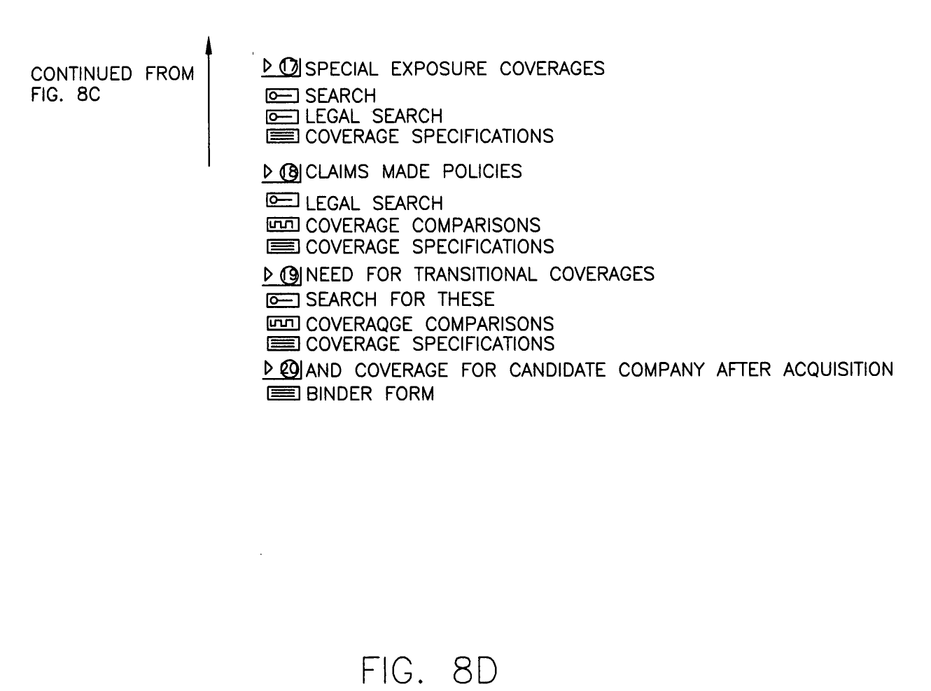

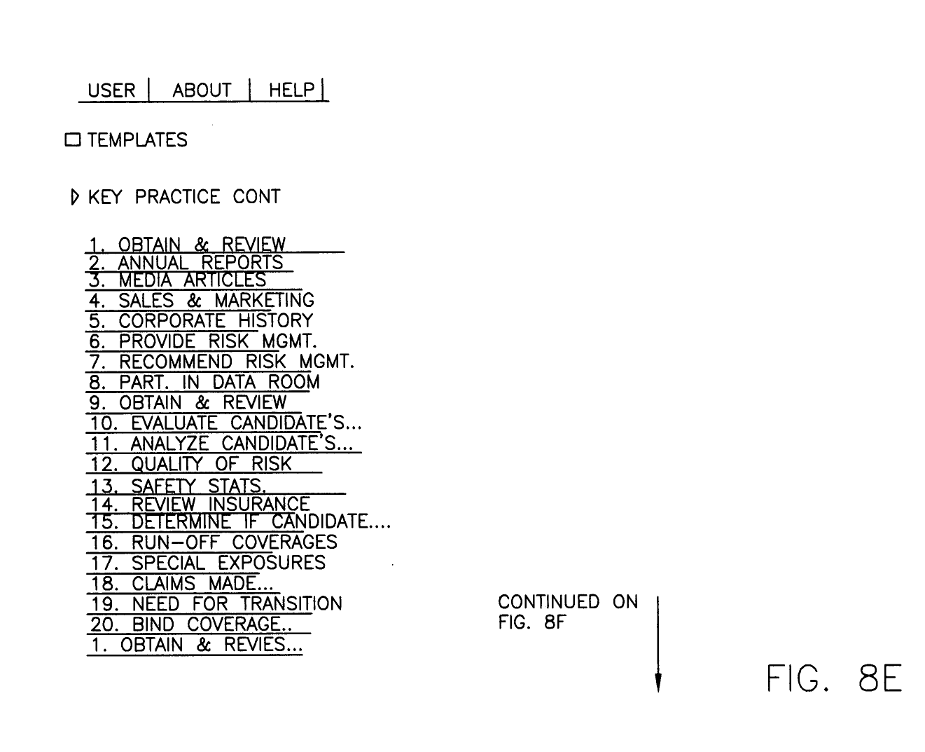

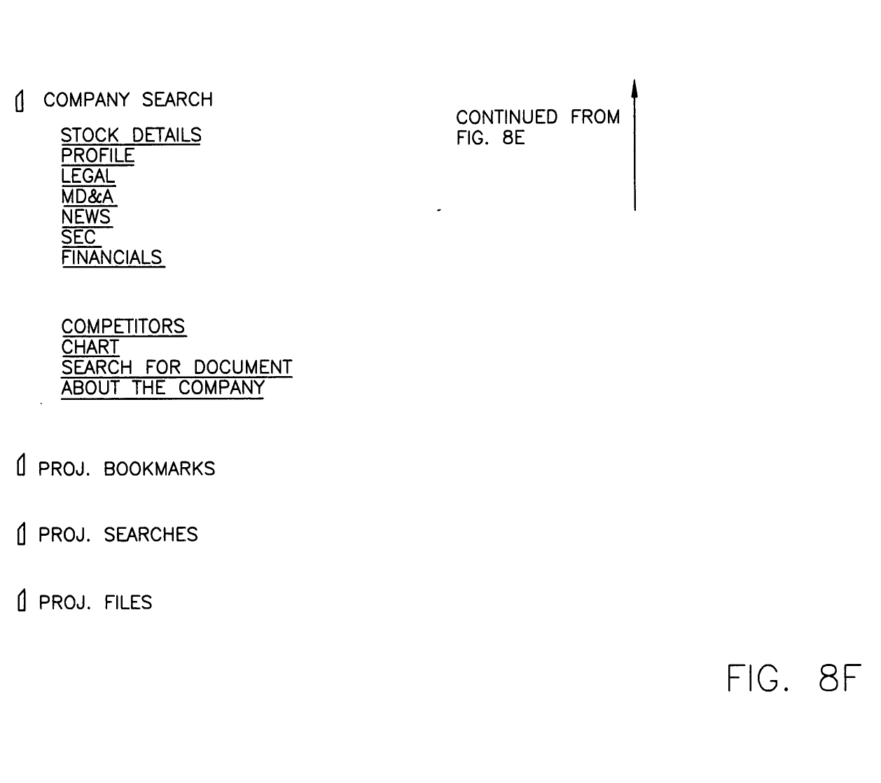

FIGS. 8a and 8b illustrate a workspace and more specifically, a keypractice portion 304, after a user selects mergers and acquisitions template in FIG. 5a. As a result, workspace administrator module 102 displays the workflow associated with the mergers and acquisitions analysis template. An exemplary workflow as illustrated in FIG. 8a includes the first step of obtaining and reviewing information on a candidate company. A sub step corresponding to this step may be the step of performing company research in accordance with one embodiment of the invention.

The first step is followed by the step of obtaining annual reports and SEC filings corresponding to the candidate company, followed by the step of obtaining media articles. The next step includes reviewing sales and marketing brochures, followed by the step of obtaining corporate history. A corresponding sub step here includes obtaining candidate's legal history information.

The next step includes providing risk management input during acquisition process, with a corresponding sub step of completing a due diligence checklist. The next step includes recommending risk management language for acquisition contract. In accordance with one embodiment of the invention this step includes the steps of enabling the user to conduct contract language search and policy form comparisons. To this end, database module 37 (FIG. 1b) stores a plurality of contracts corresponding to various issues that may arise during the user's research employing system 28. Workspace administrator 102 provides access to these contracts, based on for example, contract topics, or contract issues represented in various clauses of the contract. Thus, a user is enabled to review a plurality of clauses of prior contracts that have dealt with a particular topic, in order to research the proper language for crafting a new contract.

The next step in the acquisition and mergers workflow includes participating in data room evaluation and due diligence process. In response, workspace administrator 102 allows various users to collaborate over various documents involved in the project to track the progress of the project and to participate in the most coherent fashion.

The next step includes prompting the user to interview candidate CFO, general counsel and the broker to obtain relevant information. The step is followed by the step of evaluating the candidate's insurance risk profile. This step includes sub steps that employ analytical tools provided by analytical module 108 (FIG. 1b).

FIG. 8b illustrates the remaining steps in the workflow provided in work space 304 in response to a user selecting a mergers and acquisitions template, in accordance with one embodiment of the present invention. The next step includes analyzing the candidate company's losses. Again, this step includes sub steps that enable the user to employ analytical tools to assess the candidate company's insurance losses.

The following steps include analyzing the quality of risk of the candidate company, followed by analyzing the safety statistics and conducting news and journals searches. The workflow then prompts the user to determine whether the candidate company's program should be continued. The next step includes determining run-off coverages and servicing followed by the step of analyzing special exposures and coverages. The workflow then prompts the user to review claims made policies and determine the need for transitional coverages. Furthermore, the workflow prompts the user to acquire binders for coverage after acquisition.

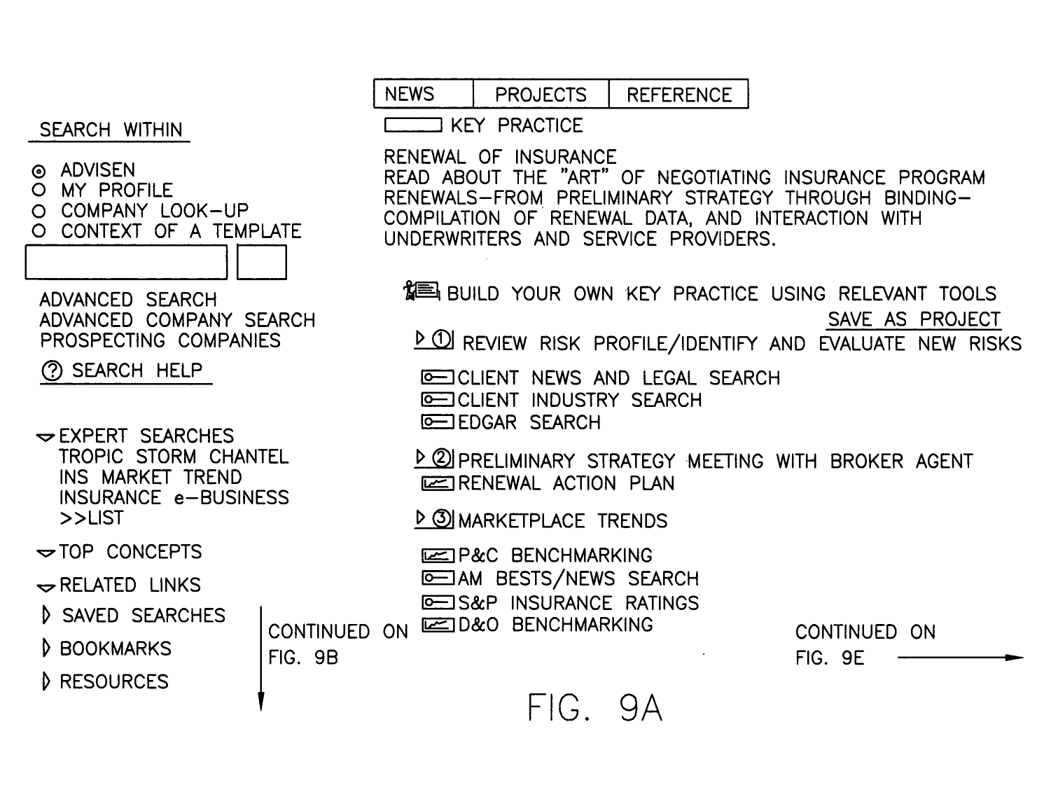

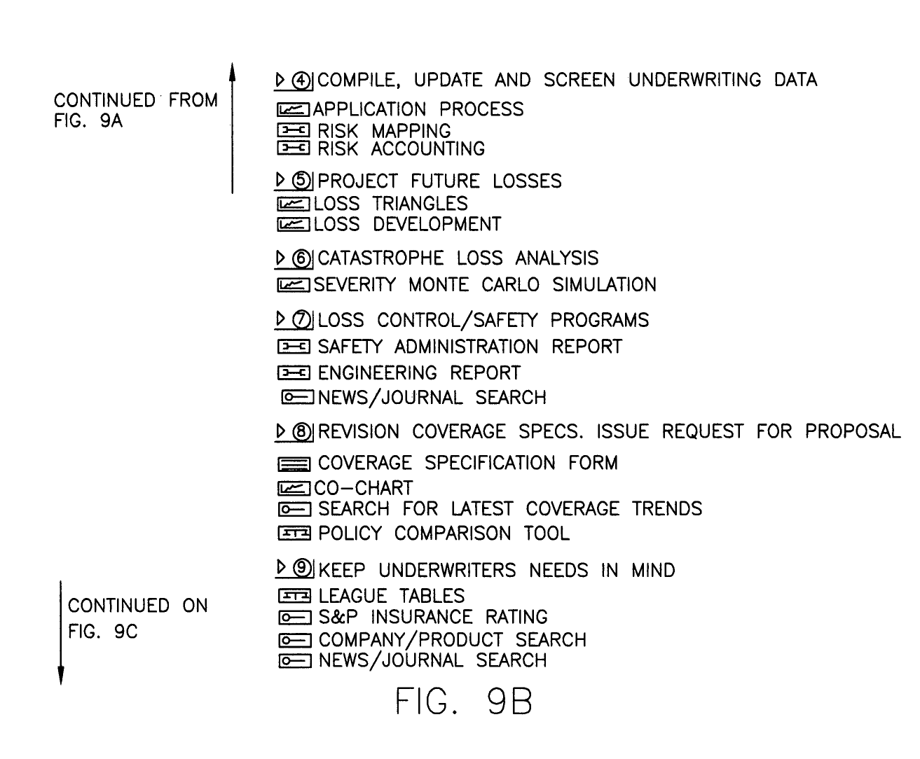

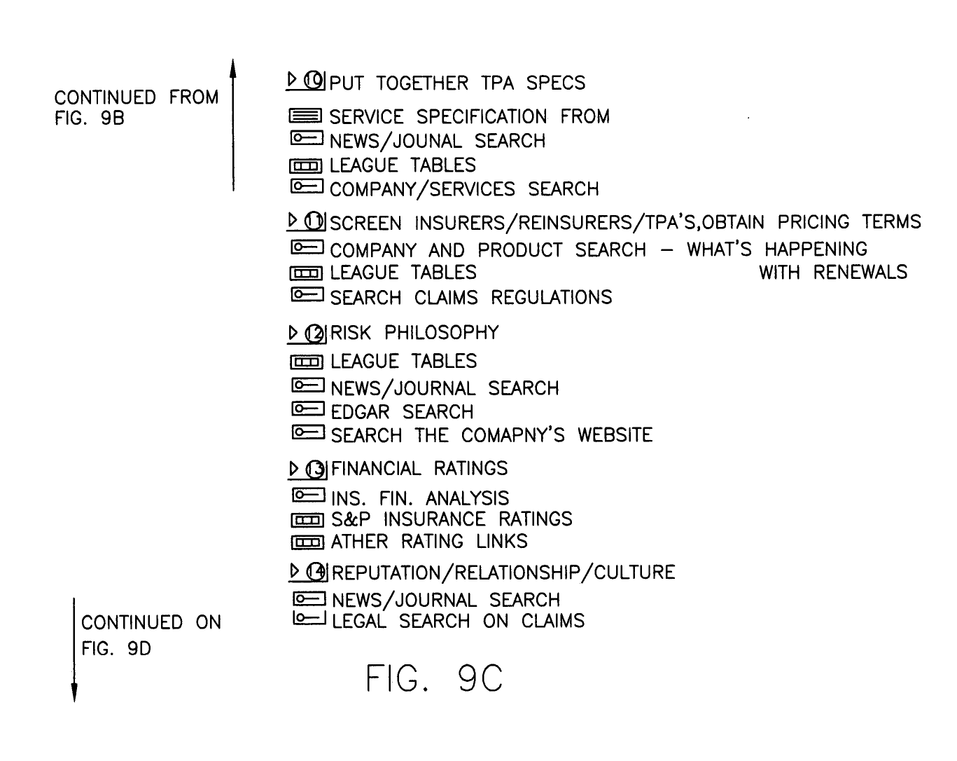

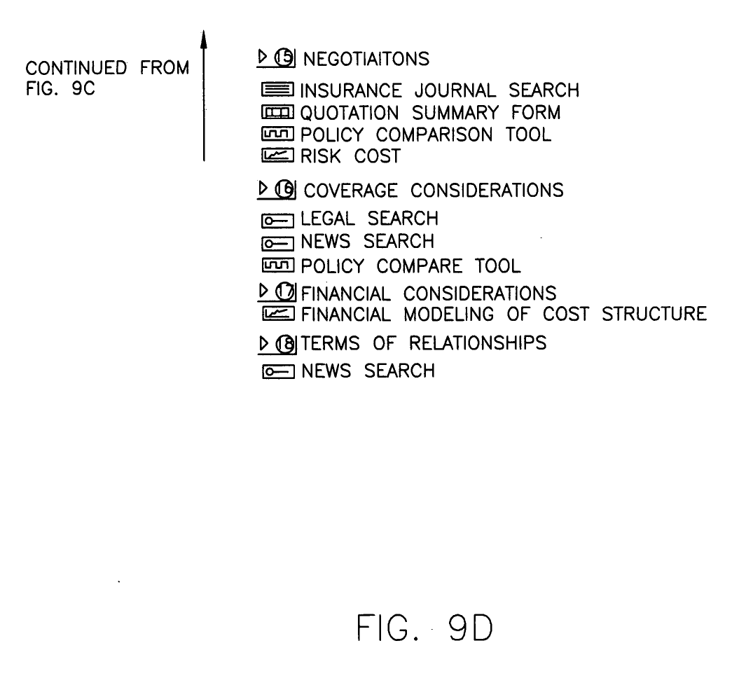

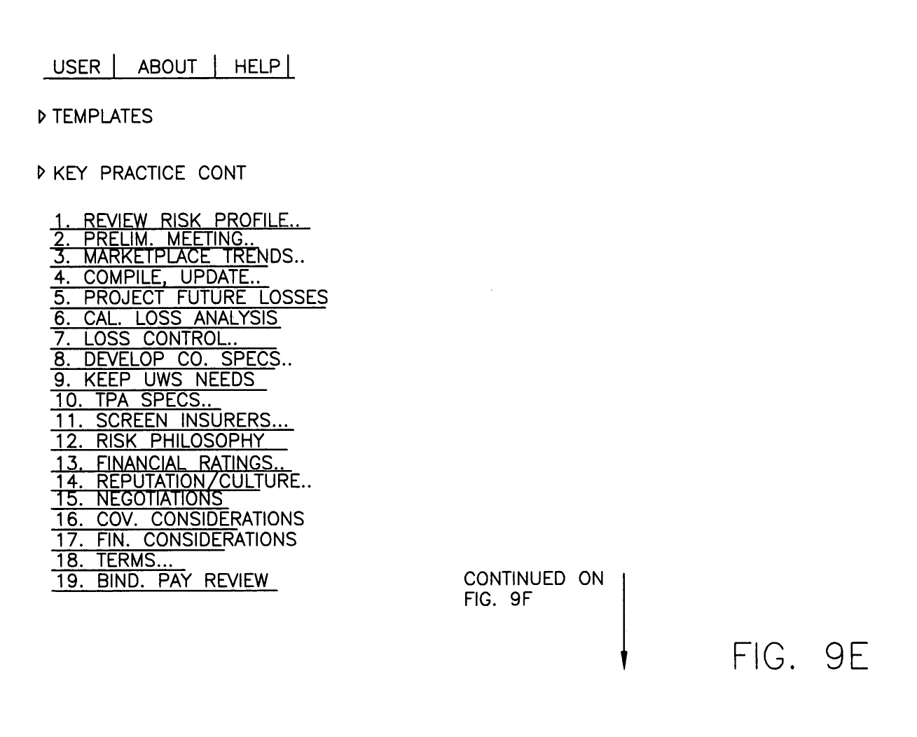

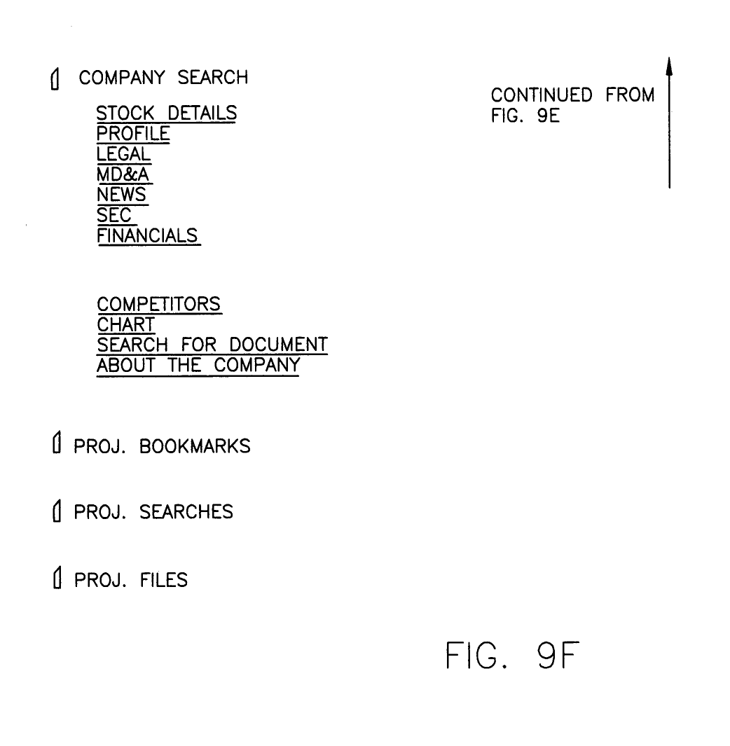

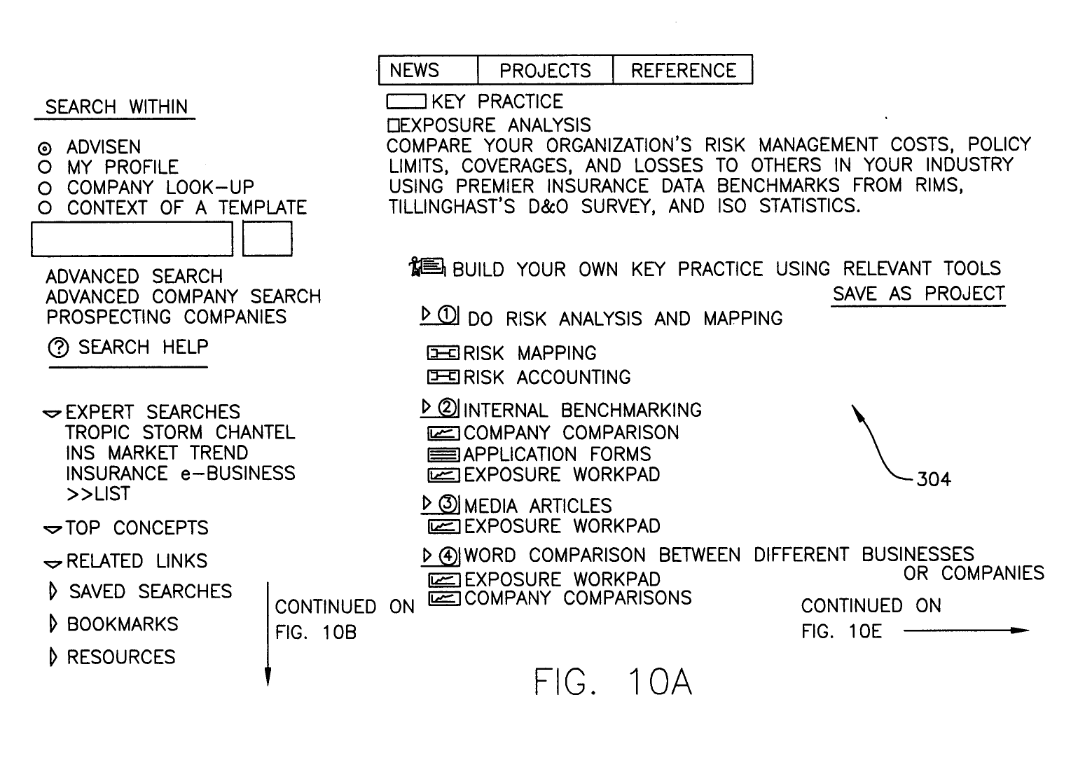

FIGS. 9a and 9b illustrate a workspace and more specifically, a keypractice portion 304, after a user selects renewal of insurance template in FIG. 5a. As a result, workspace administrator module 102 displays the workflow associated with the renewal of insurance template. This workflow enables the user to carry insurance negotiations in a methodical fashion, from preliminary strategy through binding, including compilation of renewal data, and interaction with underwriters and service providers.

An exemplary workflow as illustrated in FIG. 9a includes the first step of reviewing risk profile and identifying and evaluating new risks. This step includes the sub steps of obtaining client news and legal research. To this end, database 37 provides documents that contain recent case law and legal commentaries based on the categories related to the client's specifications as stored in taxonomy module 114. The next sub step includes conducting a client industry research, to identify risk trends developing in the client's industry. Again, database 37 provides relevant documents as specified by taxonomy module 114.

The next step includes meetings with brokers and/or agents followed by the step of conducting marketplace trend analysis. This step provides sub steps for conducting analytical functions such as property and casualty (P&C) benchmarking, A.M. Bests/News Search, S&P Insurance ratings and directors and officers (D&O) benchmarking.

The next step includes compiling and updating and screening underwriting data, which includes the sub steps of conducting the application process, performing risk mapping and risk accounting functions. This step is followed by the step of projecting future losses and conducting catastrophe loss analysis, including the sub step of performing a severity Monte Carlo simulation as provided by analytical module 108 (FIG. 1b).

The next step includes performing loss control and safety program analysis, by obtaining safety administration reports, engineering reports and news searching, followed by the step of developing coverage specifications and issuing requests for proposals. Some of the remaining steps included in the workflow comprise the sub steps of employing league tables, followed by the step of compiling TPA specifications, screening insurers, reinsurers/TPAs, and obtaining pricing and terms. These steps may be followed by the steps of generating a risk philosophy report, followed by analyzing financial ratings of various companies that plan to provide the underwriting, followed by analyzing their reputations. The next step includes negotiations workflow, followed by coverage and financial considerations followed by specifying terms of relationship.

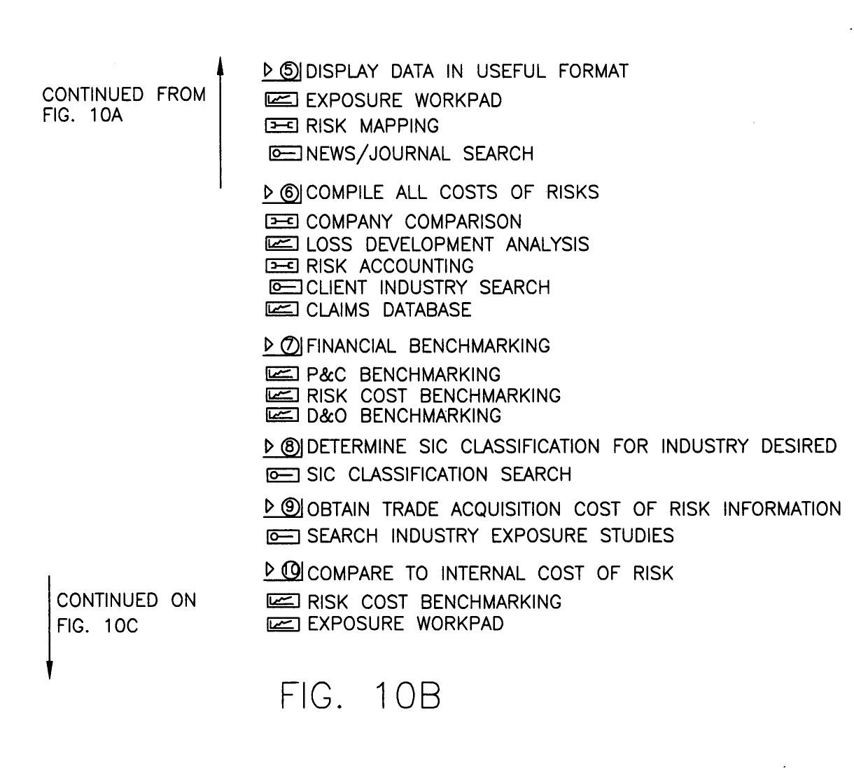

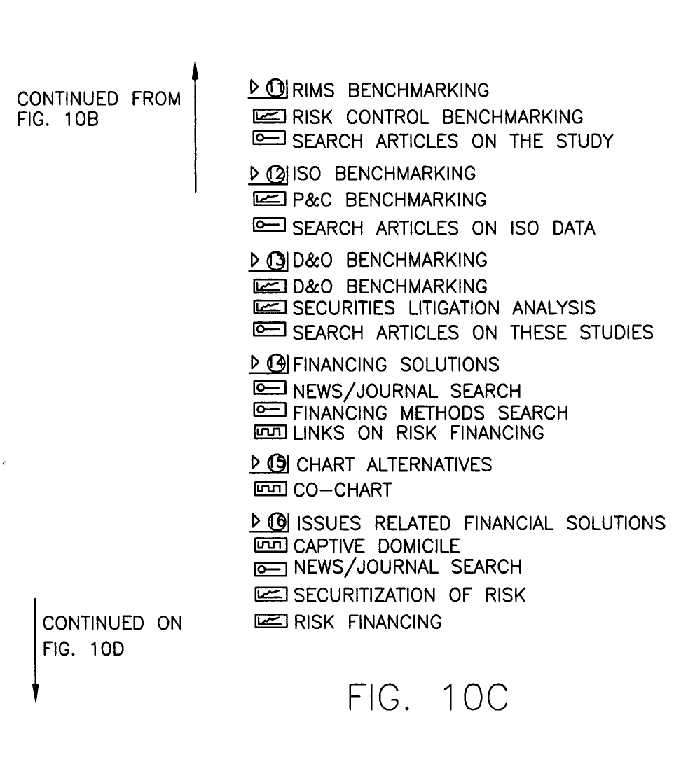

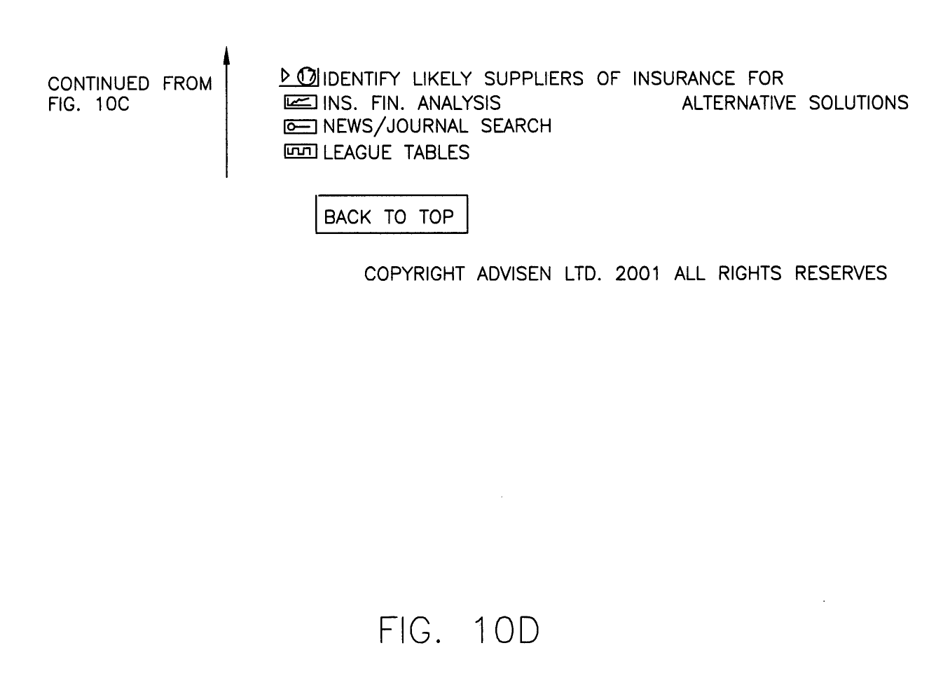

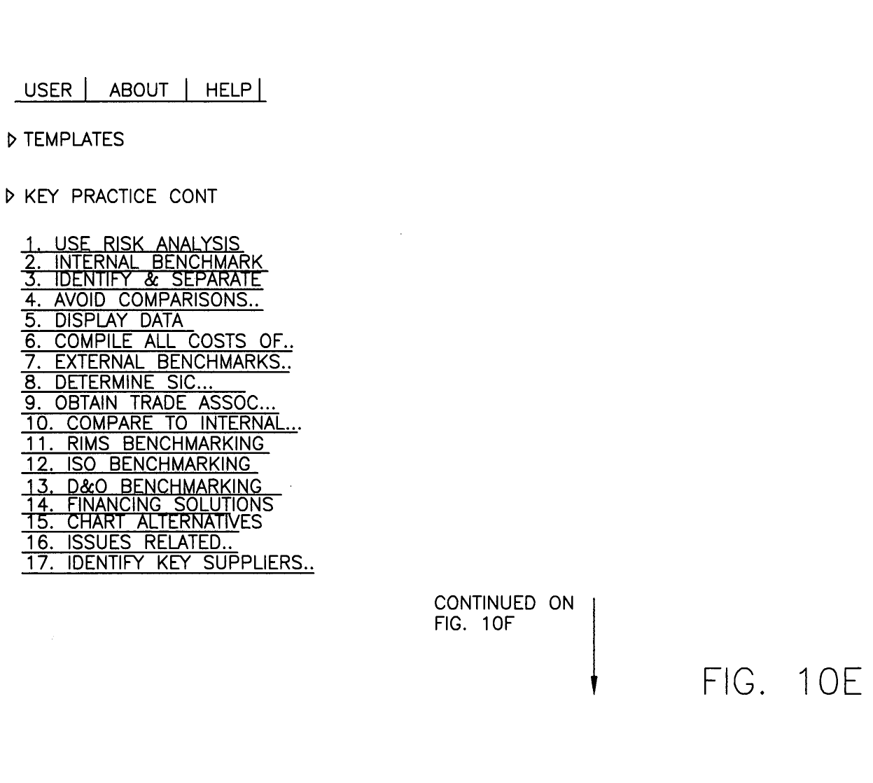

FIGS. 10a and 10b illustrate a workspace and more specifically, a keypractice portion 304, after a user selects exposure analysis template in FIG. 5a. As a result, workspace administrator module 102 displays the workflow associated with the exposure analysis template. This workflow enables the user to compare its organizational risk management costs, policy limits, coverages and losses to others in the industry using insurance data benchmarks from various sources, such as RIMS, Tillinghast's D&O survey, and ISO statistics.

The steps provided in the exposure analysis template include risk analysis and mapping followed by internal benchmarking, followed by identifying and separating internal divisions of the organization. These steps are followed by the steps of compiling costs of risk and conducting and external benchmarking. These steps are followed by the steps of determining SIC classifications for the desired industry, obtaining trade association costs of risk information, comparing to internal cost of risk, RIMS benchmarking, ISO benchmarking, D&O benchmarking, displaying results in charts, obtaining various financial solutions for financing the risk, and identifying suppliers of insurance for alternative solutions.

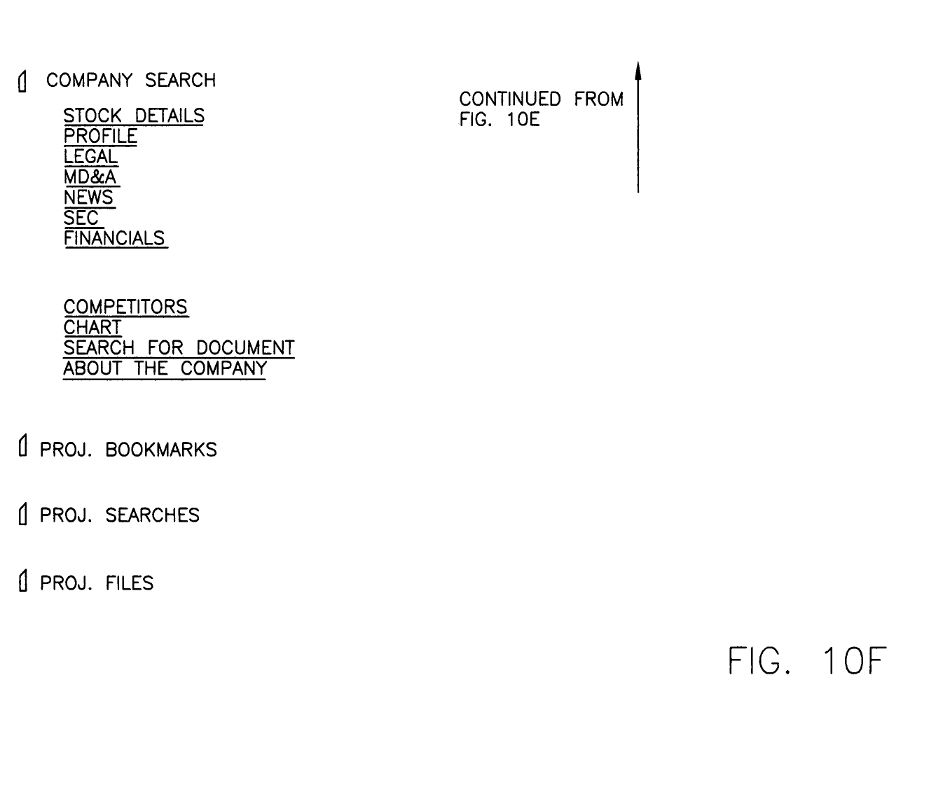

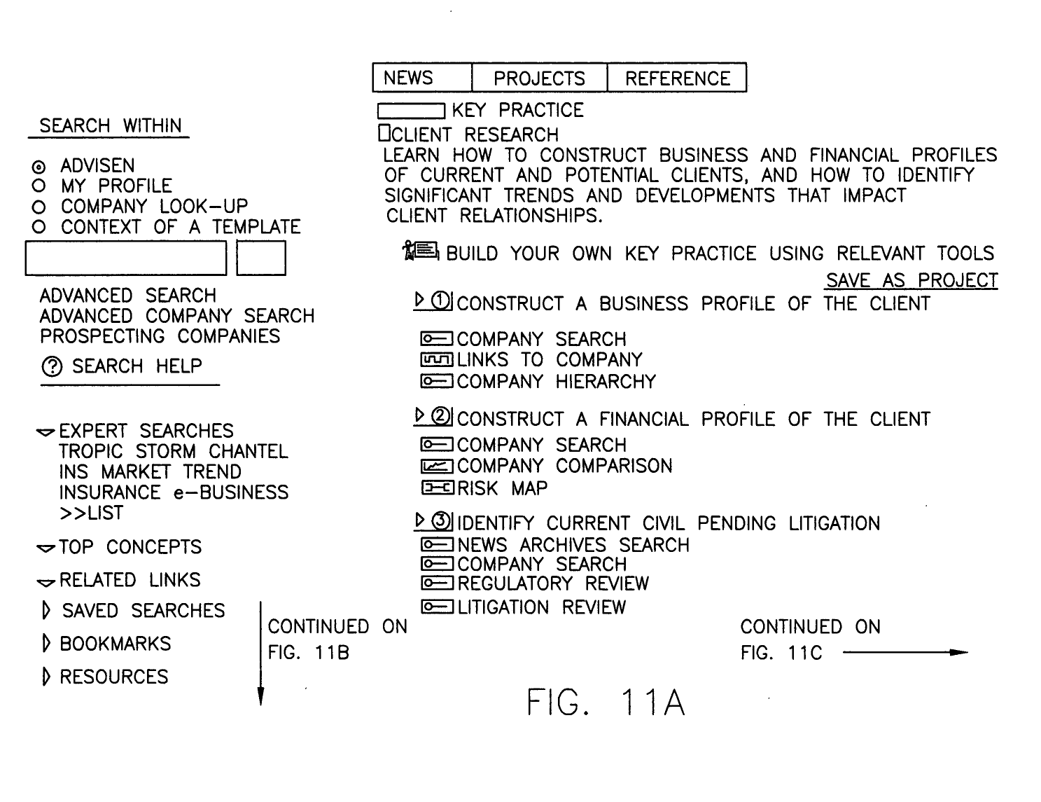

FIG. 11 illustrates a workspace and more specifically, a keypractice portion 304, after a user selects client research template in FIG. 5a. As a result, workspace administrator module 102 displays the workflow associated with the client research template. This workflow enables the user to learn how to construct business and financial profiles of current and potential clients, and how to identify significant trends and developments that impact client relationships. The steps included in this workflow include constructing profiles of the client with sub steps of conducting company research, obtaining links to the company and obtaining company hierarchy. This step is followed by the step of constructing a financial profile of the client, and identifying current and prior litigation, so as to asses the company's exposure to various risks, followed by the step of identifying significant trends and developments relating to that company.

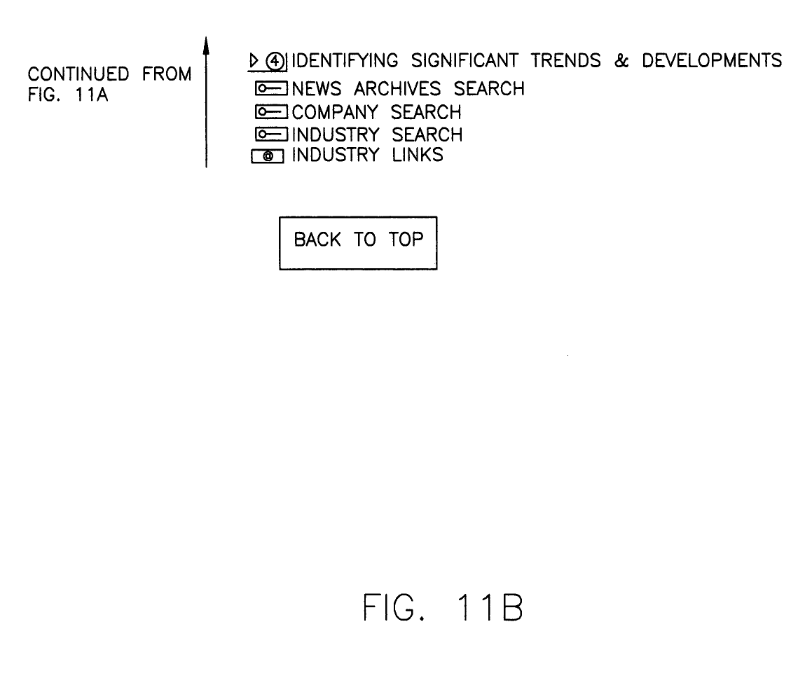

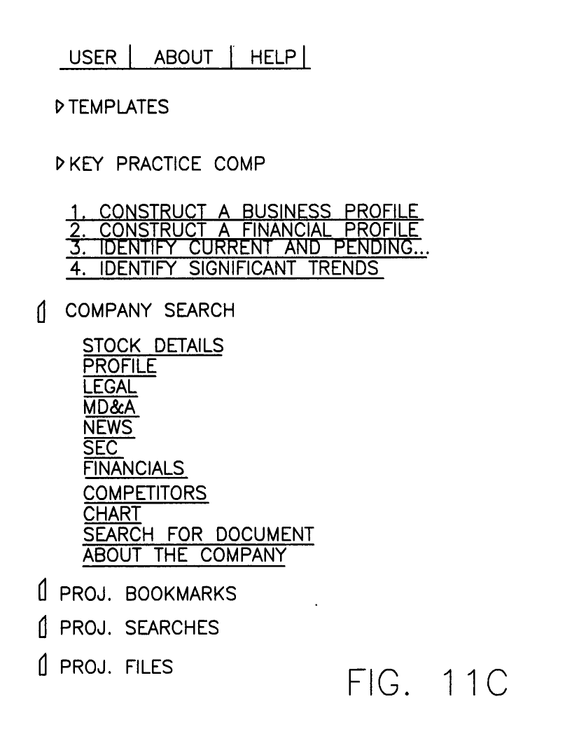

FIG. 12 illustrates a workspace and more specifically, a key practice portion 304, after a user selects new product development template in FIG. 5a. As a result, workspace administrator module 102 displays the workflow associated with the new product development template. This workflow enables the user to identify the pattern for developing a new insurance product, from identification of the new exposure through research of the potential market, and finally to a means for treating the exposure.

The steps illustrated in the workflow of FIG. 12 includes the step of identifying new exposure and loss by employing the sub steps of conducting client industry searches, insurance industry searches, case law searches by exposure and regulatory searches by exposure. This step is followed by researching new claim trends, D&O claims analysis, risk research in news and journals, client industry information for rating, identification of likely clients and size of the market, identifying insurance industry likely candidates, listing of potential experts, and determining financial solutions to provide the risk mitigation products.

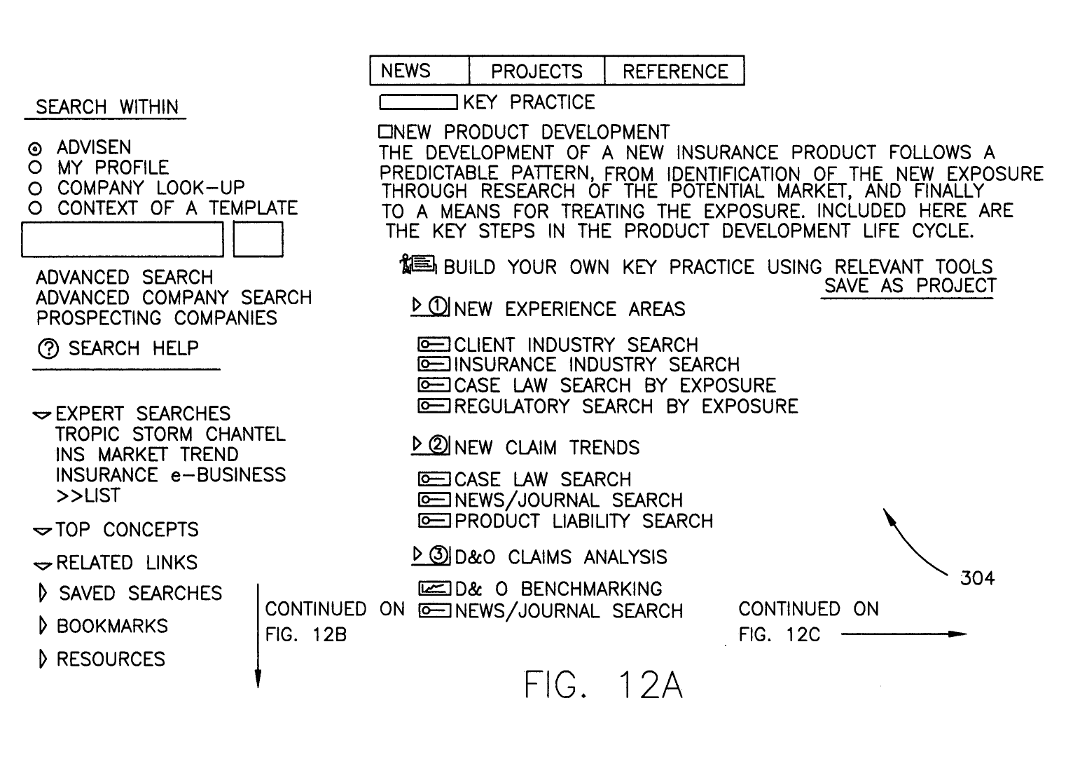

FIG. 13 illustrates a workspace and more specifically, a key practice portion 304, after a user selects the reference button of FIG. 5a. In response, workspace administrator module 102 displays a list of all references contained in or tracked by database 37. This enables the user to access various references in a centralized format.

It is noted that the key practice portions described in the preceding figs are for illustrative purposes only, and the invention is not limited in scope in that respect. Knowledge management system 28 can be configured in accordance to other embodiments of the invention so as to generate and display other key practice templates relating to other desired workflows. This can be handled either by the user itself or by a system administrator who plans to distribute the system to other users.

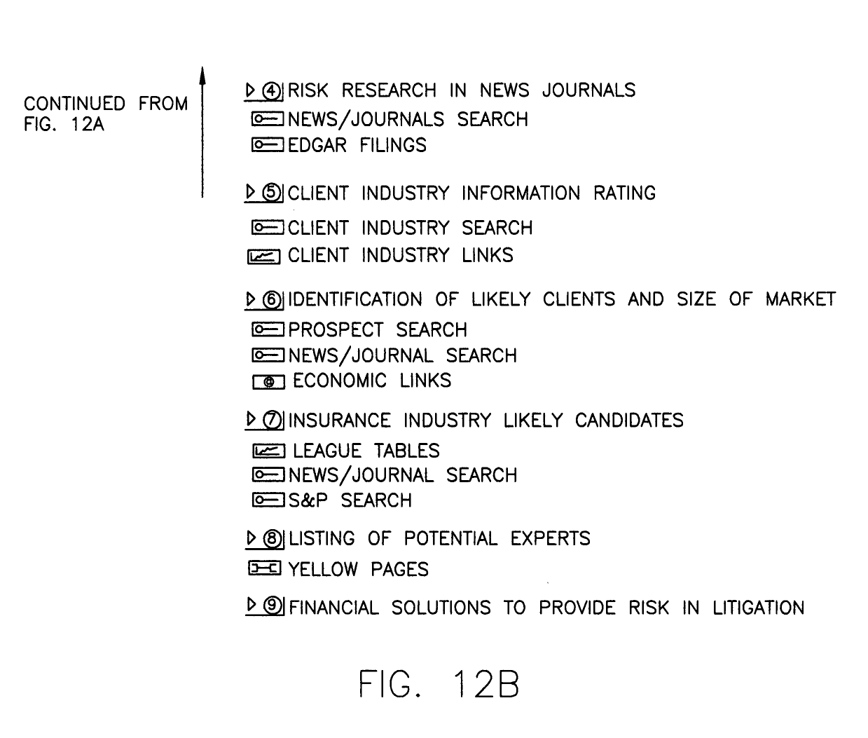

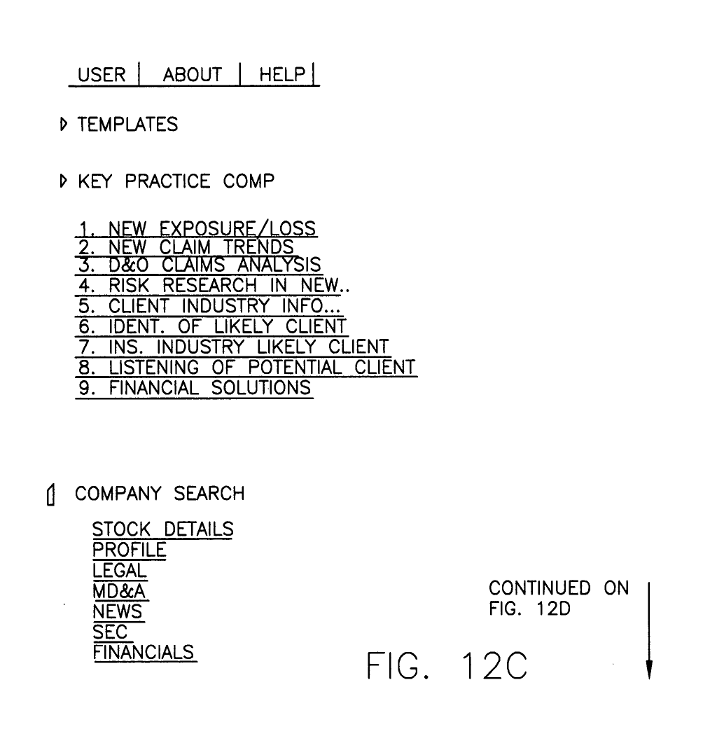

Referring now to FIG. 14, a block diagram of analytical module 108 is described in more detail. Analytical module 108 includes analytical tools that can be employed by the users when conducting research or performing the workflows specified in key practice portions 304. To this end, analytical module 108 includes an interface unit 490 that is configured to receive data from various tool modules within module 108 and provide that data to workspace administrator 102 (FIG. 1) for display to the user. Analytical module 108 includes an P&C benchmarking module 460, which is configured to perform property and casualty (P&C) benchmarking as understood by those skilled in the art. Module 108 also includes a company comparison module 462 that is configured to perform comparison of key information of companies specified by the user.

Analytical module 108 also includes a league table module 46, which is configured to generate league tables. Module 108 also includes a co-charting module 468, which is configured to generate various charts as necessary. Module 108, also includes a risk accounting module 470, which is configured to conduct risk accounting as understood by those skilled in the art. RIMS data module 472 is configured to provide data developed by the Risk and Insurance Management Society industry, for research purposes of the user. Claims data module 474 is configured to provide the claims data related to a company specified by the user. Loss triangle module 476 is configured to perform loss triangle analysis.

The Loss Triangles feature enables policyholders to create a customized electronic loss history up to and including for example five years of data—aggregated in real-time on an annual basis—providing users with an integrated picture of how losses for Worker's Compensation, Automobile and General Liability and other coverages have developed over time.

The information can be tabulated by Loss Paid or Total Incurred and can also compare the worker's compensation results against industry averages using the latest National Council on Compensation Insurance (NCCI) statistics.

The Loss Triangle feature also provides the user with Loss Development Factors (LDF)—based on a company's specific loss experience—which, collectively can be strategically used to forecast future loss development or determine the effectiveness of specific risk management programs.

For example, a Loss Triangle report can be utilized to analyze the effectiveness of “back-to-work” initiatives—programs, which are traditionally implemented by many companies to limit Worker's Compensation losses. In addition, Loss Triangle reports can be used to measure the claims handling efficiency of Third Party Administrators (TPA).

Severity Monte Carlo Simulation module 478 provides the user with the tools necessary to perform that simulation, for actuarial and other calculations. Module 480 provides analysis for financial modeling of cost structures as desired by the user. Safety administration report module 482 generates reports relating to safety issues for mitigating risks related to an organization. Similarly engineering report module 484 is configured to generate engineering reports relates to various risks a specified organization is exposed. Finally, financial summary module 486, provides information related to the financials of the organization being researched by the user.

FIG. 15 is a block diagram of various components of administrative efficiency tool module 110, in accordance with one embodiment of the invention. Administrative efficiency tool module 110 is configured to provide a plurality of chart drawing functionalities that enable the user to asses various insurance programs. To this end module 110 includes a user policy data input module 516, which is configured to receive all relevant information relating to the insurance coverages of an organization as specified by the user. User policy data input module 516 is coupled to database 37 so that information relating to all users can be stored and employed by knowledge management system 28.

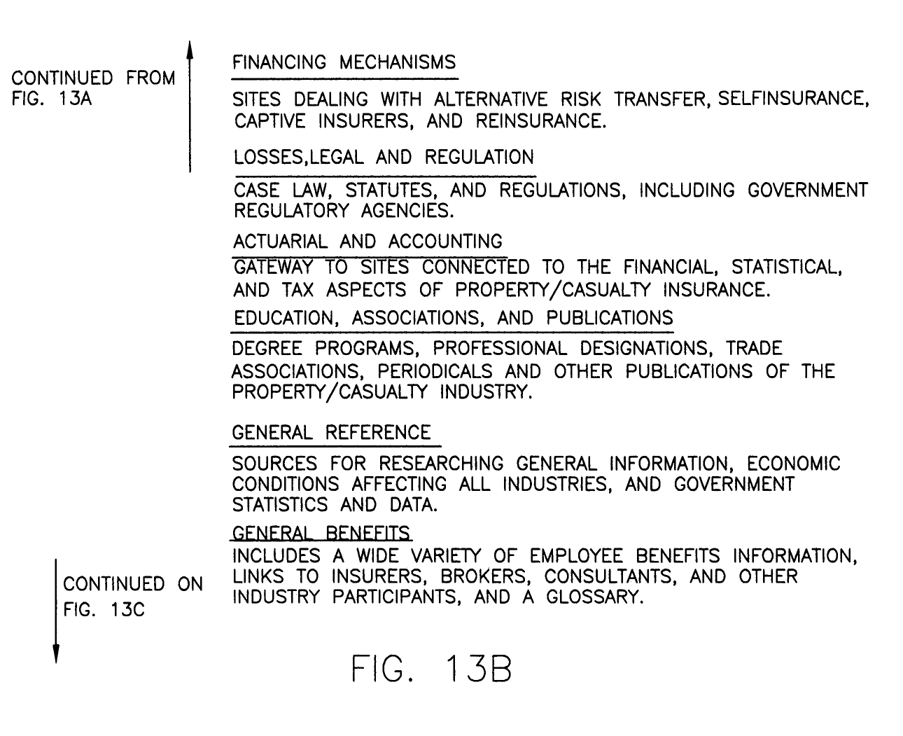

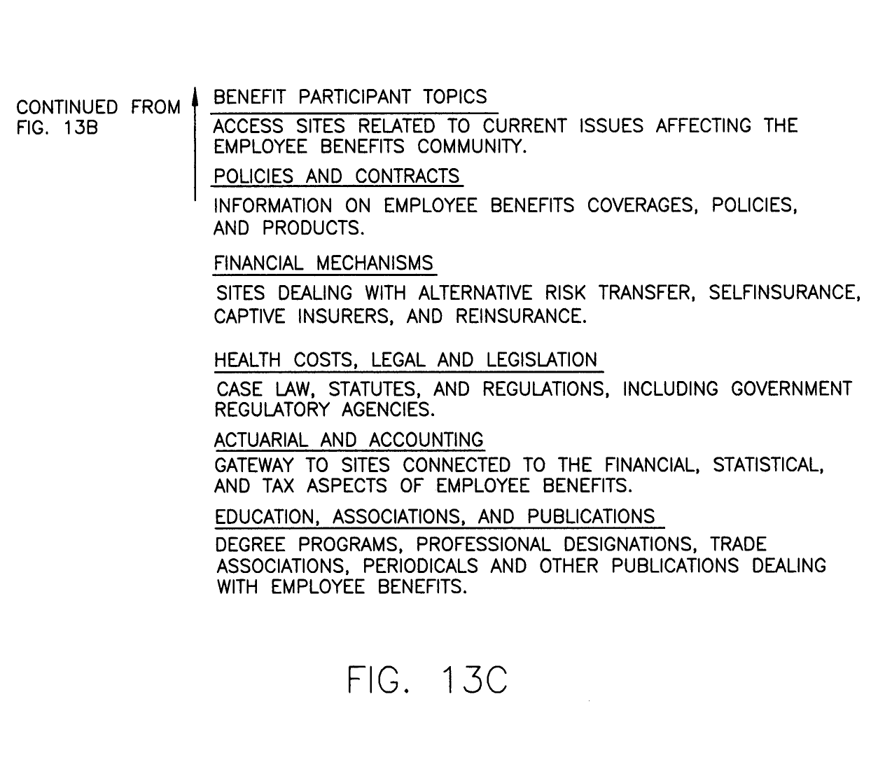

Module 15 also includes a single period insurance analyzer that determines and charts a list of a specified insurance policy of an organization extended over a specified period. FIG. 16 illustrates an exemplary coverage chart 570 for a single period specified by the user. The chart includes various portions that identify the type of insurance coverage, the policy amount, its effective dates, and whether they are retroactive and/or extended. Chart 570 provides the user with a visual summary of all pertinent insurance information of a company within a specified period.

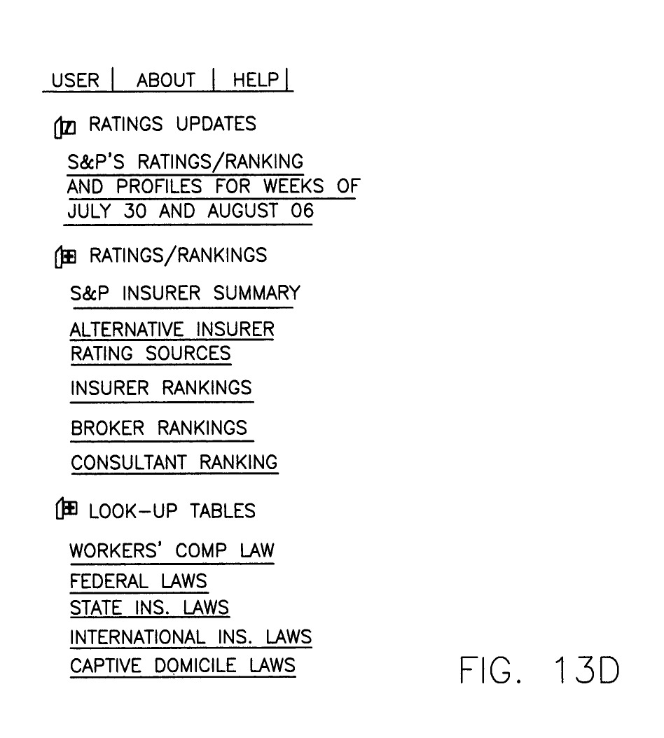

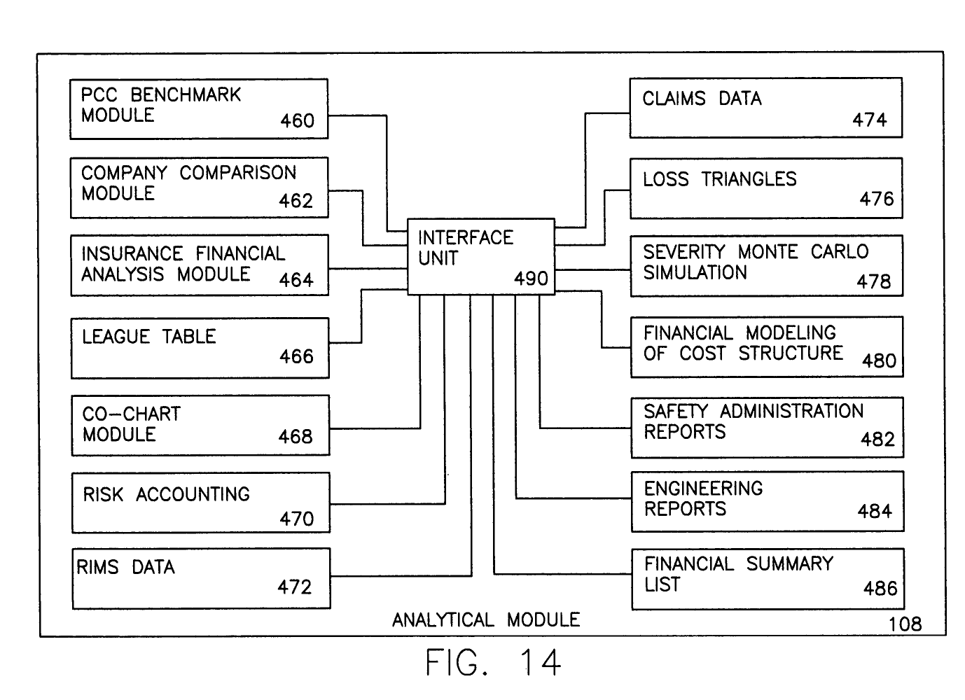

Referring back to FIG. 15, administrative efficiency module 110 also includes a multiple period single insurance analyzer 512, which is configured to provide a visual table that summarizes a single insurance program of an organization within multiple periods. FIG. 17 illustrates an exemplary coverage chart 580 for a multiple period single insurance program specified by the user in accordance with one embodiment of the invention. The chart includes various portions that identify the liability coverage for each specified period over many periods, for example, on a yearly basis over a period of five years.

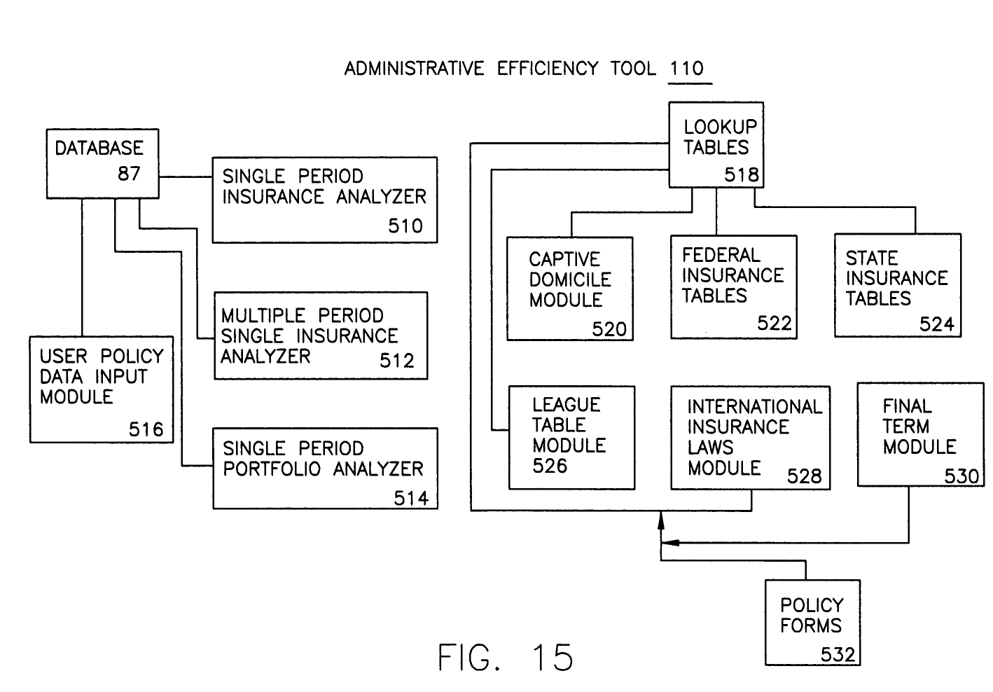

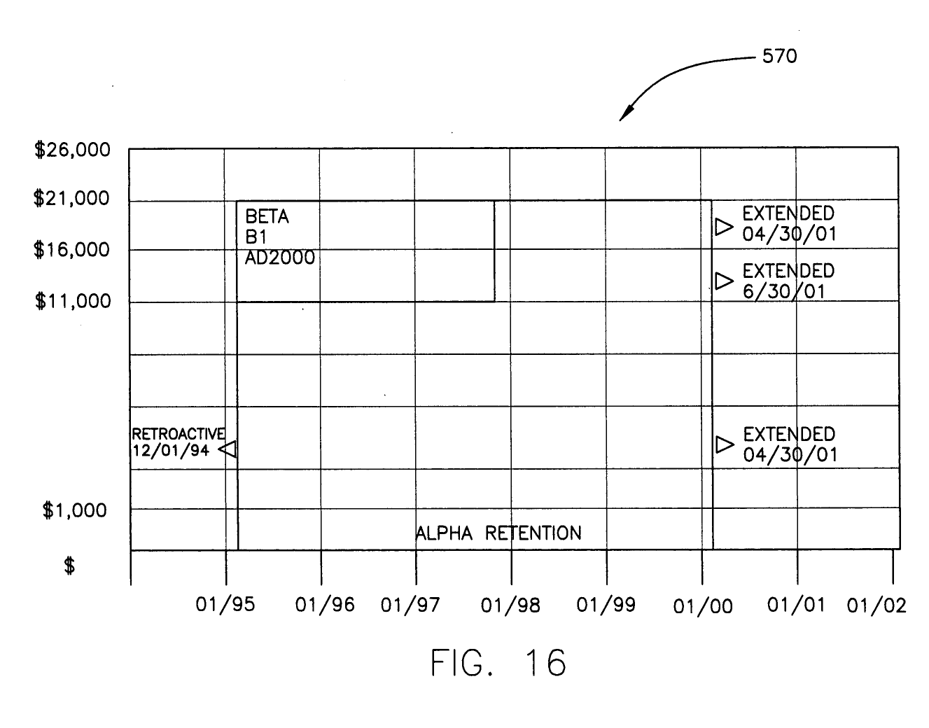

Referring back to FIG. 15, administrative efficiency module 110 also includes a single period portfolio analyzer 514, which is configured to provide a visual table that summarizes the portfolio of all insurance policies owned by an organization over a specified period. FIG. 18 illustrates an exemplary coverage chart 590 for a single period portfolio insurance view in accordance with one embodiment of the invention. Thus, the chart illustrates that for a specified period, the organization has commercial general liability insurance with various sublimits, an environmental liability insurance, a travel accident coverage and a workers compensation coverage.

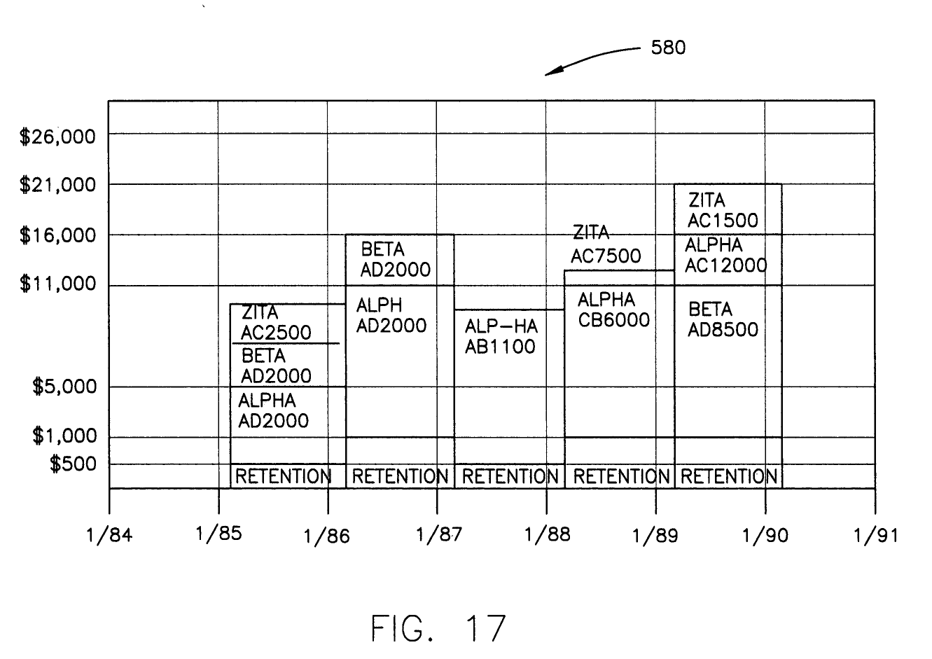

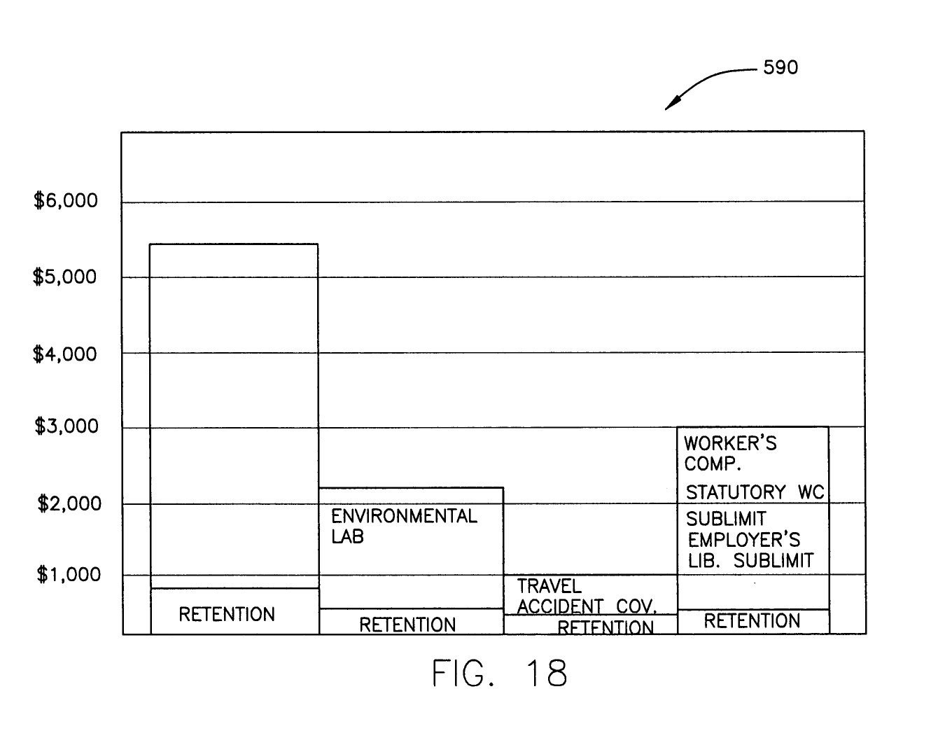

FIG. 19 illustrates the format that user policy data input module 516 collects insurance information from the user, and the format that illustrates the graphic displays in accordance with one embodiment of the invention.

Referring back to FIG. 15, a look up module 518 is configured to provide various look up functionalities for the user. As such, administrative efficiency tool module includes a captive domicile module 520 coupled to look up table module 518. Captive insurance refers to a subsidiary corporation established to provide insurance to the parent company and its affiliates. A captive insurance company represents an option for many corporations and groups that want to take financial control and manage risks by underwriting their own insurance rather than paying premiums to third-party insurers.

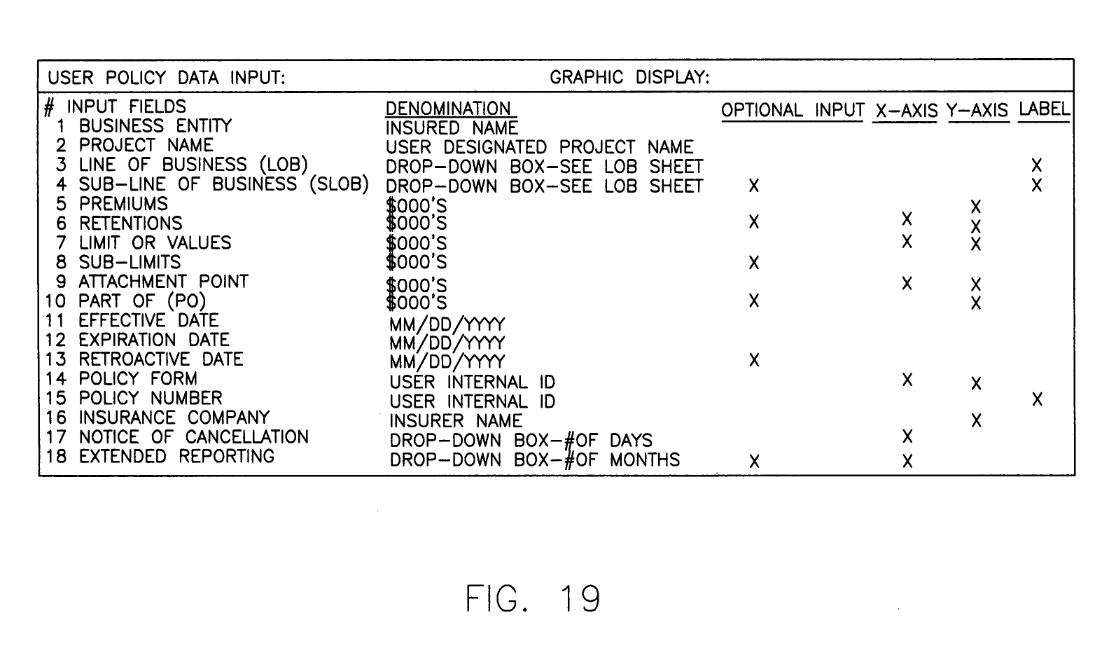

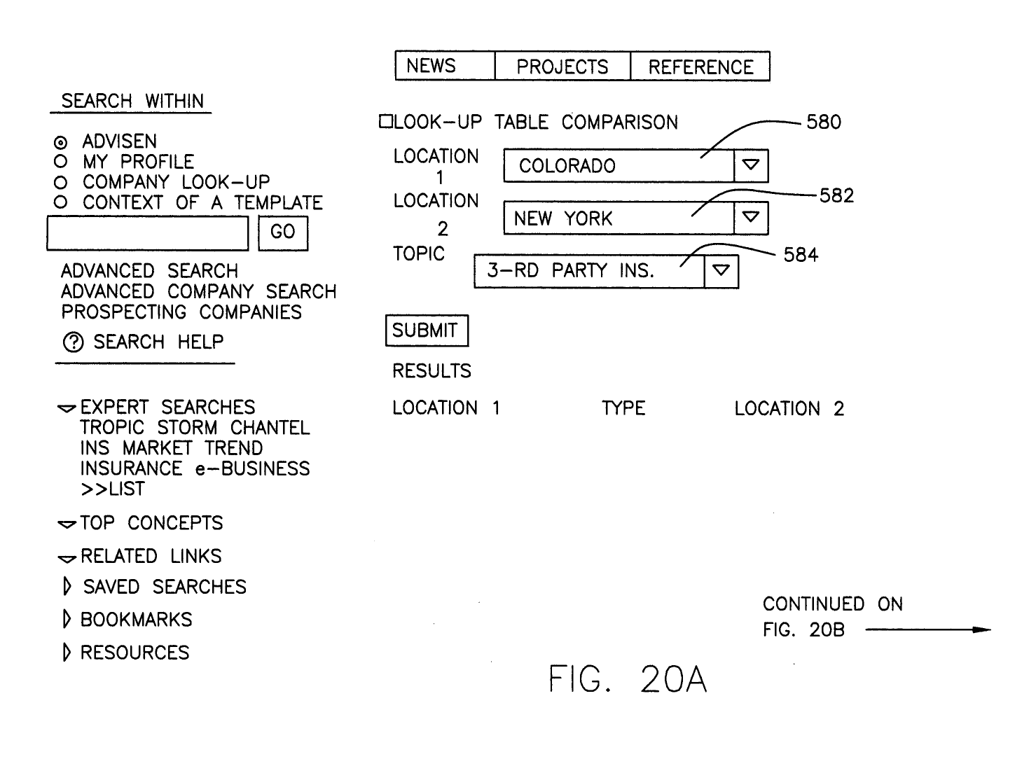

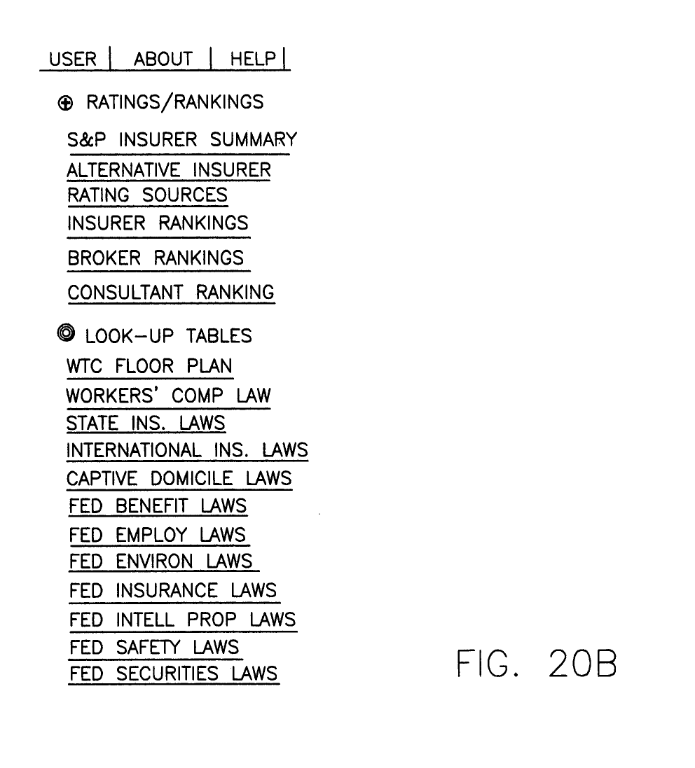

However, many insurance issues, such as captive domicile are governed by various state and federal regulations that vary in each jurisdiction. Look up table module 518, in accordance with one embodiment of the invention, allows the user to retrieve comparison tables, that set forth various rules relating to an issue so the user can asses the benefits and trade offs between each jurisdiction. To this end, FIG. 20 illustrates a work space 304, for look up table comparison function, wherein field 580 is used to state one jurisdiction (eg. Colorado), while field 582 is used to state another jurisdiction (eg. New York). For field 584, the user selects the topics that are available for comparison. In response look up table 518 prepares a corresponding look up table for the two jurisdictions and retrieves the relevant topics in each jurisdiction for display. This feature enables the user to efficiently retrieve regulations relating to an issue and further to compare their treatment in each jurisdiction.

In accordance with another embodiment of the invention, it is possible to select a topic and in response retrieve all jurisdictions that have corresponding regulations relating to that topic. FIG. 21 illustrates an example of a look up table that enables the user to view a treatment of a topic in all available jurisdictions. Thus, for example, a user can select a topic referred to as the name of statute(s) relating to an issue and request the system to identify the corresponding statute in each of the available jurisdictions, as depicted in FIG. 21.

Referring back to FIG. 15, administrative efficiency tool 110 includes a federal insurance laws module 522, coupled to look up table module 518, which is configured to provide look up comparisons, related to federal insurance law topics. Module 110, also includes a state insurance laws module 524, coupled to look up table module 518, which is configured to provide look up comparisons, related to state insurance law topics. Module 110 also includes an international insurance laws module 528, coupled to look up table module 518, which is configured to provide look up comparisons, related to international law topics.

Two additional modules coupled to look up table 518 include league table module 526, which provides comparison of various insurance ratings and financial term module 530, which is configured to provide financing topics for each jurisdiction.

Finally a policy form 532 module is also coupled to look up table 518. Policy form 532, is configured to provide a table of how various policies have treated a certain topic, by providing examples of prior forms. This enables the user to get an overall impression of coverages, exclusions, definitions for each form and jurisdiction.

It is noted that the present information management system although described in relation to the insurance industry, can be employed in other applications and is not limited in scope in that respect. For example, certain features of the present invention, can be used in any environment that requires substantial research functionality, such as law, medicine and finance. The contextualization and concept clustering modules can be easily configured for example, in a legal research engine, such as those commercially available like LEXIS and Westlaw.

While only certain features of the invention have been illustrated and described herein, many modifications, substitutions, changes or equivalents will now occur to those skilled in the art. It is therefore, to be understood that the appended claims are intended to cover all such modifications and changes that fall within the true spirit of the invention.

APPENDIX I

| | Insurance | | Group | | New Category | | Category Definition for |
|---|---|---|---|---|---|---|---|
| Risk Type | Type | Group | Prefix | Rating Groups | Prefix | Category Name | Collection of Documents |
| Hazard | Property | Risk/Exposure | PRRE_AA | A1 | A01_HZ_PR_RISK | Business Property | Buildings, Machinery, Equipment, Furniture, and Inventory |
| | | | | | | | used in the client's business operations, and which are exposed |
| | | | | | | | to loss from natural or man-made hazards or other events |
| | | | | | | | that decrease their asset value to the client. |
| Hazard | Property | Risk/Exposure | PRRE_AB | A1 | A02_HZ_PR_RISK | Vehicles Risk | Vehicles (excluding Watercraft and Aircraft) used in the client's |
| | | | | | | | business and which are exposed to loss from natural and road |
| | | | | | | | hazards, or which may cause bodily injury or property damage to |
| | | | | | | | others. |
| Hazard | Property | Risk/Exposure | PRRE_AG | A1 | A03_HZ_PR_RISK | Watercraft Risk | Ships, Boats, Tugs, Barges, Yachts and other Watercraft |
| | | | | | | | used for business purposes or business-related |
| | | | | | | | entertaining that are exposed to the perils of the sea. |
| Hazard | Property | Risk/Exposure | PRRE_AH | A1 | A04_HZ_PR_RISK | Aircraft Risk | Airplanes, Helicopters, and other Aircraft used for |
| | | | | | | | business purposes or business-related entertaining that |
| | | | | | | | are exposed to the perils of flying. |
| Hazard | Property | Risk/Exposure | PRRE_AC | A1 | A05_HZ_PR RISK | Electronic Data | Electronic Data Processing Equipment, including hardware |
| | | | | | | | and software, which are exposed to damage from natural |
| | | | | | | | hazards as well as those inherent in this type of property such |
| | | | | | | | as electrical breakdown, power surges, and loss of stored data. |
| Hazard | Property | Risk/Exposure | PRRE_AD | A1 | A06_HZ_PR_RISK | Intangible Assets | Intangible Assets/Intellectual Property, such as unique |
| | | | | | | | processes or ways of doing business that are subject to |
| | | | | | | | loss of value through copyright, trademark, or patent |
| | | | | | | | infringement, or other theft of ideas or processes. |
| Hazard | Property | Risk/Exposure | PRRE_AF | A1 | A07_HZ_PR_RISK | Contingent Exposures | Exposures involving Property of Suppliers or Customers |
| | | | | | | | that are damaged, preventing Client from obtaining raw |
| | | | | | | | materials or selling its goods. |
| Hazard | Property | Risk/Exposure | PRRE_AE | A1 | A08_HZ_PR_RISK | Earnings Revenues | Earnings/Revenues: Loss of profits due to property |
| | | | | | | | damage. |
| Hazard | Property | Perils | PRPL_BA | B1 | B01_HZ_PR_PRLS | Fire, including Arson | Fire, Lightning, Smoke, and other direct or indirect |
| | | | | | | | damage from fire, including fire from arson. |
| Hazard | Property | Perils | PRPL_BB | B1 | B02_HZ_PR_PRLS | Theft/Fraud | Theft/Crime/Employee Dishonesty/Forgery/Fraud/ |
| | | | | | | | Unauthorized Trading/Insider Trading/Computer Fraud |
| Hazard | Property | Perils | | B1 | B03_HZ_PR_PRLS | Cybercrime | Cybercrime, including internet hacking, computer |
| | | | | | | | viruses, and theft of customer information from website. |
| Hazard | Property | Perils | PRPL_BC | B1 | B04_HZ_PR_PRLS | Collision | Collision (Vehicles, excluding Watercraft and Aircraft): |
| | | | | | | | damage to vehicles from hitting another vehicle or |
| | | | | | | | object. |
| Hazard | Property | Perils | PRPL_BC1 | B1 | B04a_HZ_PR_PRLS | Vandalism | Vandalism and malicious mischief damage to insured |
| | | | | | | | property. |
| Hazard | Property | Perils | PRPL_BD | B1 | B05_HZ_PR_PRLS | Defective Products | Defective Products - first-party loss for the cost of removing |
| | | | | | | Hazard | defective products from the marketplace and destroying them, |
| | | | | | | | and third-party liability for injury to others from the |
| | | | | | | | defective products. |
| Operational | Property | Perils | | B1 | B06_OP_PR_PRLS | Defective Products Ops | Defective Products (Insured's loss from Recall, such as |
| | | | | | | | cost to remove products from stores and destroy them - |
| | | | | | | | excluding liability to others). |
| Hazard | Property | Perils | PRPL_BJ | B1 | B07_HZ_PR_PRLS | Terrorism | Terrorism, Kidnap and Ransom: countries where |
| | | | | | | | terrorism/kidnapping are problematic; groups committing these |
| | | | | | | | acts; types of terrorism to be on alert for in various countries. |
| Hazard | Property | Perils | PRPL_BJ1 | B1 | B07a_HZ_PR_PRLS | Tornado | Tornado catastrophe exposure |
| Hazard | Property | Perils | PRPL_BE | B1 | B08_HZ_PR_PRLS | Hurricane and Windstorm | Hurricane/Windstorm/Tornado/Hail: catastrophe |
| | | | | | | | exposure from these perils in various geographic areas. |
| Hazard | Property | Perils | PRPL_BF | B1 | B09_HZ_PR_PRLS | Earthquake | Earthquake and Subsidence: catastrophe exposure from |
| | | | | | | | these perils in various geographic areas. |
| Hazard | Property | Perils | PRPL_BH | B1 | B10_HZ_PR_PRLS | Flood | Flood: catastrophe exposure from this peril in various |
| | | | | | | | geographic areas. |
| Hazard | Property | Perils | PRPL_BI | B1 | B11_HZ_PR_PRLS | Other Natural | Other Natural Hazards, Freezing of Property, Water |
| | | | | | | | Leakage, and Collapse |
| Hazard | Casualty | Exposures | CAEX_CA | C1 | C01_HZ_CS_EXPS | Premises/Operations | Third Party Suits of Claims (actual or potential) Arising |
| | | | | | | | from Premises or Operations, including bodily injury and |
| | | | | | | | property damage to others occurring on client's |
| | | | | | | | premises or arising from their operations. |
| Hazard | Casualty | Exposures | CAEX_CB | C1 | C02_HZ_CS_EXPS | Vehicles Exposure | Third Party Suits or Claims (actual or potential) Arising from |
| | | | | | | | Vehicles (excluding Watercraft and Aircraft), including |
| | | | | | | | bodily injury and property damage caused by vehicles. |
| Hazard | Casualty | Exposures | CAEX_CL | C1 | C03_HZ_CS_EXPS | Watercraft Exposure | Third Party Suits or Claims (actual or potential) Arising |
| | | | | | | | from Watercraft, including bodily injury and property |
| | | | | | | | damage caused by the Watercraft. |
| Hazard | Casualty | Exposures | CAEX_CM | C1 | C04_HZ_CS_EXPS | Aircraft Exposure | Third Party Suits or Claims (actual or potential) Arising |
| | | | | | | | from Aircraft, including bodily injury and property |
| | | | | | | | damage caused by the Aircraft. |
| Hazard | Casualty | Exposures | CAEX_CC | C1 | C05_HZ_CS_EXPS | Products/Products Recall | Third Party Suits or Claims (actual or potential) Arising |
| | | | | | | Exposure | from Products, Products Recall, and/or Completed |
| | | | | | | | Operations, including bodily injury and property damage |
| | | | | | | | caused by defective products or workmanship. |
| Hazard | Casualty | Exposures | CAEX_CD | C1 | C06_HZ_CS_EXPS | Environmental | Third Party Suits or Claims (actual or potential) Arising |
| | | | | | | Contamination | from Environmental Contamination (other than from |
| | | | | | | | faulty Products), including damage to others and |
| | | | | | | | cleanup costs for the client's own property. |
| Hazard | Casualty | Exposures | CAEX_CE | C1 | C07_HZ_CS_EXPS | Libel and Slander | Third Party Suits or Claims (actual or potential) Arising from |
| | | | | | | | Libel/Slander that damages a third party's reputation |
| Hazard | Casualty | Exposures | CAEX_CF | C1 | C08_HZ_CS_EXPS | Copyright Infringement | Third Party Suits or Claims (actual or potential) Arising |
| | | | | | | | from Copyright/Trademark/Intellectual Property |
| | | | | | | | Infringement |
| Hazard | Casualty | Exposures | CAEX_CG | C1 | C09_HZ_CS_EXPS | Fiduciary Liability - from | Shareholder, Employee or Third - Party Suits or Claims (actual |
| | | | | | | ERISA | or potential) arising from activities of Officers, Directors, or |
| | | | | | | | Employees, including employees' suits or claims against |
| | | | | | | | sponsors of trustees of Employee Benefit Plans, including |
| | | | | | | | Pension Plans and Health and Welfare plans. |
| Hazard | Casualty | Exposures | CAEX_CG1 | C1 | C09a_HZ_CS_EXPS | Fiduciary Liability - to | Shareholder claims alleging breach of fiduciary duties |
| | | | | | | Shareholders | resulting in financial loss to shareholders. |
| Hazard | Casualty | Exposures | CAEX_CG2 | C1 | C09b_HZ_CS_EXPS | Fiduciary Liability - to | Suits by clients or customers alleging breach of fiduciary |
| | | | | | | Clients and Customers | duties resulting in financial loss to clients or customers. |
| Hazard | Casualty | Exposures | CAEX_CK | C1 | C10_HZ_CS_EXPS | Professional Services | Professional Services: Exposures created by the |
| | | | | | | Liability | existence or proposal of professional standards of |
| | | | | | | | conduct by government agencies, accredited associations, |
| | | | | | | | case law, or custom and practice, and Suits or Claims |
| | | | | | | | (actual or potential) arising from such exposures or services. |
| Hazard | Casualty | Exposures | CAEX_CH | C1 | C11_HZ_CS_EXPS | Job Injuries | Suits or Claims (actual or potential) by Employees |
| | | | | | | | Arising from On-the-Job Injuries and |
| | | | | | | | Employment-Related Illnesses and Diseases, including |
| | | | | | | | loss control to mitigate such exposures |
| Hazard | Casualty | Exposures | CAEX_CH2 | C1 | C11a_HZ_CS_EXPS | Employment Practices | Suits or Claims involving employment-related |
| | | | | | | Liability Exposure | discrimination, harassment, or wrongful discharge under |
| | | | | | | | federal, state, local, and common law. |
| Hazard | Casualty | Exposures | CAEX_CH3 | C1 | C12_HZ_CS_EXPS | Corporate Entity Liability - | Corporate Liability (actual or potential) related to Benefit |
| | | | | | | Arising From Benefits | Plans, a/k/a Employee Benefit Liability (EBL), dealing |
| | | | | | | Programs | withas employer negligence in administering benefit |
| | | | | | | | plans, such failing to enroll employee in group plan. |
| Hazard | Casualty | Exposures | CAEX_CH4 | C1 | C12a_HZ_CS_EXPS | Corporate Entity Liability | Direct liability of corporation for breach of duty to shareholders, |
| | | | | | | | employees, or other Third parties other than tort |
| | | | | | | | liability (bodily injury, property damage, personal injury). |
| Hazard | Casualty | Exposures | CAEX_CI | C1 | C13_HZ_CS_EXPS | Directors and Officers | Suits or Claims (actual or potential) by Employees, |
| | | | | | | Liability | Government Regulators, Shareholders, or Others, |
| | | | | | | | Arising from Activities of the Board of Directors, or |
| | | | | | | | Managerial Employees. |
| Hazard | Casualty | Exposures | CAEX_CI1 | C1 | C13a_HZ_CS_EXPS | Breach of Contractual | Suite or claims (actual or potential) arising from |
| | | | | | | Responsibilities | non-performance of obligations under contracts of all |
| | | | | | | | types. |
| Hazard | Casualty | Exposures | CAEX_CI2 | C1 | C13b_HZ_CS_EXPS | Corporate Liability related | Liabilities arising out of public or private mergers and |
| | | | | | | to mergers and | acquisitions transactions, including breach of |
| | | | | | | acquisitions. | representations and waraanties and tax opinions, or |
| | | | | | | | other disclosures, or the handling of contingent liabilities. |
| Hazard | Casualty | Exposures | CAEX_CJ | C1 | C14_HZ_CS_EXPS | Product Recall Exposure | |
| Hazard | Casualty | Exposure | CAEX_CK | C1 | C15_HZ_CS_EXPS | Asbestos | Asbestos - liability (actual or potential) to others for |
| | | | | | | | asbestosis and other lung diseases caused by asbestos |
| | | | | | | | (previously used as a fire retardant) manufactured or |
| | | | | | | | incorporated into buildings or products. |
| Hazard | Casualty | Exposure | CAEX_CL | C1 | C16_HZ_CS_EXPS | Privacy Regulations | Privacy Regulations - liability (actual or potential) to others for |
| | | | | | | | violating their right to privacy, such as their right to medical |
| | | | | | | | privacy, financial privacy (Fair Credit Reporting Act), |
| | | | | | | | and personal privacy (surveillance restrictions). |
| Hazard | Casualty | Exposure | CAEX_CM | C1 | C17_HZ_CS_EXPS | Workplace Violence | Workplace Violence - liability (actual or potential) to |
| | | | | | | | customers or employees stemming from acts of |
| | | | | | | | workplace violence traceable to inadequate security or |
| | | | | | | | training by employer. |
| Hazard | Casualty | Exposure | CAEX_CM1 | C1 | C17a_HZ_CS_EXPS | Workplace Discrimination, | Age discrimination, sex discrimination, sexual |
| | | | | | | Harassment, etc. | harassment, unlawful termination, and other |
| | | | | | | | employment-related activities that could result in claims |
| | | | | | | | against an employer. |
| Hazard | Casualty | Exposure | CAEX_CM2 | C1 | C18_HZ_CS_EXPS | eSignature Debate | eSignature Debate - statutes and case law relating to |
| | | | | | | | the legal validity of electronic signatures on business |
| | | | | | | | documents. A recently-passed federal law recognizes |
| | | | | | | | such signatues as binding under most circumstances. |
| Hazard | Casualty | Exposure | CAEX_CM3 | C1 | C19_HZ_CS_EXPS | Internet Privacy | Internet Privacy - liability (actual or potential) of those |
| | | | | | | | engaging in electronic commerce to users of their |
| | | | | | | | websites who allege unauthorized disclosure of |
| | | | | | | | personal information such as credit card numbers, |
| | | | | | | | prescriptions, medical conditions, and financial matters. |
| Hazard | Casualty | Exposure | CAEX_DM4 | C1 | C20_HZ_CS_EXPS | Technology Risks | Technology Risks - liability (actual or potential) to |
| | | | | | | | others, or damage to or loss of value of entity's own |
| | | | | | | | property, caused by obsolesence of technology, |
| | | | | | | | incompatibility of systems, or equipment failure. |
| Financial | All | Exposures | FAEX_CN | C0 | C21_FN_AL_EXPS | Financial Risk | General overview and trend-type articles on financial risk |
| | | | | | | | exposures that do not focus entirely on any one specific |
| | | | | | | | type of financial risk more specifically covered by |
| | | | | | | | another Financial category. |
| Financial | All | Exposures | FAEX_CN1 | C0 | C25_FN_AL_EXPS | Currency Risk | The risk that the exchange rate of a country's currency |
| | | | | | | | vis-a-vis the currency of certain other countries in which |
| | | | | | | | the company transacts business will change or fluctuate, |
| | | | | | | | causing financial loss to the company. |
| Financial | All | Exposures | FAEX_CN2 | C0 | C26_FN_AL_EXPS | Market Risk | The risk that the market for certain goods or services will change |
| | | | | | | | between the time the goods were produced or services developed |
| | | | | | | | and the time they are offered for sale, in such a way |
| | | | | | | | that the goods or services will be rendered obsolete or |
| | | | | | | | their value significantly decreased. Also, the purchase of |
| | | | | | | | products in the capital markets based on one view of the market, |
| | | | | | | | and the market performs in a different or opposite way. |
| Financial | All | Exposures | FAEX_CN3 | C0 | C27_FN_AL_EXPS | Principal Risk | the risk that the principal portion of a loan will not be |
| | | | | | | | recouped by the lender due to the inability of the |
| | | | | | | | borrower to pay. |
| Financial | All | Exposures | FAEX_CN4 | C0 | C28_FN_AL_EXPS | Liquidity Risk | The risk that a company will not have sufficient cash on |
| | | | | | | | hand to meet obligations as they come due. This risk |
| | | | | | | | can have a domino effect in the capital markets. |
| Financial | All | Exposures | FAEX_CN5 | C0 | C29_FN_AL_EXPS | Credit Risk | The risk that customers with which a company does |
| | | | | | | | business will not be able to pay for goods or services |
| | | | | | | | provided or rendered to them in advance of payment. |
| | | | | | | | Also, when a lender receives payment late on a regular basis, |
| | | | | | | | or the likelihood that interest and principal will not be repaid. |
| Financial | All | Exposures | FAEX_CN6 | C0 | C30_FN_AL_EXPS | Interest Rate Risk | The risk that interest rates will change or fluctuate in a |
| | | | | | | | way that adversely affects the company's business, |
| | | | | | | | loans, or debt instruments. |
| Financial | All | Exposures | FAEX_CN7 | C0 | C31_FN_AL_EXPS | Asset Values | The risk that the value of certain assets will change or |
| | | | | | | | fluctuate in a way that adversely impacts the company's |
| | | | | | | | balance sheet or the potential sale or resale of those assets. |
| Financial | All | Exposures | FAEX_CN8 | C0 | C32_FN_AL_EXPS | Contingent Liabilities | The risk that reserves in a liability portfolio will be |
| | | | | | | | inadequate to cover actual losses, resulting in additional |
| | | | | | | | expense to the purchaser of the portfolio. |
| Operational | All | Exposures | OAEX_CO | C0 | C22_OP_AL_EXPS | Operational Risk | Risk stemming from interruption in Operations such as |
| | | | | | | | from technological malfunction. |
| Strategic | All | Exposures | SAEX_CP | C0 | C23_ST_AL_EXPS | Strategic Risk | Risk stemming from changes in market or business |
| | | | | | | | strategies. |
| Enterprise | All | Exposures | EAEX_CQ | C0 | C24_EN_AL_EXPS | Enterprise Risk | Risk encompassing all of an organization's related |
| | | | | | | | Hazard Financial, Operational, and Strategic Risks. |
| | | | | | | OTJ Discrimination | OTJ Discrimination Harrasment |
| | | | | | | Harrasment | |
| Hazard | Property | Coverage | PCPM_DA | D1 | D01_HZ_PR_CVRG | Fire Coverage | Risk Transfer Property Insurance Products |
| | | Products/ | | | | | Fire and Allied Lines - |
| | | Mitigation | | | | | Policy terms, coverage issues (including litigation) rate |
| | | | | | | | levels, availability, new products, general trends (e.g. |
| | | | | | | | increases in property values, inflation). |
| Hazard | Property | Coverage | PCPM_DB | D1 | D02_HZ_PR_CVRG | Business Interruption | Risk Transfer Property Insurance Products |
| | | Products/ | | | | | Business Interruption - |
| | | Mitigation | | | | | Policy terms, coverage issues (including coverage |
| | | | | | | | litigation, occurrence vs. claims made forms), rate |
| | | | | | | | levels, availability, new products, general trends |
| | | | | | | | (change in buying habits, higher limits purchased by |
| Hazard | Property | Coverage | PCPM_DC | D1 | D03_HZ_PR_CVRG | Difference in Conditions | Risk Transfer Property Insurance Products |
| | | Products/ | | | | | Differences in Conditions - |
| | | Mitigation | | | | | Policy terms, coverage issues, (including coverage |
| | | | | | | | litigation), rate levels, all-risk coverage, availability, |
| | | | | | | | new products, new markets, general trends. |
| Hazard | Property | Coverage | PCPM_DC1 | D1 | D03a_HZ_PR_CVRG | Earthquake Coverage | Risk Transfer Insurance Products - Monoline earthquake |
| | | Products/ | | | | | coverage. |
| | | Mitigation | | | | | |
| Hazard | Property | Coverage | PCPM_DC2 | D1 | D03b_HZ_PR_CVRG | Flood Coverage | Risk Transfer Insurance Products - Monoline flood |
| | | Products/ | | | | | coverage including Federal Flood Insurance. |
| | | Mitigation | | | | | |
| Hazard | Property | Coverage | PCPM_DD | D1 | D04_HZ_PC_CVRG | Boiler and Machinery | Risk Transfer Property Insurance Products |
| | Casualty | Products/ | | | | | Boiler and Machinery - policy terms, coverage issues, |
| | | Mitigation | | | | | market capacity, rates, products, and general trends for insurance |
| | | | | | | | covering breakdown of boilers, machinery, and equipment. |
| Hazard | Property | Coverage | PCPM_DE | D1 | D05_HZ_PR_CVRG | Inland Marine | Risk Transfer Property Insurance Products |
| | | Products/ | | | | | Inland Marine - |
| | | Mitigation | | | | | Policy terms, coverage issues, availability, rate levels, |
| | | | | | | | general trends (insured's buying higher limits, slow |
| | | | | | | | down in housing starts, construction projects slowing |
| Hazard | Property | Coverage | PCPM_D7 | D1 | D06_HZ_PC_CVRG | Ocean Marine | Risk Transfer Property Insurance Products - Ocean |
| | Casualty | Products/ | | | | | Marine - Policy terms, coverage issues, availability, |
| | | Mitigation | | | | | rate levels, general trends (hull, cargo, watercraft liability). |
| Hazard | Property | Coverage | PCPM_D9 | D1 | D07_HZ_PC_CVRG | Aviation Coverage | Risk Transfer Property Insurance Products - Aviation - |
| | Casualty | Products/ | | | | | Policy terms, coverage issues, availability, rate levels, |
| | | Mitigation | | | | | general trends (hull, cargo, aircraft liability). |
| Hazard | Property | Coverage | PCPM_DF | D1 | D08_FN_PR_CVRG | Political Risk | Risk Transfer Property Insurance Products |
| | | Products/ | | | | | Political Risk - |
| | | Mitigation | | | | | Policy terms, coverage issues (including coverage |
| | | | | | | | litigation), rate levels, availability (new markets, withdrawal |
| | | | | | | | of markets), general trends(economic trends, major |
| | | | | | | | swings in exchange rates, comodity prices, inflation rates.) |
| Hazard | Casualty | Coverage | PCPM_DG | D1 | D09_HZ_CS_CVRG | General Liability | Risk Transfer Casualty Insurance Products |
| | | Products/ | | | | | General Liability |
| | | Mitigation | | | | | Policy terms, coverage issues (including coverage |
| | | | | | | | litigation), rate levels, availability, new products, general |
| | | | | | | | trends (e.g. insured's buying higher limits). |
| Hazard | Property | Coverage | PCPM_DH | D1 | D10_HZ_PC_CVRG | Automobile Coverage | Risk Transfer Casualty Insurance Products |
| | Casualty | Products/ | | | | | Automobile - |
| | | Mitigation | | | | | Policy terms, coverage issues (including coverage |
| | | | | | | | litigation), rate levels, new products, changes in |
| | | | | | | | distribution channels, new regulations, general trends |
| | | | | | | | (e.g. increases in claim frequencies or severity, new car |
| | | | | | | | sales, shift in types of vehicles purchased, change in |
| | | | | | | | annual miles driven or price of gas) |
| Hazard | Property | Coverage | PCPM_DI | D1 | D11_HZ_PR_CVRG | Product Liability | Risk Transfer Casualty Insurance Products |
| | | Products/ | | | | Coverage | Product Liability - |
| | | Mitigation | | | | | Policy terms, coverage issues (including coverage |
| | | | | | | | litigation) rate levels, availability, new products, general |
| | | | | | | | trends (e.g. higher jury awards, new requlations) |
| Operational | Casualty | Coverage | PCPM_DJ | D1 | D12_OP_CS_CVRG | Product Recall Coverage | Risk Transfer Casualty Insurance Products |
| | | Products/ | | | | | Product Recall - |
| | | Mitigation | | | | | Policy terms, coverage issues, (including coverage |
| | | | | | | | litigation), rate levels, changes in availability, new |
| | | | | | | | products, changes in requlations, general trends (e.g. |
| | | | | | | | insured's buying coverage, or buying higher limits) |
| Hazard | Casualty | Coverage | PCPM_DK | D1 | D13_HZ_CS_CVRG | Directors and Officers - | Risk Transfer Casualty Insurance Products |
| | | Products/ | | | | Liability Insurance | Directors & Officers |
| | | Mitigation | | | | | Policy terms, coverage issues (including coverage |
| | | | | | | | litigation), rate levels, availability, new products, general |
| | | | | | | | trends (e.g. insured's buying higher limits, allocation of |
| | | | | | | | loss between entity and directors/officers and allocation |
| | | | | | | | between covered/uncovered claims). |
| Hazard | Casualty | Coverage | PCPM_DK1 | D1 | D13a_HZ_CS_CVRG | Directors and | Risk Transfer Casualty Insurance Products |
| | | Products/ | | | | Officers - Liability | Directors & Officers-Entity |
| | | Mitigation | | | | Insurance - Entity | Policy terms, coverage issues (including coverage |
| | | | | | | Coverage | litigation), rate levels, availability, new products, general |
| | | | | | | | trends regarding the providing of entity coverage under |
| | | | | | | | D&O insurance policies. |
| Hazard | Casualty | Coverage | PCPM_DK2 | D1 | D13b_HZ_CS_CVRG | Partnership Liability | Risk Transfer Casualty Insurance Products - Partnership |
| | | Products/ | | | | | Liability - Policy terms, coverage issues (including |
| | | Mitigation | | | | | coverage litigation), rate levels, availability, new |
| | | | | | | | products, general trends regarding the providing of |
| | | | | | | | Partnership Liability, which covers suits against partners |
| | | | | | | | by other partners, government authorities, employees, or |
| | | | | | | | third-parties. |
| Hazard | Casualty | Coverage | PCPM_D8 | D1 | D14_HZ_CS_CVRG | Fiduciary Liability | Insurance covering trustees or employee benefit plans |
| | | Products/ | | | | Insurance | for violating their fiduciary responsibility under ERISA to |
| | | Mitigation | | | | | exercise reasonable care, resulting in investment losses |
| | | | | | | | or other losses by the benefit plans. |
| Hazard | Casualty | Coverage | PCPM_D4 | D1 | D15_HZ_CS_CVRG | Professional Liability | Policy terms, coverage issues (including coverage |
| | | Products/ | | | | Insurance - Professional | litigation), rate levels, availability, new products, general |
| | | Mitigation | | | | Services Firms | trends regarding the Professional Liability insurance |
| | | | | | | | policies for service firms. |
| Hazard | Casualty | Coverage | PCPM_D4a | D1 | D15a_HZ_CS_CVRG | Professional Liability | Risk Transfer Casualty Insurance ProductsProfessional |
| | | Products/ | | | | Insurance - Financial | Liability, Professional Indemnity, and Errors and |
| | | Mitigation | | | | Services Firms | Omissions: Claims-made versus occurrence policies, |
| | | | | | | | retroactive dates, extended reporting periods, coverage |
| | | | | | | | for intentional acts, for banks, insurance companies, |
| | | | | | | | mutual funds, investment advisors, securities brokers, |
| | | | | | | | and insurance brokers and agents, and all other |
| | | | | | | | non-bodily-injury-related financial services. |
| Hazard | Casualty | Coverage | PCPM_D4b | D1 | D15b_HZ_CS_CVRG | Professional Liability | Risk Transfer Casualty Insurance ProductsProfessional |
| | | Products/ | | | | Insurance - Healthcare | Liability, Professional Indemnity, and Errors and |
| | | Mitigation | | | | Organizations and | Omissions: Claims-made versus occurrence policies, |
| | | | | | | Medical Professionals | retroactive dates, extended reporting periods, coverage |
| | | | | | | | for intentional acts, for doctors, hospitals, Managed Care |
| | | | | | | | Organizations, nursing homes, and other services that |
| | | | | | | | may lead to bodily or mental injuries. |
| Hazard | Property | Coverage | PCPM_D5 | D1 | D16_HZ_PR_CVRG | Fidelity/Crime Coverage | Risk transfer products involving employee dishonesty, |
| | | Products/ | | | | | burglary, robbery, and other theft of money, securities, |
| | | Mitigation | | | | | or other property from a business or organization. |
| Hazard | Property | Coverage | PCPM_DL | D1 | D17_HZ_PC_CVRG | Environmental Coverage | Risk Transfer Casualty Insurance Products |
| | Casualty | Products/ | | | | | Environmental - |
| | | Mitigation | | | | | Policy terms, coverage issues (including coverage |
| | | | | | | | litigation), rate levels, availability, new products, general |
| | | | | | | | trends (e.g. new regulations, more aggressive |
| | | | | | | | enforcement), pollution coverage under general liability |
| | | | | | | | policies, cleanup coverage for insured's own property, |
| | | | | | | | cleanup cost over-runs |
| Hazard | Casualty | Coverage | PCPM_DM | D1 | D18_HZ_CS_CVRG | Employment Practices | Risk Transfer Casualty Insurance Products |
| | | Products/ | | | | Liability Insurance | Employment Practices |
| | | Mitigation | | | | | Policy terms, coverage issues (including coverage |
| | | | | | | | litigation), rate levels, availability, new products, general |
| | | | | | | | trends (e.g. insured's buying higher limits). (Harassment, |
| | | | | | | | Discrimination, Wrongful Discharge) |
| Hazard | Casualty | Coverage | PCPM_DM1 | D1 | D18a_HZ_CS_CVRG | Representation and | Insurance to replace or enhance the financial caps |
| | | Products/ | | | | Warranty Insurance | related to representations and warranties made in |
| | | Mitigation | | | | | connection with mergers, acquisitions, and sales. |
| Hazard | Casualty | Coverage | PCPM_DM2 | D1 | D18b_HZ_CS_CVRG | Tax Opinion Insurance | Insurance covering insured's additional and unexpected |
| | | Products/ | | | | (Contingent Tax | taxes or liabilities resulting from tax opinions that are |
| | | Mitigation | | | | Insurance) | found to be invalid. |
| Hazard | Casualty | Coverage | PCPM_DM3 | D1 | D18c_HZ_CS_CVRG | Contingent Liability | Insurance covering amounts that may be in excess of |
| | | Products/ | | | | Insurance | the reserves set for claims in a loss portfolio, removing |
| | | Mitigation | | | | | the known and potential liabilities from the balance |
| | | | | | | | sheet. |
| Hazard | Casualty | Coverage | PCPM_DN | D1 | D19_HZ_CS_CVRG | Umbrella Liability | Risk Transfer Casualty Insurance Products |
| | | Products/ | | | | Insurance | Umbrella and Excess Liability - |
| | | Mitigation | | | | | Policy terms, coverage issues, (including coverage |
| | | | | | | | litigation), rate levels, availability (including maximum |
| | | | | | | | limits available), new products, general trends (e.g. |
| | | | | | | | insured's buying higher limits, expansion of coverages |
| | | | | | | | provided, change from occurrence to claims made |
| | | | | | | | forms) |
| Hazard | Casualty | Coverage | PCPM_DO | D1 | D20_HZ_CS_CVRG | Workers Compensation | Risk Transfer Casualty Insurance Products |
| | | Products/ | | | | Insurance | Workers' Compensation and Employers' Liability |
| | | Mitigation | | | | | Policy terms, coverage issues (including coverage |
| | | | | | | | litigation), rate levels, availability, new products, |
| | | | | | | | exclusive remedy erosion, general trends |
| Hazard | Property | Coverage | PCPM_DP | D1 | D21_HZ_PC_CVRG | Multiline Coverage | Risk Transfer Casualty Insurance Products |
| | Casualty | Products/ | | | | | Multi-line - |
| | | Mitigation | | | | | Policy terms, coverage issues (including coverage |
| | | | | | | | litigation), rate levels, availability, new products, general |
| | | | | | | | trends, (e.g. higher policy limits, changes in claim |
| | | | | | | | severity, increases in medical inflation, increase in |
| | | | | | | | bankruptcies) |
| Hazard | Property | Coverage | PCPM_DQ | D1 | D22_HZ_PC_CVRG | Package Products | Risk Transfer: Package/Multi-line (P&C) Products - |
| | Casualty | Products/ | | | | | Policy terms, coverage issues (including litigation), |
| | | Mitigation | | | | | rate levels, availability, new products, general trends |
| | | | | | | | (e.g. higher policy limits, changes in claim severity, |
| | | | | | | | increase in medical inflation, increase in business |
| Hazard | Property | Coverage | PCPM_DQ1 | D1 | D22a_HZ_PC_CVRG | Surety Bonds | The guaranteeing a performance obligation of a principal |
| | Casualty | Products/ | | | | | to the obligee by the surety company., including rates, |
| | | Mitigation | | | | | contracts, markets, availability, new products and |
| | | | | | | | companies. |
| Hazard | Property | Coverage | PCPM_DQ2 | D1 | D22b_HZ_PC_CVRG | Financial Guarantee | The guaranteeing a financial obligation of a principal to |
| | Casualty | Products/ | | | | Bonds | the obligee by the financial guarantee company, such as |
| | | Mitigation | | | | | interest rates/coupons and the principal thereof for |
| | | | | | | | municipal and asset-backed securities, Including rates, |
| | | | | | | | contracts, markets, availability, new products and |
| | | | | | | | companies. |
| Enterprise | All | Coverage | PCPM_D6 | D1 | D23_EN_AL_CVRG | Integrated Risk Coverage | Integrated Risk - |
| | | Products/ | | | | | Insurance programs or policies containing diverse risks, |
| | | Mitigation | | | | | such as property, casualty, interest rate, and currency |
| | | | | | | | risk. |
| Enterprise | Property | Coverage | PCPM_D6a | D1 | D23a_EN_AL_CVRG | Limitation of Liability | Alternative methods to limit a corporation's liability |
| | Casualty | Products/ | | | | | through contract, a change on government statute, or |
| | | Mitigation | | | | | other non-traditional means. |
| Enterprise | Property | Coverage | PCPM_D6b | D1 | D23b_EN_AL_CVRG | Indemnification Rights | Alternative methods to transfer a corporation's liability |
| | Casualty | Products/ | | | | | through contract, a change on government statute, or |
| | | Mitigation | | | | | other non-traditional means. |
| Enterprise | All | Financial Tools | PCFT_LA | E0 | E01_EN_AL_TOOL | Guaranteed Cost | Guarenteed Cost - |
| | | and Funding | | | | | Guarenteed Cost Coverage Programs - paying |
| | | Methods | | | | | “guaranteed” premiums that do not fluctuate based |
| | | | | | | | on the amount of losses during the policy period (as |
| | | | | | | | opposed to “loss-sensitive” policies such as |
| | | | | | | | retroactively-rated policies). |
| Enterprise | Benefits | Financial Tools | PCFT_LA1 | E2 | E02_EN_BN_TOOL | Insured NonParticipating | Insured Non-Participating - Guarenteed Costs - |
| | | and Funding | | | | | employee benefit programs, such as group health |
| | | Methods | | | | | insurance, in which the employer pays the full cost of |
| | | | | | | | coverage; employer-paid benefits. |
| Enterprise | Benefits | Financial Tools | PCFT_LA2 | E2 | E03_EN_BN_TOOL | Insured Participating | Insured Participating - Shared Costs - employee benefit |
| | | and Funding | | | | | programs, such as group health insurance, in which the |
| | | Methods | | | | | employer and employee split the cost of coverage; |
| | | | | | | | employee-paid benefits. |
| Enterprise | All | Financial Tools | PCFT_LB | E0 | E04_EN_AL_TOOL | Reinsurance Proportional | Risk Transfer: Reinsurance |
| | | and Funding | | | | | Treaty Proportional - |
| | | Methods | | | | | |
| Enterprise | All | Financial Tools | PCFT_LC | E0 | E05_EN_AL_TOOL | Reinsurance Excess | Risk Transfer: Reinsurance |
| | | and Funding | | | | | Treaty Excess of Loss - |
| | | Methods | | | | | |
| Enterprise | All | Financial Tools | PCFT_LC1 | E0 | E05a_EN_AL_TOOL | Treaty Reinsurance-XS & | Risk Transfer: Reinsurance - Property and casualty |
| | | and Funding | | | | Proportional | treaties (contracts providing reinsurance for policies in a |
| | | Methods | | | | | pre-defined group, as opposed to an individual policy) |
| | | | | | | | between insurance companies providing reinsurance on |
| | | | | | | | an excess basis (reinsurer reimburses ceding company |
| | | | | | | | for losses over a certain limit) or proportional basis |
| | | | | | | | (reinsurer reimburses ceding company for a share of |
| | | | | | | | every loss), including rates, availability, terms, products, |
| | | | | | | | and markets. |
| Enterprise | All | Financial Tools | PCFT_LD | E0 | E06_EN_AL_TOOL | Reinsurance Catastrophe | Treaty Excess of Loss - |
| | | and Funding | | | | | |
| | | Methods | | | | | |
| Enterprise | All | Financial Tools | PCFT_LE | E0 | E07_EN_AL_TOOL | Reinsurance Facultative | Property risk excess of loss, casualty occurrence excess |
| | | and Funding | | | | | of loss, aggregate excess of loss, rate levels |
| | | Methods | | | | | (reinsurance and primary), availability, new markets, |
| | | | | | | | [symbol] |
| Enterprise | Property | Financial Tools | PCFT_LF | E1 | E08_EN_PC_TOOL | Reinsurance Autofac | Risk Transfer: Reinsurance |
| | Casualty | and Funding | | | | | Auto-Fac - |
| | | Methods | | | | | Property and Casualty programs, exess and |
| | | | | | | | proportional programs, program terms, rate and |
| | | | | | | | commission levels, availability, new products, new |
| | | | | | | | markets, general trends, (e.g. shift from treaty to non |
| | | | | | | | obilatory autofac, difference in rates, commissions on |
| Enterprise | All | Financial Tools | PCFT_LF1 | E0 | E08a_EN_PC_TOOL | Alternative Risk Transfer | Availability, pricing, terms, products, trends, and |
| | | and Funding | | | | Techniques - General | providers and users of self-insurance, finite insurance |
| | | Methods | | | | | and reinsurance, captive insurance, Protected Cell |
| | | | | | | | Companies, Special Purpose Vehicles, risk |
| | | | | | | | securitization, capital markets risk financing, and other |
| | | | | | | | ART methods. |
| Enterprise | All | Financial Tools | PCFT_LF2 | E0 | E08b_EN_PC_TOOL | Stop Loss | Techniques for capping insureds' losses in excess of a |
| | | and Funding | | | | | deductible or self-insured retention. |
| | | Methods | | | | | |
| Enterprise | All | Financial Tools | PCFT_LF3 | E0 | E08c_EN_PC_TOOL | Fronting | Use or fronting arrangements, whereby an admitted |
| | | and Funding | | | | | insurer writes a policy on behalf of a non-admiited |
| | | Methods | | | | | insurer, with the non-admiited insurer reinsuring the |
| | | | | | | | admitted insurer. |
| Enterprise | All | Financial Tools | PCFT_LG | E0 | E09_EN_AL_TOOL | Securitization | Risk Transfer: Capital Markets |
| | | and Funding | | | | | Securitization - |
| | | Methods | | | | | Insuring risks through capital market mechanisms |
| | | | | | | | instead of traditional insurance/reinsurance - |
| | | | | | | | Availability, new products, coverage issues, costs vs |
| | | | | | | | traditional coverage, requlatory changes, new |
| | | | | | | | markets. |
| Enterprise | All | Financial Tools | PCFT_LH | E0 | E10_EN_AL_TOOL | Futures Derivatives | Risk Transfer: Capital Markets |
| | | and Funding | | | | | Futures and other Derivatives - |
| | | Methods | | | | | Determining loss based on performance of an index |
| | | | | | | | rather than actual loss to individual insured - |
| | | | | | | | Availability, new products, costs, new markets, |
| | | | | | | | requlatory changes, market acceptance. |
| Enterprise | All | Financial Tools | PCFT_LI | E0 | E11_EN_AL_TOOL | Captive Insurer | Risk Financing: Captive Insurer - |
| | | and Funding | | | | | Tax issues, regulatory issues, cost comparison to |
| | | Methods | | | | | traditional risk transfer, availability of reinsurance, |
| | | | | | | | primary rate levels, coverage issue, comparisons |
| | | | | | | | among various captive domiciles. |
| Enterprise | All | Financial Tools | PCFT_LJ | E0 | E12_EN_AL_TOOL | Finite Risk Insurance | Risk Financing: Financial (Re)Insurance - |
| | | and Funding | | | | | Regulatory issues, tax issues, availability, costs. |
| | | Methods | | | | | |
| Enterprise | All | Financial Tools | PCFT_LK | E0 | E13_EN_AL_TOOL | Retrospective Covers | Retrospective Covers - |
| | | and Funding | | | | | Retrospectivly Rated Participating Program - |
| | | Methods | | | | | Premiums based on losses during policy period (as |
| | | | | | | | opposed to guaranteed cost policies). |
| Enterprise | All | Financial Tools | PCFT_LL | E0 | E14_EN_AL_TOOL | Liquidity Facility | Risk Financing: Liquidity Facility - A non-insurance risk |
| | | and Funding | | | | | financing vehicle for providing liquidity in the event of a |
| | | Methods | | | | | catastrophe, often a “put” for a special class of preferred |
| | | | | | | | stock. |
| Operational | Benefits | Financial Tools | | E2 | E15_OP_BN_TOOL | Self Insured Reinsurance | Self Insured - with Reinsurance - employee benefit |
| | | and Funding | | | | | programs that are self-funded or self-insured by the |
| | | Methods | | | | | employer, but with reinsurance (stop-loss) to cover |
| | | | | | | | individual or total claims over a specified amount. |
| Operational | Benefits | Financial Tools | | E2 | E16_OP_BN_TOOL | Self Insured ASO | Self Insured ASO (administrated services organization) |
| | | and Funding | | | | | employee benefit programs that are self-funded or |
| | | Methods | | | | | self-insured by the employer, with a third-party |
| | | | | | | | administrator (TPA) providing claims management and |
| | | | | | | | other services for the plans. |
| Enterprise | All | Financial Tools | PCFT_LM | E0 | E17_EN_AL_TOOL | Self Insurance | Risk Financing: Self-Insurance - |
| | | and Funding | | | | | Cost vs risk transfer, tax issues, regulatory issues, |
| | | Methods | | | | | general trends (e.g. higher retentions, deductables) |
| | | | | | | | lack of availability of traditional coverage. |
| Operational | Benefits | Financial Tools | | E2 | E18_OP_BN_TOOL | Defined Contributions | Defined Contributions - employee benefit plans, such as |
| | | and Funding | | | | | a 401(k) retirement savings plan, in which the amount |
| | | Methods | | | | | contributed or to be contributed is presently known, |
| | | | | | | | while the amount of the benefit ultimately to be collected |
| | | | | | | | is not known (opposite of defined benefit plan). |
| Enterprise | All | Financial Tools | PCFT_LN | E0 | E19_EN_AL_TOOL | Other Financial Tools | Risk Financing: Other - ??? |
| | | and Funding | | | | | Self insurance, risk avoidance, uninsured exposures, |
| | | Methods | | | | | lack of availability of coverage for specific exposures |
| Hazard | Property | Legislation/ | PCLR_HA | F1 | F01_HZ_PC_REGL | OSHA | Federal Compliance Issues: |
| | Casualty | Regulation | | | | | OSHA |
| | | | | | | | Federal legislation, and the activities of federal |
| | | | | | | | regulatory agencies, which create compliance (and |
| | | | | | | | potential liability) issues for corporations. Also: State |
| | | | | | | | enabling legislation/rulemaking for the states with |
| | | | | | | | OSHA-type plans. |
| Hazard | Property | Legislation/ | PCLR_HB | F1 | F02_HZ_PC_REGL | EPA | Federal Compliance Issues: |
| | Casualty | Regulation | | | | | EPA |
| | | | | | | | Federal legislation, and the activities of federal |
| | | | | | | | regulatory agencies, which create compliance (and |
| | | | | | | | potential liability) issues for corporations. Also: State |
| | | | | | | | enabling legislation/rulemaking for the states with |
| | | | | | | | environmental regulatory agencies. |
| Hazard | Property | Legislation/ | PCLR_HI | F1 | F03_HZ_PC_REGL | SEC Legal Liability | Liability for money damages, including fines and |
| | Casualty | Regulation | | | | | penalties, or other specific financial impacts, arising |
| | | | | | | | out of violation of the Securities and Exchange |
| | | | | | | | Commission disclosure requirements or other federal, |
| | | | | | | | state, and local securities laws, including derivative class |
| | | | | | | | actions, and suits against directors and officers or the |
| | | | | | | | corporation brought by shareholders, the SEC, or others. |
| Financial | All | Legislation/ | | F0 | F04_FN_AL_REGL | SEC Financial | SEC Financial - Potential or actual fines and penalities, |
| | | Regulation | | | | | or other specifically financial impacts other than tort |
| | | | | | | | damages, associated with disclosure requirements of |
| | | | | | | | the Securities and Exchange Commission or the various |
| | | | | | | | states. |
| Operational | All | Legislation/ | | F2 | F05_OP_BN_REGL | SEC Operational | SEC Operational - The Impact, potential or actual, on a |
| | | Regulation | | | | | company's business performance (reputation, client or |
| | | | | | | | business partner relationships, management disruptions, |
| | | | | | | | etc.) arising from compliance or non-compliance with |
| | | | | | | | SEC or state securities regulation. |
| Hazard | Property | Legislation/ | PCLR_HC | F1 | F06_HZ_PC_REGL | FedReg Other Hazard | Federal Regulation Other Hazard - Potential or actual |
| | Casualty | Regulation | | | | | tort libility arising from federal compliance requirements |
| | | | | | | | of other than OSHA, EPA, or SEC. Often will involve |
| | | | | | | | damages (BI, PD, or financial) resulting from failure to |
| | | | | | | | disclose a dangerous situation as required by law, or |
| | | | | | | | damages resulting from a dangerous situation that would |
| | | | | | | | not otherwise have existed had regulations been |
| | | | | | | | complied with. |
| Financial | All | Legislation/ | | F0 | F07_FN_AL_REGL | FedReg Other Financial | Federal Compliance Issues: |
| | | Regulation | | | | | Other |
| | | | | | | | Federal legislation, and the activities of federal |
| | | | | | | | regulatory agencies, which create compliance (and |
| | | | | | | | potential liability) issues for corporations. Examples |
| | | | | | | | include the Americans With Disabilities Act. |
| Operational | Benefits | Legislation/ | | F2 | F08_OP_BN_REGL | FedReg Other Ops | Federal Compliance Issues: |
| | | Regulation | | | | | Other |
| | | | | | | | Federal legislation, and the activities of federal |
| | | | | | | | regulatory agencies, which create compliance (and |
| | | | | | | | potential liability) issues for corporations. Examples |
| | | | | | | | include the Americans With Disabilities Act. |
| Hazard | Property | Legislation/ | PCLR_HD | F1 | F09_HZ_PC_REGL | Liability Issues Hazard | Federal Liability Issues, such as Federal Tort Claims |
| | Casualty | Regulation | | | | | Act, Federal Employer Liability Act, Longshoremen's and |
| | | | | | | | Harbor Workers' Act |
| Financial | All | Legislation/ | | F0 | F10_FN_AL_REGL | Liability Issues Financial | Federal Liability Issues, such as Federal Tort Claims |
| | | Regulation | | | | | Act, Federal Employer Liability Act, Longshoremen's and |
| | | | | | | | Harbor Workers' Act. |
| Operational | Benefits | Legislation/ | | F2 | F11_OP_BN_REGL | Liability Issues Ops | Federal Liability Issues, such as Federal Tort Claims |
| | | Regulation | | | | | Act, Federal Employer Liability Act, Longshoremen's and |
| | | | | | | | Harbor Workers' Act. |
| Hazard | Property | Legislation/ | PCLR_HE | F1 | F12_HZ_PC_REGL | NAIC Hazard | State Insurance (Including NAIC): |
| | Casualty | Regulation | | | | | NAIC/Model Regulations |
| | | | | | | | Concerning state insurance legislation and |
| | | | | | | | regulations, the enforcement activities of state |
| | | | | | | | departments of insurance, and the activities of the |
| | | | | | | | National Association of Insurance Commissioners |
| Operational | Benefits | Legislation/ | | F2 | F13_OP_BN_REGL | NAIC Ops | State Insurance (Including NAIC): |
| | | Regulation | | | | | NAIC/Model Regulations |
| | | | | | | | Concerning state insurance legislation and |
| | | | | | | | regulations, the enforcement activities of state |
| | | | | | | | departments of insurance, and the activities of the |
| | | | | | | | National Association of Insurance Commissioners |
| | | | | | | | (NAIC). |
| Hazard | Property | Legislation/ | PCLR_HF | F1 | F14_HZ_PC_REGL | State Regulations Hazard | State Insurance (including NAIC): |
| | Casualty | Regulation | | | | | Insurance Regulation: state versus federal regulation, |
| | | | | | | | deregulation of commercial lines. |
| Operational | Benefits | Legislation/ | | F2 | F15_OP_BN_REGL | State Regulations Ops | State Insurance (Including NAIC): |
| | | Regulation | | | | | Insurance Regulation: state versus federal regulation, |
| | | | | | | | deregulation of commercial lines. |
| Hazard | Property | Legislation/ | PCLR_HF1 | | F15a_OP_BN_REGL | Federal Insurance | The regulation of P&C insurance companies and |
| | Casualty | Regulation | | | | Regulation - P&C | products (incl. work comp) at the federal level, including |
| | | | | | | | the debate over federal vs. state regulation. |
| Hazard | Benefits | Legislation/Regulation | PCLR_HF2 | | F15b_OP_BN_REGL | Federal Insurance | The regulation of L&H insurance companies and |
| | | | | | | Regulation - Benefits | products (incl. work comp) at the federal level, including |
| | | | | | | | the debate over federal vs. state regulation. |
| Hazard | Property | Legislation/ | PCLR_HG | F1 | F16_HZ_PC_REGL | Captive Legislation | Legislation concerning captive insurance companies and |
| | Casualty | Regulation | | | | | the regulation of captives in U.S. states and “offshore” |
| | | | | | | | domiciles. |
| Hazard | Property | Legislation/ | PCLR_HH | F1 | F17_HZ_PC_REGL | NonInsurance Statutes | Regulation of risk-related entities under statutes not |
| | Casualty | Regulation | | | | | under the purview of state insurance departments or |
| | | | | | | | federal agencies (e.g., regulation of municipal risk |
| | | | | | | | pools). |
| Operational | Benefits | Legislation/ | | F2 | F18_OP_BN_REGL | COBRA | Health Care Benefit Continuation Laws - COBRA - |
| | | Regulations | | | | | Federal and State - statutes, such as federal |
| | | | | | | | Consolidated Omnibus Budget Reconciliation Act and its |
| | | | | | | | state law equivalents, granting employees and |
| | | | | | | | dependents the right to continue group health insurance |
| | | | | | | | coverage for a certain period of time after termination of |
| | | | | | | | employment, upn payment of COBRA premiums by |
| | | | | | | | employee; health insurance continuation law. |
| Hazard | Property | Legislation/ | | F1 | F19_HZ_PC_REGL | ERISA Hazard | Fiduciary Liability Exposures - ERISA - liability (under |
| | Casualty | Regulations | | | | | Employee Retirement Income Security Act) of trustees |
| | | | | | | | of employee benefit plans, such as a pension plan, to |
| | | | | | | | employees who suffer financial/investment losses due |
| | | | | | | | to breach of fiduciary duties of care by the trustees; |
| | | | | | | | Pension Trust Liability. |
| Operational | Benefits | Legislation/ | | F2 | F20_OP_BN_REGL | ERISA Ops | Fiduciary Liability Exposures - ERISA - duty of benefit |
| | | Regulations | | | | | plan trustees to comply with the requirements of the |
| | | | | | | | Employee Retirement Income Security Act regulating the |
| | | | | | | | administration, funding, and management of employee |
| | | | | | | | benefit plans; Pension Trust Liability. |
| Operational | Benefits | Legislation/ | | F2 | F21_OP_BN_REGL | FMLA | Family Leave Laws - FMLA - Family Medical Leave Act - |
| | | Regulations | | | | | federal statute, and its state law equivalents, granting |
| | | | | | | | employees right to unpaid time off for childbirth, |
| | | | | | | | adoption, or serious medical condition of employees or |
| | | | | | | | certain close family members; a/k/a parental leave, child |
| | | | | | | | leave, adoption leave, leave of absence. |
| Operational | Benefits | Legislation/ | | F2 | F22_OP_BN_REGL | HIPAA | Health Insurance Portability and Accountability Act - |
| | | Regulations | | | | | HIPAA - federal law giving employees right to medical |
| | | | | | | | records privacy and continued health coverage after |
| | | | | | | | leaving job; medical records privacy legislation. |
| Operational | Benefits | Legislation/ | | F2 | F23_OP_BN_REGL | DoL Regulations | Department of Labor (DoL) Administrative Regulations - |
| | | Regulations | | | | | regs promulgated to expand upon or explain federal |
| | | | | | | | labor laws, such as Fair Labor Standards Act |
| | | | | | | | (Wage/Hour law), Employment Standards law, and |
| | | | | | | | Equal Employment laws. |
| Operational | Benefits | Legislation/ | | F2 | F24_OP_BN_REGL | Mandated Benefit | State Mandated Benefit Levels - federal or state laws |
| | | Regulations | | | | | granting leave rights, medical expenses, or wage |
| | | | | | | | reimbursement to employees and with certain medical |
| | | | | | | | conditions or personal problems; e.g., Disability Benefits |
| | | | | | | | Law (DBL), Social Security. |
| Hazard | Property | Tort Law/ | PCTL_IA | G1 | G01_HZ_PC_LTGN | Coverage Litigation | Insurance Coverage Litigation |
| | Casualty | Litigation | | | | Hazard | Litigation (and arbitration) concerning coverage under |
| | | | | | | | insurance policies. (Examples: 1. Is coverage for |
| | | | | | | | pollution triggered when polluting event first took |
| | | | | | | | place, or when the pollution was discovered. 2. Is |
| | | | | | | | electronic data “property” under a property insurance |
| Financial | All | Tort Law/ | | G0 | G02_FN_AL_LTGN | Coverage Litigation | Insurance Coverage Litigation |
| | | Litigation | | | | Financial | Litigation (and arbitration) concerning coverage under |
| | | | | | | | insurance policies. (Examples: 1. Is coverage for |
| | | | | | | | pollution triggered when polluting event first took |
| | | | | | | | place, or when the pollution was discovered. 2. Is |
| | | | | | | | electronic data “property” under a property insurance |
| Operational | Benefits | Tort Law/ | | G2 | G03_OP_BN_LTGN | Coverage Litigation Ops | Insurance Coverage Litigation |
| | | Litigation | | | | | Coverage Litigation - legal actions involving |
| | | | | | | | contractual provisions of insurance policies and other |
| | | | | | | | insurance-related documents. |
| Hazard | All | Tort Law/ | PCTL_IB | G0 | G04_HZ_AL_LTGN | Major Events Litigation | Major Industry Events |
| | | Litigation | | | | | Any natural occurrence or potential legal liability in |
| | | | | | | | excess of $500 million, such as tobacco, Y2K, |
| | | | | | | | environmental, asbestos, and pharmaceutical products |
| | | | | | | | litigation. Alternative definition: Litigation, often (but not |
| | | | | | | | necessarily) class action suits, with potentially |
| | | | | | | | devistating impact to the insurance industry. Recent |
| | | | | | | | examples include tobacco, asbestos, and Y2K. |
| Hazard | Property | Tort Law/ | PCTL_IC | G1 | G05_HZ_PC_LTGN | Precedent Litigation | Precedent Setting Cases |
| | Casualty | Litigation | | | | Hazard | Any litigation that results in a unique interpretation of |
| | | | | | | | insurance policy terms, a/k/a “landmark cases.” |
| Financial | All | Tort Law/ | | G0 | G06_FN_AL_LTGN | Precedent Litigation | Precedent Setting Cases |
| | | Litigation | | | | Financial | Any litigation that results in the creation of new financial |
| | | | | | | | exposures to companies. |
| Operational | Benefits | Tort Law/ | | G2 | G07_OP_BN_LTGN | Precedent Litigation Ops | Precedent Setting Cases |
| | | Litigation | | | | | Any litigation that results in a unique interpretation of |
| | | | | | | | L&H insurance policy terms or employee benefits. |
| Hazard | Property | Loss Control | PCLC_JA | H1 | H01_HZ_PC_LOSS | Catastrophe Modeling | Risk identification/Assessment/Quantification |
| | Casualty | | | | | | Catastrophe Modeling - Includes efforts to project |
| | | | | | | | losses to property and people based on historical and |
| | | | | | | | scientific data as related to potential exposures. |
| Hazard | Property | Loss Control | PCLC_JB | H1 | H02_HZ_PC_LOSS | Other Loss Control | Risk identification/Assessment/Quantification |
| | Casualty | | | | | | Other |
| Hazard | Property | Loss Control | PCLC_JC | H1 | H03_HZ_PC_LOSS | Safety Standards | Safety Engineering/Industrial Hygiene: |
| | Casualty | | | | | | Protection Standards |
| | | | | | | | [symbol] |
| Hazard | Property | Loss Control | PCLC_JD | H1 | H04_HZ_PC_LOSS | Safety Training | Safety Engineering/Industrial Hygiene: |
| | Casualty | | | | | | Safety Training - Methods to motivate, educate, and |
| | | | | | | | assist management and employees in identifying job |
| | | | | | | | hazards and safely performing required activities, and |
| | | | | | | | establishing and maintaining the necessary engineering |
| | | | | | | | and human element standards to prevent loss of assets. |
| Hazard | Property | Loss Control | PCLC_JE | H1 | H05_HZ_PC_LOSS | Safety Security | Safety Engineering/Industrial Hygiene: |
| | Casualty | | | | | | Security - The protection of employees and property |
| | | | | | | | from injury or damage resulting from criminal activity. |
| Hazard | Property | Loss Control | PCLC_JF | H1 | H06_HZ_PC_LOSS | Safety Disaster | Safety Engineering/Industrial Hygiene: |
| | Casualty | | | | | | Disaster Planning - An event resulting in loss of life or |
| | | | | | | | extensive property damage. |
| Hazard | Property | Loss Control | PCLC_JG | H1 | H07_HZ_PC_LOSS | Safety Compliance | Safety Engineering/Industrial Hygiene: |
| | Casualty | | | | | | Compliance - Compliance with all applicable legislation |
| | | | | | | | and regulation in the employee safety and asset |
| | | | | | | | protection areas. |
| Hazard | Property | Loss Control | PCLC_JH | H1 | H08_HZ_PC_LOSS | Safety Other | Safety Engineering/Industrial Hygiene: |
| | Casualty | | | | | | Other - Any other issues relating to safety that have not |
| | | | | | | | been otherwise defined. |
| Hazard | Property | Loss Control | | H1 | H09_HZ_PC_LOSS | Ergonomic | Ergonomic/OSHA - federal regulation mandating |
| | Casualty | | | | | | ergonomic measures to reduce employee |
| | | | | | | | musculoskeletal disorders (e.g., carpal tunnel |
| | | | | | | | syndrome), requires payment of certain medical benefits |
| | | | | | | | (supplementing work comp) for ergonomic injuries. |
| Hazard | Property | Loss Control | | H1 | H10_HZ_PC_LOSS | Risk Management | Risk Management Practices - risk treatment techniques |
| | Casualty | | | | | Practices | employing loss control and engineering methods to |
| | | | | | | | reduce or eliminate hazards. |
| Hazard | Property | Back to Work | | H1 | H11_HZ_PC_BACK | Back Work Hazard | Back to Work - process of getting employees who Suffer |
| | Casualty | | | | | | job-related injuries or illnesses back to work so they will |
| | | | | | | | be productive and not collect work comp benefits; |
| | | | | | | | integrated disability management; work hardening; light |
| | | | | | | | duty; work hardening. |
| Operational | Benefits | Back to Work | | H2 | H12_OP_BN_BACK | Back Work Benefits | Back to Work - process of getting employees who suffer |
| | | | | | | | non-job-related injuries or illnesses back to work so they |
| | | | | | | | will be productive and not collect group health benefits; |
| | | | | | | | integrated disability management; work hardening; light |
| | | | | | | | duly; work hardening. |
| | | | | | | Contingency Planning | Contingency Planning |
| Operational | Benefits | Health - Type of | | I2 | I01_OP_BN_HLTH | Hospital Facility | Hospital or Other Facility; nursing home; ambulatory |
| | | Service | | | | | care facilty; hospice; clinic; emergency treatment |
| | | | | | | | center. |
| Operational | Benefits | Health - Type of | | I2 | I02_OP_BN_HLTH | Surgical | Surgical; surgical center; surgi-center. |
| | | Service | | | | | |
| Operational | Benefits | Health - Type of | | I2 | I03_OP_BN_HLTH | Physician | Physician; doctor; intern; resident; specialist; medical |
| | | Service | | | | | doctor; osteopath; surgeon. |
| Operational | Benefits | Health - Type of | | I2 | I04_OP_BN_HLTH | XRay Lab | X-Ray/Lab; medical resonance imaging (MRI); testing |
| | | Service | | | | | lab; radiology. |
| Operational | Benefits | Health - Type of | | I2 | I05_OP_BN_HLTH | Prescription | Prescription; prescription drugs; Rx; |
| | | Service | | | | | generic/formulary/brand name drugs. |
| Operational | Benefits | Health - Type of | | I2 | I06_OP_BN_HLTH | Dental | Dental; oral surgery; maxillofacial surgery; orthodonture. |
| | | Service | | | | | |
| Operational | Benefits | Health - Type of | | I2 | I07_OP_BN_HLTH | Vision | Vision; ocular care; eyeglasses; opthomology; |
| | | Service | | | | | optometry. |
| Operational | Benefits | Health - Type of | | I2 | I08_OP_BN_HLTH | Alternative Medicine | Alternative Medicine; holistic medicine; acupuncture; |
| | | Service | | | | | herbal medicine; natural medicine; chiropractic; |
| | | | | | | | hypnosis. |
| Operational | Benefits | Health - | | J2 | J01_OP_BN_DIAG | Nervous System | Diseases & Disorders of the Nervous System; central |
| | | Diagnostic | | | | | nervous system; autonomic nervous system; peripheral |
| | | Grouping | | | | | nervous system. |
| Operational | Benefits | Health - | | J2 | J02_OP_BN_DIAG | Eye | Diseases & Disorders of the Eye; ocular/optometric |
| | | Diagnostic | | | | | ophthalmic disorders; |
| | | Grouping | | | | | |
| Operational | Benefits | Health - | | J2 | J03_OP_BN_DIAG | Ear Nose Mouth | Diseases & Disorders of the Ear, Nose, Mouth, and |
| | | Diagnostic | | | | | Throat |
| | | Grouping | | | | | |
| Operational | Benefits | Health - | | J2 | J04_OP_BN_DIAG | Respitory System | Diseases & Disorders of the Respitory System; |
| | | Diagnostic | | | | | pulmonological disorders. |
| | | Grouping | | | | | |
| Operational | Benefits | Health - | | J2 | J05_OP_BN_DIAG | Circulatory System | Diseases & Disorders of the Circulatory System |
| | | Diagnostic | | | | | |
| | | Grouping | | | | | |
| Operational | Benefits | Health - | | J2 | J06_OP_BN_DIAG | Digestive System | Diseases & Disorders of the Digestive System; |
| | | Diagnostic | | | | | gastroenterological disorders. |
| | | Grouping | | | | | |
| Operational | Benefits | Health - | | J2 | J07_OP_BN_DIAG | Hebatobiliary Pancreas | Diseases & Disorders of the Hebatobiliary system and |
| | | Diagnostic | | | | | Pancreas; blood-related disorders. |
| | | Grouping | | | | | |
| Operational | Benefits | Health - | | J2 | J08_OP_BN_DIAG | Musculoskeletal | Diseases & Disorders of the Musculoskeletal System |
| | | Diagnostic | | | | Connective Tissue | and Connective Tissue; repetitive motion disorder; |
| | | Grouping | | | | | cumulative trauma disorder. |
| Operational | Benefits | Health - | | J2 | J09_OP_BN_DIAG | Skin Breast | Diseases & Disorders of the Skin, Subcutaneous Tissue |
| | | Diagnostic | | | | | and Breast; dermatological disorders. |
| | | Grouping | | | | | |
| Operational | Benefits | Health - | | J2 | J10_OP_BN_DIAG | Endocrine Nutritional | Endocrine, Nutritional and Metabolic Diseases and |
| | | Diagnostic | | | | Metabolic | Disorders; endocrinological disroders. |
| | | Grouping | | | | | |
| Operational | Benefits | Health - | | J2 | J11_OP_BN_DIAG | Kidney Urinary Tract | Diseases & Disorders of the Kidney and Urinary Tract; |
| | | Diagnostic | | | | | urological disorders. |
| | | Grouping | | | | | |
| Operational | Benefits | Health - | | J2 | J12_OP_BN_DIAG | Male Reproductive | Diseases & Disorders of the Male Reproductive System. |
| | | Diagnostic | | | | System | |
| | | Grouping | | | | | |
| Operational | Benefits | Health - | | J2 | J13_OP_BN_DIAG | Female Reproductive | Diseases & Disorders of the Female Reproductive |
| | | Diagnostic | | | | System | System; gynecological disorders. |
| | | Grouping | | | | | |
| Operational | Benefits | Health - | | J2 | J14_OP_BN_DIAG | Preganacy Childbirth | Preganacy, Childbirth, and the Puerperium; |
| | | Diagnostic | | | | Puerperium | prgenancy-related disorders. |
| | | Grouping | | | | | |
| Operational | Benefits | Health - | | J2 | J15_OP_BN_DIAG | Newborns | Newborns and Other Neonates with Conditions |
| | | Diagnostic | | | | | Originating in the Perinatal Period; neonatal disorders; |
| | | Grouping | | | | | birth defects. |
| Operational | Benefits | Health - | | J2 | J16_OP_BN_DIAG | Blood Immunological | Diseases & Disorders of the Blood and Blood Forming |
| | | Diagnostic | | | | Disorders | Organs and Immunological Disorders; hematological |
| | | Grouping | | | | | disorders. |
| Operational | Benefits | Health - | | J2 | J17_OP_BN_DIAG | Myeloproliferative | Myeloproliferative Diseases & Disorders, & Poorly |
| | | Diagnostic | | | | Neoplasms | Differentiated Neoplasms |
| | | Grouping | | | | | |
| Operational | Benefits | Health - | | J2 | J18_OP_BN_DIAG | Infectious Parasitic | Infectious and Parasitic Diseases; infections; contagious |
| | | Diagnostic | | | | | diseases. |
| | | Grouping | | | | | |
| Operational | Benefits | Health - | | J2 | J19_OP_BN_DIAG | Mental Diseases | Mental Diseases and Disorders; emotional disorders; |
| | | Diagnostic | | | | | behavioral disorders. |
| | | Grouping | | | | | |
| Operational | Benefits | Health - | | J2 | J20_OP_BN_DIAG | Alcohol Drug | Alcohol/Drug Use and Alcohol/Drug-Induced Organic |
| | | Diagnostic | | | | | Mental Disorders; addiction; intoxication. |
| | | Grouping | | | | | |
| Operational | Benefits | Health - | | J2 | J21_OP_BN_DIAG | Injury Poisoning | Injury, Poisoning, and Toxic Effect of Drugs; side effects. |
| | | Diagnostic | | | | | |
| | | Grouping | | | | | |
| Operational | Benefits | Health - | | J2 | J22_OP_BN_DIAG | Burns | Burns - third degree/second degree/first degree burns. |
| | | Diagnostic | | | | | |
| | | Grouping | | | | | |
| Operational | Benefits | Health - | | J2 | J23_OP_BN_DIAG | Health Status | Factors Influencing Health Status and Other Contacts |
| | | Diagnostic | | | | | with Health Services |
| | | Grouping | | | | | |
| Operational | Benefits | Health - | | J2 | J24_OP_BN_DIAG | Multiple Significant | Multiple Significant Trauma |
| | | Diagnostic | | | | Trauma | |
| | | Grouping | | | | | |
| Operational | Benefits | Health - | | J2 | J25_OP_BN_DIAG | Immunodeficiency Virus | Human Immunodeficiency Virus Infections - HIV; |
| | | Diagnostic | | | | Infections | Acquired Immune Deficiency Syndrome (AIDS). |
| | | Grouping | | | | | |
| Operational | Benefits | Health - | | J2 | J26_OP_BN_DIAG | DRGs Associated MDCs | Other DRGs Associated with All MDCs; Diagnostic |
| | | Diagnostic | | | | | Related Groups/Medically Diagnosed Conditions. |
| | | Grouping | | | | | |
| Operational | Benefits | Welfare - Type of | | K2 | K01_OP_BN_WELF | Short Term Disability | Short Term Disability - disability or up to six months |
| | | Service | | | | | stemming from non-work-related cause during which |
| | | | | | | | wage replacement benefits are collected; lost-time |
| | | | | | | | disability; lost-time injury/illness. |
| Operational | Benefits | Welfare - Type of | | K2 | K02_OP_BN_WELF | Long Term Disability | Long Term Disability - disability of more than six months |
| | | Service | | | | | stemming from non-work-related cause during which |
| | | | | | | | wage replacement benefits are collected; lost-time |
| | | | | | | | disability; lost-time injury/illness. |
| Operational | Benefits | Welfare - Type of | | K2 | K03_OP_BN_WELF | Transition Benefits | Transition Benefits/Back to Work - partial benefits for |
| | | Service | | | | | period of time bridging light-duty work and return to |
| | | | | | | | pre-injury production level. |
| Operational | Benefits | Welfare - Type of | | K2 | K04_OP_BN_WELF | Work Life Programs | Work Life Programs - making work more productive and |
| | | Service | | | | | satisfying by helping employees live better lives; |
| | | | | | | | Childcare/Daycare/Eldercare programs; Employee |
| | | | | | | | Assistance Programs (EAPs); rehabilitation programs; |
| | | | | | | | flexible hours (flex time); employee wellness programs. |
| Operational | Benefits | Welfare - Income | | L2 | L01_OP_BN_PROT | Income Protection | Income Protection - Loss of Income - Loss of Time - |
| | | Protection | | | | | benefits that replace income lost when employee cannot |
| | | | | | | | work due to non-job-related injury or illness; wage |
| | | | | | | | replacement benefits; welfare benefits; indemnity |
| | | | | | | | benefits; salary continuation plan. |
| Operational | Benefits | Retirement | | L2 | L02_OP_BN_RETR | Retiree Benefits | Retiree Benefits - group health and other employee |
| | | | | | | | benefits used or collected by retirees; Medicare HMO vs. |
| | | | | | | | staying in employer plan as retireee (pros and cons, tax |
| | | | | | | | implications, age discrimination implications). |
| Operational | Benefits | Cost Containment | | M2 | M01_OP_BN_CNTN | Capitation | Capitation - basing medical care provider compensation |
| | | | | | | | on number of patients under provider's care, instead of |
| | | | | | | | on amount of services rendered; per capita |
| | | | | | | | reimbursement. |
| Operational | Benefits | Cost Containment | | M2 | M02_OP_BN_CNTN | Utilization Management | Utilization Management Containment - controlling |
| | | | | | | | healthcare costs by reviewing care provided or to be |
| | | | | | | | provided; utilization review; prior approval plans. |
| Operational | Benefits | Cost Containment | | M2 | M03_OP_BN_CNTN | Drug Formularies | Drug formularies - list of approved drugs in Managed |
| | | | | | | | Care Organization plan - one of three Rx tiers: generic |
| | | | | | | | (least expensive and lowest co-pay); formulary |
| | | | | | | | (approved by MCO, mid-level co-pay); and |
| | | | | | | | non-approved brand name (highest co-pay). |
| Operational | Benefits | Cost Containment | | M2 | M04_OP_BN_CNTN | Hospital Stop Loss | Hospital Stop Loss - the amount below which a |
| | | | | | | | self-insured employer agrees to take as risk, amounts |
| | | | | | | | above the stop loss are reinsured with a stop loss |
| | | | | | | | insurer. |
| Operational | Benefits | Cost Containment | | M2 | M05_OP_BN_CNTN | Hospital Reimbursement | Hospital Reimbursement - Per Diem - DRG - daily |
| | | | | | | | hospital benefit calculated based on amount in |
| | | | | | | | Diagnostic Related Group schedule for type of |
| | | | | | | | injury/illness listed on schedule; fee schedule; diagnostic |
| | | | | | | | grouping. |
| Operational | Benefits | Cost Containment | | M2 | M06_OP_BN_CNTN | Fee Schedules | Negotiated Fee Schedules - reduced fees negotiated |
| | | | | | | | with providers by Managed Care Organization; schedule |
| | | | | | | | of reimbursement. |
| Operational | Benefits | Cost Containment | | M2 | M07_OP_BN_CNTN | Mail Order Pharmacy | Mail Order Pharmacy - prescriptions filled through mail |
| | | | | | | | or Internet, allowed and/or required by some plans to |
| | | | | | | | lower prescription drug costs. |
| Operational | Benefits | Cost Containment | | M2 | M08_OP_BN_CNTN | Managed Care Products | Managed Care Products - employee benefit plants |
| | | | | | | | available through Managed Care Organizations; |
| | | | | | | | Point-of-Service (POS) product; Preferred Provider |
| | | | | | | | Organization (PPO) product; Health Maintenance |
| | | | | | | | Organization (HMO) product. |
| Operational | Benefits | Cost Containment | | M2 | M09_OP_BN_CNTN | Primary Care Physicians | Primary Care Physicians - “gatekeeper” - doctor |
| | | | | | | | managed care patient sees for most of care, can refer |
| | | | | | | | patients to specialists. |
| Hazard | Property | Trends | PCTR_KA | N0 | N01_IN_AL_TRND | Result Trends | Industry Results - loss ratios, combined ratios, profits |
| | Casualty | | | | | | and losses, growth/decline in policyholders' surplus, |
| | | | | | | | growth/decline in premiums written. |
| Hazard | Property | Trends | PCTR_KB | N0 | N02_IN_AL_TRND | Capacity Trends | Industry Capacity/Coverage Availability/Terms/Rate |
| | Casualty | | | | | | Levels |
| | | | | | | | Stories about the capacity (capital) of the industry |
| | | | | | | | increasing or decreasing, rate levels going up or |
| | | | | | | | down, coverage for certain classes becoming easier |
| | | | | | | | or harder to find. |
| Hazard | Property | Trends | PCTR_KC | N0 | N03_IN_AL_TRND | Mergers Trends | Industry Mergers and Acquisitions/Consolidation/ |
| | Casualty | | | | | | Convergence/Disintermediation |
| | | | | | | | Including Underwriter and Brokers |
| Hazard | Property | Trends | PCTR_KD | N0 | N04_IN_AL_TRND | Globalization Trends | Globalization Trends |
| | Casualty | | | | | | Emergence of new risks through growth of multi-national |
| | | | | | | | insureds and interlocking risk shifting and servicing |
| | | | | | | | agreements (reinsurance and other) among underwiting |
| | | | | | | | and servicing organizations. |
| Hazard | Property | Trends | PCTR_KE | N0 | N05_IN_AL_TRND | IT Trends | Industry internet/Information Technology, selling |
| | Casualty | | | | | | property and casualty insurance or insurance services |
| | | | | | | | over the Internet. |
| Hazard | Property | Trends | PCTR_KF | N0 | N06_IN_AL_TRND | Exposure Trends | Trends in Exposures/Risks/Perils |
| | Casualty | | | | | | Developments regarding risks or exposures which signal |
| | | | | | | | a change from past or current levels of potential loss or |
| | | | | | | | cost. |
| Hazard | Property | Trends | PCTR_KG | N0 | N07_IN_AL_TRND | Product Trends | Trends in Products |
| | Casualty | | | | | | Changes in existing insurance or other risk transfer |
| | | | | | | | products in response to economic or social |
| | | | | | | | developments. |
| Operational | Property | Trends | PCTR_KG1 | N0 | N07a_IN_AL_TRND | Insurer Claims | Articles about particular insuance companies' positive or |
| | Casualty | | | | | Handling - Ratings and | negative handling or settlement of clients' claims. |
| | | | | | | Observations | |
| Operational | Property | Trends | PCTR_KG2 | N0 | N07b_IN_AL_TRND | Insurer Financial Security | Articles about particular insurance companies' positive |
| | Casualty | | | | | | or negative financial condition. |
| Operational | Property | Trends | PCTR_KG3 | N0 | N07c_IN_AL_TRND | Underwriting Audits | Audit or an insurance company's underwriting operations |
| | Casualty | | | | | | by insurer management or state government requlators, |
| | | | | | | | or audits of Managing General Agents and brokers by |
| | | | | | | | the insurers they represent. |
| Client Issues | Property | Trends | PCTR_KG4 | N0 | N07d_IN_AL_TRND | Program Structures | Particular methods of organizing individual insurance |
| | Casualty | | | | | | programs, I.e., a collection of insurance policies |
| | | | | | | | assembled together as a single insurance placement for |
| | | | | | | | a specific client. |
| Client Issues | Property | Trends | PCTR_KG5 | N0 | N07e_IN_AL_TRND | Cost of Risk | Amounts and costs of risk insured and self-insured by |
| | Casualty | | | | | | corporations, including major surveys such as the RIMS |
| | | | | | | | Cost of Risk Study. |
| Client Issues | Property | Trends | PCTR_KG5 | N0 | N07f_IN_AL_TRND | Risk Managers | Articles about risk managers, including profiles, |
| | Casualty | | | | | | promotions, accomplishmnets, conferences, |
| | | | | | | | professional designations and certifications. |
| Client Issues | Property | Trends | PCTR_KG6 | N0 | N07g_IN_AL_TRND | Safety Engineers | Articles about safety engineers, including profiles, |
| | Casualty | | | | | | promotions, accomplishmnets, conferences, |
| | | | | | | | professional designations and certifications. |
| Client Issues | Property | Trends | PCTR_KG7 | N0 | N07h_IN_AL_TRND | Contingency Planning | Planning to continue operations following a catastrophic |
| | Casualty | | | | | | event such as fire, workplace violence, earthquake, |
| | | | | | | | kidnapping, or other major, infrequent adverse event. |
| Client Issues | Property | Trends | PCTR_KG8 | N0 | N07i_IN_AL_TRND | Crisis Management | Continuing operations following a catastrophic event |
| | Casualty | | | | | | such as fire, workplace violence, earthquake, |
| | | | | | | | kidnapping, or other major, infrequent adverse event. |
| Client Issues | Property | Trends | PCTR_KG9 | N0 | N07j_IN_AL_TRND | Claims/Litigation | Managing an organization's insurance claims and |
| | Casualty | | | | | Management | lawsuits, including use of public adjusters, setting |
| | | | | | | | reserves, settling claims, choosing and monitoring |
| | | | | | | | counsel, and closing out old claims. |
| Insurance | All | Trends | PCTR_KH | N0 | N08_IN_AL_TRND | Competition Banks | Competition between Banks and Insurance Companies - |
| | | | | | | Insurers | Financial Services Reform Act - banks permitted to |
| | | | | | | | sell insurance; banks and insurers allowed to merge. |
| Insurance | All | Trends | PCTR_KI | N0 | N08a_IN_AL_TRND | Reinsurance Market | Availability, pricing, terms, products, trends, and |
| | | | | | | | providers and users of reinsurance and reinsurance |
| | | | | | | | services. |
| Insurance | All | Trends | PCTR_KJ | N0 | N08b_IN_AL_TRND | Bermuda Market | Availability, pricing, terms, products, trends, and |
| | | | | | | | providers and users of insurance, reinsurance, captive |
| | | | | | | | insurance, Protected Cell Companies, Special Purpose |
| | | | | | | | Vehicles, and other risk financing methods in the |
| | | | | | | | Bermuda market. |
| Insurance | All | Trends | PCTR_KK | N0 | N08c_IN_AL_TRND | London Market | Availability, pricing, terms, products, trends, and |
| | | | | | | | providers and users of insurance, reinsurance, and |
| | | | | | | | other risk financing methods in the London market, |
| | | | | | | | including the Lioyds market. |
| Insurance | All | Trends | PCTR_KL | N0 | N08d_IN_AL_TRND | Alternative Risk Transfer | Providers and users of self-insurance, finite insurance |
| | | | | | | Market | and reinsurance, captive insurance, Protected Cell |
| | | | | | | | Companies, Special Purpose Vehicles, risk |
| | | | | | | | securitization, capital markets risk financing, and other |
| | | | | | | | ART methods. |
| Insurance | All | Trends | PCTR_KM | N0 | N08e_IN_AL_TRND | Distribution Trends | Insurance distribution methods using brokers, |
| | | | | | | | independent agents, exclusive agents, Managing |
| | | | | | | | General Agents, direct writers, Insurance Web sites, |
| | | | | | | | banks and other financial institutions, associations, and |
| | | | | | | | other techniques for delivering insurance products to |
| | | | | | | | businesses. |
| Insurance | Benefits | Trends | | N2 | N09_IN_BN_TRND | Medicare Benefit | Medicare Benefit Levels and Requirements - Medicare |
| | | | | | | | (medical benefits for those over 65); Medicare HMOs; |
| | | | | | | | coordination of benefits between Medicare and retiree |
| | | | | | | | group health insurance program. |
| Insurance | Benefits | Trends | | N2 | N10_IN_BN_TRND | Pricing Underwriting | Pricing and Underwriting - higher benefit |
| | | | | | | | costs/insurance coverage premiums from medical |
| | | | | | | | inflation, prescription drug costs; exhaustion of managed |
| | | | | | | | care savings as cause of higher prices. |
| Insurance | All | New/Emerging | PCNE_LA | O0 | O01_IN_AL_ERMG | Exposures New | Exposures/Risks/Penis |
| | | | | | | | Too similar to Exposure Trends |
| Insurance | All | New/Emerging | PCNE_LB | O0 | O02_IN_AL_ERMG | Products New | Products |
| | | | | | | | Too Similar to Product Trends |
| Operational | Benefits | In or Out of | | O2 | O03_OP_BN_ERMG | In Network | In Network - medical/prescription services/products |
| | | Network | | | | | through providers approved by managed care |
| | | | | | | | organization, resulting in higher reimbursement/lower |
| | | | | | | | co-pay/lower deductible for patient; managed care |
| | | | | | | | network; network providers. |
| Operational | Benefits | In or Out of | | O2 | O04_OP_BN_ERMG | Out of Network | Out of Network - medical/prescription services/products |
| | | Network | | | | | through providers not approved by managed care |
| | | | | | | | organization, resulting in lower reimbursement/higher |
| | | | | | | | co-pay/higher deductible for patient; out-of-network care; |
| | | | | | | | our-of-network providers. |
| Operational | Benefits | Disciplines | | O2 | O05_OP_BN_ERMG | Benefit Plan Performance | Benefit Plan Performance Diagnostics - methods of |
| | | | | | | | calculating costs versus benefits of plans; benefit plan |
| | | | | | | | analytics; benefit plan ratio analysis. |
| Enterprise | Property | Demographics | | O1 | O06_EN_PC_ERMG | Employee Demographics | Employee Demographics - employee characteristics by |
| | Casualty | | | | | PC | age, sex, marital status, or geographic region, and their |
| | | | | | | | relation to workers' compensation, employment |
| | | | | | | | practices laibility, and other property/casualty coverages. |
| Enterprise | Benefits | Demographics | | O2 | O07_EN_BN_ERMG | Employee Demographics | Employee Demographics - employee characteristics by |
| | | | | | | Benefits | age, sex, marital status, or geographic region, and their |
| | | | | | | | relation to illnesses/injuries/prescription drug needs. |
| Enterprise | Property | Demographics | | O1 | O08_EN_PC_ERMG | Age Evolution PC | Age Evolution in Workforce, Age Driven Consumption - |
| | Casualty | | | | | | Demographics - “Graying”/Aging of the U.S. workforce |
| | | | | | | | and it effects on accidents, workers' compensation, age |
| | | | | | | | discrimination claims; “Graying” of America; Age |
| | | | | | | | Discrimination in Employment Act (ADEA). |
| Enterprise | Benefits | Demographics | | O2 | O09_EN_BN_ERMG | Age Evolution Benefits | Age Evolution in Workforce, Age Driven Consumption - |
| | | | | | | | Demographics - “Graying”/Aging of the U.S. workforce |
| | | | | | | | and it effects on accidents, medical costs, retirement |
| | | | | | | | benefits, prescription drug costs; “Graying” of America. |
| Operational | Benefits | Surveys | | O2 | O10_OP_BN_ERMG | Cost Experience | Cost Experience - Benefit costs broken down by |
| | | | | | | | industry group, geographic region, employer size, type |
| | | | | | | | of plans offered, etc. |
| Operational | Benefits | Surveys | | O2 | O11_OP_BN_ERMG | Payroll Deduction | Payroll Deduction - Benefit plans funded wholly or partly |
| | | | | | | | by employee payroll deductions; employee-paid |
| | | | | | | | benefits. |
| Operational | Benefits | Surveys | | O2 | O12_OP_BN_ERMG | Payment Plans | Payment Plans - Type of plans used by employers to |
| | | | | | | | pay for employee benefits; installment options. |
| Enterprise | Property | Tax/Accounting | | O1 | O13_EN_PC_ERMG | Tax Issues PC | Tax Issues - premium taxes; excess and surplus lines |
| | Casualty | Issues | | | | | taxes; deductibility of premiums paid to captive insurers; |
| | | | | | | | off-shore tax havens; income taxes; deductibility of loss |
| | | | | | | | reserves; balance sheet treatment of loss reserves. |
| Enterprise | Benefits | Tax/Accounting | | O2 | O14_EN_BN_ERMG | Tax Issues Benefits | Tax Issues - premium taxes; deductibility of premiums |
| | | Issues | | | | | paid to captive insurers; off-shore tax havens; income |
| | | | | | | | taxes; deductibility of loss reserves; balance sheet |
| | | | | | | | treatment of loss reserves; tax consequences of retiree |
| | | | | | | | benefits versus Medicare HMO. |
| Enterprise | Property | Tax/Accounting | | O1 | O15_EN_PC_ERMG | Accounting Issues PC | Accounting Issues - insurance accounting versus GAAP |
| | Casualty | Issues | | | | | (Generally Accepted Accounting Principles); insurer |
| | | | | | | | annual statements; balance sheet treatment of |
| | | | | | | | premiums and loss reserves. |
| Enterprise | Benefits | Tax/Accounting | | O2 | O16_EN_BN_ERMG | Accounting Issues | Accounting Issues - insurance accounting versus GAAP |
| | | Issues | | | | Benefits | (Generally Accepted Accounting Principles); insurer |
| | | | | | | | annual statements; balance sheet treatment of |
| | | | | | | | premiums and loss reserves. |
| Operational | Benefits | Benefits | | P2 | P01_OP_BN_PERF | Raw Costs | Raw Costs; loss costs; pure loss costs - cost of |
| | | Performance | | | | | benefits before administrative expenses added in. |
| Operational | Benefits | Benefits | | P2 | P02_OP_BN_PERF | Costs Going Up | How are Costs Going Up?; medical inflation; rise in |
| | | Performance | | | | | prescription drug costs; overutilization of services; higher |
| | | | | | | | benefit levels; more mandated benefits. |
| Operational | Benefits | Benefits | | P2 | P03_OP_BN_PERF | Shared Costs Practice | What are others doing regarding shared costs? |
| | | Performance | | | | | Purchasing groups; association/group captive insurance |
| | | | | | | | companies; employee contributions. |
| Operational | Benefits | Benefits | | P2 | P04_OP_BN_PERF | Payroll Deductions | What are others doing regarding payroll deductions? |
| | | Performance | | | | Practice | Prevalence and amount of employee payroll deductions |
| | | | | | | | to help fund benefit costs. |
| Operational | Benefits | Benefits | | P2 | P05_OP_BN_PERF | Employee Satisfaction | Employee Satisfaction with plan offerings, benefit levels, |
| | | Performance | | | | | co-payments; recruitment and retention based on benefit |
| | | | | | | | plan satisfaction. |
| Operational | Benefits | Benefits | | P2 | P06_OP_BN_PERF | Wage Replacement | Wage Replacement - Welfare - benefit that replaces |
| | | Performance | | | | Welfare | lost wages when employee suffers non-work-related |
| | | | | | | | injury or illness; indemnity; salary continuation. |
| Operational | Benefits | Benefits | | P2 | P07_OP_BN_PERF | Wage Replacement | Wage Replacement - Health - benefit that replaces lost |
| | | Performance | | | | Health | wages when employee suffers non-work-related injury or |
| | | | | | | | illness; indemnity; salary continuation. |
| Operational | Benefits | Benefits | | P2 | P08_OP_BN_PERF | ROI Health Care | ROI for Health Care Initiatives - “Return on Investment” |
| | | Performance | | | | | as measure of health plan success. |
| Operational | Benefits | Benefits | | P2 | P09_OP_BN_PERF | Medical Privacy | Medical Privacy - “Healthcare Bill of Rights”; Health |
| | | Performance | | | | | Insurance Portability and Accountability Act (HIPAA); |
| | | | | | | | medical records privacy. |
| Operational | Benefits | Benefits | | P2 | P10_OP_BN_PERF | Patients Bill Rights | Patients Bill of Rights; Health Insurance Portability and |
| | | Performance | | | | | Accountability Act; medical records privacy. |
| Operational | Benefits | Benefits | | P2 | P11_OP_BN_PERF | Patient Life Style | Patient Life Style - incorporating life-enhancing benefits |
| | | Performance | | | | | into plan; Viagra; fertility treatments; Employee |
| | | | | | | | Assistance Program (EAP). |
| Operational | Benefits | Benefits | | P2 | P12_OP_BN_PERF | Quality of Care | Quality of Care - rating care of hospital, physician, and |
| | | Performance | | | | | other providers; utilization review; accreditation. |
| Operational | Benefits | Benefits | | P2 | P13_OP_BN_PERF | Medical Errors | Medical Errors; medical malpractice; medical |
| | | Performance | | | | | professional liability; hospital malpractice; hospital |
| | | | | | | | professional liability; physicians & surgeons malpractice. |
| Enterprise | Property | Geographic | PCLO_GA | Q1 | Q01_EN_PC_GEOG | US Northeast | United States: Region/Catastrophe Zones |
| | Casualty | Region | | | | | Northeast: Connecticut, Delaware, Maine, Maryland, |
| | | | | | | | Massachusetts, New Hampshire, New Jersey, New |
| | | | | | | | York, Pennsylvania, Rhode Island, Vermont, |
| | | | | | | | Washington D.C., West Virginia |
| Enterprise | Property | Geographic | PCLO_GB | Q1 | Q02_EN_PC_GEOG | US Southeast | United States: Region/Catastrophe Zones |
| | Casualty | Region | | | | | Southeast: Florida, Georgia, North Carolina, South |
| | | | | | | | Carolina, Virginia |
| Enterprise | Property | Geographic | PCLO_GC | Q1 | Q03_EN_PC_GEOG | US Gulf | United States: Region/Catastrophe Zones |
| | Casualty | Region | | | | | Gulf States: Alabama, Louisiana, Missisippi, Texas |
| Enterprise | Property | Geographic | PCLO_GD | Q1 | Q04_EN_PC_GEOG | US Midwest | United States: Region/Catastrophe Zones |
| | Casualty | Region | | | | | Midwest: Arizona, Arkansas, Colorado, Idaho, Illinois, |
| | | | | | | | Indiana, Iowa, Kansas, Kentucky, Michigan, Minnesota, |
| | | | | | | | Missouri, Montana, Nebraska, Nevada, New Mexico, |
| | | | | | | | North Dakota, Ohio, Oklahoma, South Dakota, |
| | | | | | | | Tennessee, Utah, Wyoming, Wisconsin |
| Enterprise | Property | Geographic | PCLO_GE | Q1 | Q05_EN_PC_GEOG | US California | United States: Region/Catastrophe Zones |
| | Casualty | Region | | | | | California |
| Enterprise | Property | Geographic | PCLO_GF | Q1 | Q06_EN_PC_GEOG | US Northwest | United States: Region/Catastrophe Zones |
| | Casualty | Region | | | | | Northwest and Alaska: Alaska, Oregon, Washington |
| Enterprise | Property | Geographic | PCLO_GG | Q1 | Q07_EN_PC_GEOG | US Hawaii | United States: Region/Catastrophe Zones |
| | Casualty | Region | | | | | Hawaii |
| Enterprise | Benefits | Geographic | | Q2 | Q08_EN_BN_GEOG | US New England | New England |
| | | Region | | | | | Connecticut, Maine, Massachusetts, New Hampshire, |
| | | | | | | | Rhode Island, Vermont |
| Enterprise | Benefits | Geographic | | Q2 | Q09_EN_BN_GEOG | US Mid Atlantic | Mid-Atlantic |
| | | Region | | | | | New Jersey, New York, Pennsylvania |
| Enterprise | Benefits | Geographic | | Q2 | Q10_EN_BN_GEOG | US South Atlantic | South Atlantic |
| | | Region | | | | | Delaware, Florida, Georgia, Maryland, North Carolina, |
| | | | | | | | South Carolina, Virginia, Washington D.C., West Virginia |
| Enterprise | Benefits | Geographic | | Q2 | Q11_EN_BN_GEOG | US ENorth Central | East North Central |
| | | Region | | | | | Illinois, Indiana, Michigan, Ohio, Wisconsin |
| Enterprise | Benefits | Geographic | | Q2 | Q12_EN_BN_GEOG | US ESouth Central | East South Central |
| | | Region | | | | | Alabama, Kentucky, Missisippi, Tennessee |
| Enterprise | Benefits | Geographic | | Q2 | Q13_EN_BN_GEOG | US WNorth Central | West North Central |
| | | Region | | | | | Iowa, Kansas, Minnesota, Missouri, Nebraska, North |
| | | | | | | | Dakota, South Dakota |
| Enterprise | Benefits | Geographic | | Q2 | Q14_EN_BN_GEOG | US WSouth Central | West South Central |
| | | Region | | | | | Arkansas, Louisiana, Oklahoma, Texas |
| Enterprise | Benefits | Geographic | | Q2 | Q15_EN_BN_GEOG | US Mountain | Mountain |
| | | Region | | | | | Arizona, Colorado, Idaho, Montana, Nevada, New |
| | | | | | | | Mexico, Utah, Wyoming |
| Enterprise | Benefits | Geographic | | Q2 | Q16_EN_BN_GEOG | US Pacific | Pacific |
| | | Region | | | | | Alaska, Hawaii, California, Oregon, Washington |
| Enterprise | All | Geographic | PCLO_GH | Q0 | Q17_EN_AL_GEOG | Canada | Canada |
| | | Region | | | | | |
| Enterprise | All | Geographic | PCLO_GI | Q0 | Q18_EN_AL_GEOG | Latin America | Latin America |
| | | Region | | | | | |
| Enterprise | All | Geographic | PCLO_GJ | Q0 | Q19_EN_AL_GEOG | Europe | Europe |
| | | Region | | | | | |
| Enterprise | All | Geographic | PCLO_GK | Q0 | Q20_EN_AL_GEOG | Asia | Asia |
| | | Region | | | | | |
| Enterprise | All | Geographic | PCLO_GM | Q0 | Q21_EN_AL_GEOG | Australasia | Australia and Pacific Islands |
| | | Region | | | | | |
| Enterprise | All | Geographic | PCLO_GL | Q0 | Q22_EN_AL_GEOG | Africa | Africa |
| | | Region | | | | | |
| Enterprise | All | Client Industry | PCCL_MA | R0 | R01_EN_AL_INDU | Agriculture Tobacco | Agriculture and Tobacco |
| | | | | | | | SIC codes: 01; 02; 07; 08; 21 |
| | | | | | | | Agricultural cooperatives, grain and feed processing, |
| | | | | | | | crops including tobacco, livestock, forestry, |
| Enterprise | All | Client Industry | PCCL_MB | R0 | R02_EN_AL_INDU | Banks | Banks |
| | | | | | | | SIC codes: 60; 67 |
| | | | | | | | Banks, thrifts, and bank holding companies, excluding |
| | | | | | | | investment banks and finance companies. |
| Enterprise | All | Client Industry | PCCL_MC | R0 | R03_EN_AL_INDU | Chemicals | Chemicals |
| | | | | | | | SIC codes: 28 |
| | | | | | | | Chemicals, specialty chemicals, and allied products, |
| | | | | | | | excluding rubber, plastics, drugs, and pharmaceuticals. |
| Enterprise | All | Client Industry | PCCL_MD | R0 | R04_EN_AL_INDU | Communications | Communications |
| | | | | | | | SIC codes: 48 |
| | | | | | | | Broadcasting, including television and radio, and |
| | | | | | | | telecommunications, excluding printing and publishing. |
| Enterprise | All | Client Industry | PCCL_ME | R0 | R05_EN_AL_INDU | Construction | Construction |
| | | | | | | | SIC codes: 15; 16; 17 |
| | | | | | | | All building and heavy construction, general contractors, |
| | | | | | | | specialty trade contractors. |
| Enterprise | All | Client Industry | PCCL_MF | R0 | R06_EN_AL_INDU | Educational and | Educational and Non-Profit Institutions |
| | | | | | | NonProfit | SIC codes: 82; 83; 84; 86 |
| | | | | | | | Colleges, universities, and public school systems, and |
| | | | | | | | all non-profit Institutions. |
| Enterprise | All | Client Industry | PCCL_MG | R0 | R07_EN_AL_INDU | Electronic Electrical | Electronic and Electrical Equipment |
| | | | | | | Equipment | SIC codes: 36 |
| | | | | | | | Manufacturers of electronic and electrical equipment and |
| | | | | | | | components. |
| Enterprise | All | Client Industry | PCCL_MH | R0 | R08_EN_AL_INDU | Energy Oil Mining | Energy, Oil and Gas, and Mining |
| | | | | | | | SIC codes: 10; 12; 13; 14 |
| | | | | | | | Mining and metals extraction, energy resources, oil and |
| | | | | | | | gas operations. |
| Enterprise | All | Client Industry | PCCL_MI | R0 | R09_EN_AL_INDU | Food Processing | Food Processing and Distribution |
| | | | | | | Distribution | SIC codes: 20 |
| | | | | | | | Food processors and distributors, excluding agriculture |
| | | | | | | | and grain and feed processing. |
| Enterprise | All | Client Industry | PCCL_MJ | R0 | R10_EN_AL_INDU | Government | Government |
| | | | | | | | SIC codes: 43; 91; 92; 93; 94; 95; |
| | | | | | | | Federal, state, county, and city government agencies |
| | | | | | | | and authorities, excluding schools, port authorities, and |
| | | | | | | | transportation. |
| Enterprise | All | Client Industry | PCCL_MK | R0 | R11_EN_AL_INDU | Health Care | Health Care |
| | | | | | | | SIC codes: 80 |
| | | | | | | | Hospitals, nursing homes, physicians, and ancillary |
| | | | | | | | health services. |
| Enterprise | All | Client Industry | PCCL_ML | R0 | R12_EN_AL_INDU | Insurance Investment | Insurance, Investment, and Finance |
| | | | | | | Finance | SIC codes: 61; 62; 63; 64; 67 |
| | | | | | | | Insurance companies, HMOs, securities brokers, |
| | | | | | | | investment banks, mutual funds, finance companies, |
| | | | | | | | insurance agents and brokers. |
| Enterprise | All | Client Industry | PCCL_MM | R0 | R13_EN_AL_INDU | Lumber Furniture Paper | Lumber, Furniture, Paper, and Packaging |
| | | | | | | | SIC codes: 24; 25; 26 |
| | | | | | | | Lumber and wood products, furniture and fixtures, paper |
| | | | | | | | and allied products. |
| Enterprise | All | Client Industry | PCCL_MN | R0 | R14_EN_AL_INDU | Machinery Equipment | Machinery and Equipment Manufacturers |
| | | | | | | Manufacturers | SIC codes: 35 |
| | | | | | | | Industrial and commercial machinery and equipment |
| | | | | | | | manufacturing. |
| Enterprise | All | Client Industry | PCCL_MO | R0 | R15_EN_AL_INDU | Metals | Metals |
| | | | | | | | SIC codes: 31; 33; 34 |
| | | | | | | | Processing of aluminum, steel, and other metal |
| | | | | | | | products. |
| Enterprise | All | Client Industry | PCCL_MP | R0 | R16_EN_AL_INDU | Miscellaneous | Miscellaneous Manufacturing |
| | | | | | | Manufacturing | SIC codes: 28; 38; 39 |
| | | | | | | | All manufacturing except those in the more specific |
| | | | | | | | industry classes, this category includes drug and |
| | | | | | | | pharmaceutical manufacturing. |
| Enterprise | All | Client Industry | PCCL_MQ | R0 | R17_EN_AL_INDU | Printing Publishing | Printing and Publishing |
| | | | | | | | SIC codes: 27 |
| | | | | | | | Printing, publishing, and allied industries. |
| Enterprise | All | Client Industry | PCCL_MR | R0 | R18_EN_AL_INDU | Professional Personal | Professional and Personal Services |
| | | | | | | Services | SIC codes: 72; 73; 75; 76; 78; 79; |
| | | | | | | | All professional and personal services, including |
| | | | | | | | employment and entertainment, but excluding publishing |
| | | | | | | | and broadcasting. |
| Enterprise | All | Client Industry | PCCL_MS | R0 | R19_EN_AL_INDU | Real Estate Hotels | Real Estate, Hotels, and Hospitality |
| | | | | | | | SIC codes: 65; 70 |
| | | | | | | | Real estate operators, developers, managers, and |
| | | | | | | | agents, and hotels and others in the hospitality industry. |
| Enterprise | All | Client Industry | PCCL_MT | R0 | R20_EN_AL_INDU | Restaurants | Restaurants |
| | | | | | | | SIC codes: 58 |
| | | | | | | | All eating and drinking establishments. |
| Enterprise | All | Client Industry | PCCL_MU | R0 | R21_EN_AL_INDU | Retail Trade | Retail Trade |
| | | | | | | | SIC codes: 52, 53, 54; 55; 56; 57; |
| | | | | | | | All retail stores, and gas stations. |
| Enterprise | All | Client Industry | PCCL_MV | R0 | R22_EN_AL_INDU | Rubber Plastics Stone | Rubber, Plastics, Stone, and Cement |
| | | | | | | | SIC codes: 30; 32 |
| | | | | | | | Rubber and miscellaneous plastics, stone, cement, and |
| | | | | | | | related products. |
| Enterprise | All | Client Industry | PCCL_MW | R0 | R23_EN_AL_INDU | Software and Technology | Software and Technology |
| | | | | | | | SIC codes: 73 |
| | | | | | | | All software and electronics companies, excluding |
| | | | | | | | electronics manufacturing and telecommunications. |
| Enterprise | All | Client Industry | PCCL_MX | R0 | R24_EN_AL_INDU | Textile Products | Textile Products and Consumer Beverages |
| | | | | | | Beverages | SIC codes: 20; 22; 23 |
| | | | | | | | Food and kindred products, textile mill products, apparel |
| | | | | | | | and other finished products made from fabrics. |
| Enterprise | All | Client Industry | PCCL_MY | R0 | R25_EN_AL_INDU | Transportation Equipment | Transportation Equipment Manufacturers |
| | | | | | | Manufactures | SIC codes: 37 |
| | | | | | | | Transportation equipment manufacturing, including |
| | | | | | | | aviation and aerospace equipment. |
| Enterprise | All | Client Industry | PCCL_MZ | R0 | R26_EN_AL_INDU | Transportation Services | Transportation Services and Shipbuilding |
| | | | | | | Shipbuilding | SIC codes: 37; 40; 41; 42; 44; 47 |
| | | | | | | | Includes trucking/warehousing, public transport, ports |
| | | | | | | | and port authorities, shipbuilding and repair. |
| Enterprise | All | Client Industry | PCCL_M1 | R0 | R27_EN_AL_INDU | Utilities Electric | Utilities - Electric |
| | | | | | | | SIC codes: 49 |
| | | | | | | | Electric utilities only - not natural gas or combination |
| | | | | | | | utilities. |
| Enterprise | All | Client Industry | PCCL_M2 | R0 | R28_EN_AL_INDU | Utilities Gas Combination | Utilities - Gas and Combination |
| | | | | | | | SIC codes: 49 |
| | | | | | | | Natural gas and combination utilities - not electric |
| | | | | | | | utilities. |
| Enterprise | All | Client Industry | PCCL_M3 | R0 | R29_EN_AL_INDU | Wholesale Trade | Wholesale Trade |
| | | | | | | | SIC codes: 50; 51 |
| | | | | | | | All engaged in the wholesale distribution of products. |
| Hazard | Property | Industry Players | PCIP_FA | S1 | S01_HZ_PC_PLYR | Broker Property Casualty | Broker - represents the policyholder in an Insurance |
| | Casualty | | | | | | transaction with insurance companies: compensation - |
| | | | | | | | fees versus commissions; appropriateness of broker |
| | | | | | | | receipt of contingent commissions from insurers |
| Hazard | Property | Industry Players | PCIP_FB | S1 | S02_HZ_PC_PLYR | Insurer Property Casualty | Insurer - Underwrites and assumes the risk of loss in an |
| | Casually | | | | | | insurance transaction |
| Hazard | Property | Industry Players | PCIP_FC | S1 | S03_HZ_PC_PLYR | Reinsurer Property | Reinsurer - Assumes part of the risk of loss from |
| | Casualty | | | | | Casualty | insurers on individual policies or groups of policies |
| Hazard | Property | Industry Players | PCIP_FD | S1 | S04_HZ_PC_PLYR | TPA Property Casualty | Third-Party Administrator - Settles claims or provides |
| | Casualty | | | | | | other insurance-related services to self-insured firms, or |
| | | | | | | | on a contract basis on behalf of insurers. |
| Hazard | Property | Industry Players | PCIP_FE | S1 | S05_HZ_PC_PLYR | MGA MGU | Managing General Agent/Managing General Underwriter - |
| | Casualty | | | | | | An agent that receives underwriting authority from an |
| | | | | | | | insurer for specific lines of business or programs. |
| Hazard | Property | Industry Players | PCIP_FF | S1 | S06_HZ_PC_PLYR | Consultant Property | Consultant - provides risk management advice for a fee, |
| | Casualty | | | | | Casualty | does not sell insurance or receive commissions. |
| Hazard | Property | Industry Players | PCIP_FG | S1 | S07_HZ_PC_PLYR | Regulator Property | Regulator - State or federal government agency |
| | Casualty | | | | | Casualty | overseeing some aspect of the business of insurance: |
| | | | | | | | trend toward deregulation of commercial insurance |
| | | | | | | | rates, rules, and policy forms. |
| Hazard | Property | Industry Players | PCIP_FH | S1 | S08_HZ_PC_PLYR | Rating Agency PC | Rating Agency - an independent company that rates the |
| | Casualty | | | | | | financial stability or claims-paying ability of insurers. |
| Hazard | Property | Industry Players | PCIP_FI | S1 | S09_HZ_PC_PLYR | Association Property | Association - a group of insurers, brokers, |
| | Casually | | | | | Casualty | policyholders, or other group bandiing together to further |
| | | | | | | | their mutual interests: trend - consolidation of |
| | | | | | | | associations to achieve more lobbying power. |
| Hazard | Property | Industry Players | PCIP_FJ | S1 | S10_HZ_PC_PLYR | Others PC Players | Others |
| | Casualty | | | | | | |
| Hazard | Property | Industry Players | PCIP_FK | S1 | S11_HZ_PC_PLYR | All Industry PC | All Industry |
| | Casualty | | | | | | |
| Operational | Benefits | Industry Players | | S2 | S12_OP_BN_PLYR | Indemnity Insurer | Indemnity Insurer - “fee for service” (FFS) plan - |
| | | | | | | Benefits | patient pays provider and is then reimbursed by insurer; |
| Operational | Benefits | Industry Players | | S2 | S13_OP_BN_PLYR | For Profit MCO | For-Profit MCO - Managed Care Organizaion operating |
| | | | | | | | on for-profit basis. |
| Operational | Benefits | Industry Players | | S2 | S14_OP_BN_PLYR | Not ForProfit MCO | Not-For-Profit MCO - Managed Care Organization |
| | | | | | | | operating on a not-for-profit basis. |
| Operational | Benefits | Industry Players | | S2 | S15_OP_BN_PLYR | Blue Cross Plan | Blue Cross Plan - Blue Cross; Blue Shield “the Blues” - |
| | | | | | | | Managed Care Organization affiliated with Blue Cross. |
| Operational | Benefits | Industry Players | | S2 | S16_OP_BN_PLYR | Reinsurer | Re-Insurance Company - takes portion of risk from |
| | | | | | | | primary insurance company; reinsurer; retrocessionaire. |
| Operational | Benefits | Industry Players | | S2 | S17_OP_BN_PLYR | Dental Maintenance | Dental Maintenance Organization - Managed Care |
| | | | | | | Organization | Organization specializing in dental coverage; Dental |
| | | | | | | | HMO; Dental PPO. |
| Operational | Benefits | Industry Players | | S2 | S18_OP_BN_PLYR | PPO Network Manager | PPO - Network Manager - Chief administrator of |
| | | | | | | | Preferred Provider Organization providers. |
| Operational | Benefits | Industry Players | | S2 | S19_OP_BN_PLYR | Disease State | Disease State Management Company - provider |
| | | | | | | Management | handling serious/costly/catastrophic diseases. |
| Operational | Benefits | Industry Players | | S2 | S20_OP_BN_PLYR | Utilization Management | Utilization Management Company - firm that analyzes |
| | | | | | | Company | appropriateness of medical care already provided or to |
| | | | | | | | be provided; utilization review. |
| Operational | Benefits | Industry Players | | S2 | S21_OP_BN_PLYR | Third Party Claims | Third Party Claims Administrator - outside firm hired to |
| | | | | | | | settle claims on hehalf of self-insured employer or |
| | | | | | | | insurance company. |
| Operational | Benefits | Industry Players | | S2 | S22_OP_BN_PLYR | Actuarial Firm | Actuarial Firm - calculates insurance rates, analyzes |
| | | | | | | | loss trends; insurance statistics; actuary; actuarial |
| | | | | | | | consultant. |
| Operational | Benefits | Industry Players | | S2 | S23_OP_BN_PLYR | Health Welfare | Health and Welfare Consultant; - provides benefits |
| | | | | | | Consultant | advice and services for a fee; employee benefits |
| | | | | | | | consultant; insurance consultant. |
| Operational | Benefits | Industry Players | | S2 | S24_OP_BN_PLYR | Benefit Managers | Benefit Manager - manages insured and self-insured |
| | | | | | | | employee benefit programs of the employer. |
| Operational | Benefits | Industry Players | | S2 | S25_OP_BN_PLYR | Broker Benefits | Broker - negotiates and places on behalf of |
| | | | | | | | employer/client health insurance policies and other |
| | | | | | | | benefits with insurers; health insurance broker; health |
| | | | | | | | insurance agent; health insurance intermediary. |
| Operational | Benefits | Industry Players | | S2 | S26_OP_BN_PLYR | EAP Administrator | EAP Administrator - runs an Employee Assistance |
| | | | | | | | Program providing help to employees with drug/alcohol |
| | | | | | | | or other problems; drug/alcohol counselor; employee |
| | | | | | | | rehabilitation counselor. |
| Operational | Benefits | Industry Players | | S2 | S27_OP_BN_PLYR | Pharmacy Benefit | Pharmacy Benefit Manager - administers prescription |
| | | | | | | Manager | benefits program; prescription drug manager; Rx |
| | | | | | | | manager. |
| Operational | Benefits | Industry Players | | S2 | S28_OP_BN_PLYR | Behavioral Health | Behavioral Health Manager - administers benefit |
| | | | | | | Manager | program covering mental/emotional/behavioral |
| | | | | | | | problems; mental health program manager. |
| Operational | Benefits | Industry Players | | S2 | S29_OP_BN_PLYR | Vision Service Provider | Vision Service Provider - administers vision program |
| | | | | | | | provided as benefit to employees; eyeglass benefit, |
| | | | | | | | optometric/ophthalmic services provider. |
| | System | Exclude Tag | | | X01_EB_SY_EXCL | Exclusion Tag 01 | TBD |
| | System | Exclude Tag | | | X02_EB_SY_EXCL | Exclusion Tag 02 | TBD |
| | System | Exclude Tag | | | X03_EB_SY_EXCL | Exclusion Tag 03 | TBD |
| | System | Exclude Tag | | | X04_EB_SY_EXCL | Exclusion Tag 04 | TBD |
| | System | Exclude Tag | | | X05_EB_SY_EXCL | Exclusion Tag 05 | TBD |
| | System | Exclude Tag | | | X06_EB_SY_EXCL | Exclusion Tag 06 | TBD |
| | System | Exclude Tag | | | X07_EB_SY_EXCL | Exclusion Tag 07 | TBD |
| | System | Exclude Tag | | | X08_EB_SY_EXCL | Exclusion Tag 08 | TBD |
| | System | Exclude Tag | | | X09_EB_SY_EXCL | Exclusion Tag 09 | TBD |
| | System | Exclude Tag | | | X10_EB_SY_EXCL | Exclusion Tag 10 | TBD |
| Enterprise | All | Company Name | | | Y01_EN_AL_NAME | Client Name | Client Name |
| Hazard | Property | Company Name | | | Y02_HZ_PC_NAME | Property Casualty Player | Property Casualty Player |
| | Casualty | | | | | | |
| Operational | Benefits | Company Name | | | Y03_OP_BN_NAME | Benefits Player | Benefits Player |
| Insurance | All | General | PCXX_ZA | Z0 | Z01_IN_AL_GNRL | Any Trends | Any document about Industry Trends |
| Insurance | All | General | PCXX_ZB | Z0 | Z02_IN_AL_GNRL | Any Litigation | Any Document about Litigation |
| Insurance | All | General | PCXX_ZC | Z0 | Z03_IN_AL_GNRL | Any Legislation | Any Document about Legislation or Regulation |
| | | | | | | Regulation | |
| Insurance | All | General | PCXX_ZD | Z0 | Z04_IN_AL_GNRL | Any Demographics | Any Document about Demographics |

Sources:
NGEN: General News
NRSK: Risk Industry News
JRNL: Journal
WHTP: White Paper (Monograph/Thesis/etc.)
BOOK: Book
AREP: Analyst Report
FNCL: Financial Statements/SEC Filing
COM: .com (Commercial Web Site)

1-3. (canceled)

4. A system for providing information on risks and related hedging strategies, said system comprising:
a plurality of client terminals coupled to said system, said client terminals providing access to said system for accessing information on risks and related hedging strategies;
a data aggregation module configured to store financial and risk related information from a plurality of data sources, said data sources including private client data sources and public data sources;
an analytical module coupled to said data aggregation module, said analytical module configured to perform benchmarking estimates based on information retrieved from said private client data sources and said public data sources.

5. The system in accordance with claim 4, wherein said private client data sources include asset information corresponding to each client whose information is stored in said data aggregation module, said asset information including one or more of asset categories from a list comprising real estate assets, automobile assets, inventory assets, technology assets and heavy equipment assets.

6. The system in accordance with claim 5, wherein said private client data sources include legal information, insurance policy information, claims information, and legal information.

7. The system in accordance with claim 6, wherein said private client data sources include financial information such as payroll and general ledger information.

8. The system in accordance with claim 7, wherein said analytical module further comprises a company comparison module configured to perform comparison of key information of companies specified by a user employing one of said client terminals.

9. The system in accordance with claim 7, wherein said analytical module further comprises modules configured to perform one or more functions from a list including league table calculations, risk mapping, risk accounting, claims data, loss triangles, loss development analysis and severity Monte Carlo simulations.

10. The system in accordance with claim 9, wherein said loss triangle calculation includes calculation of loss history within a specified period of time, so as to provide information on how losses and coverages have developed over time.

11. A system for providing information on risks and related hedging strategies, said system comprising:
a plurality of client terminals coupled to said system, said client terminals providing access to said system for accessing information on risks and related hedging strategies;
a data aggregation module configured to store financial and risk related information from a plurality of data sources, said data sources including private client data sources and public data sources;
an administrative efficiency tool module coupled to said data aggregation module, said administrative efficiency tool module further comprising a user policy data input module configured to receive information relating to insurance coverages of an organization, wherein said insurance coverage information is stored in said private client data source.

12. The system in accordance with claim 11 further comprising a single period insurance analyzer that determines and charts a list of specified insurance policies of an organization extended over a specified period.

13. The system in accordance with claim 12, wherein said charts include various portions that identify the type of insurance coverage, the policy amount, and corresponding effective date.

14. The system in accordance with claim 13, further comprising a multiple period single insurance analyzer, configured to provide a visual table that summarizes a single insurance program of an organization within multiple periods.

15. The system in accordance with claim 1I further comprising a look up table module configured to generate comparison tables that set forth various insurance related regulations corresponding to various jurisdictions so as to allow a user to assess the benefits and trade offs between each jurisdiction.

16. The system in accordance with claim 15 wherein said comparison tables relate to captive domicile insurance information.

17. The system in accordance with claim 11 wherein said administrative efficiency tool is further configured to allow a user to select an insurance topic so as to generate a list of all jurisdictions that have corresponding regulations relating to that topic.

18. The system in accordance with claim 17 wherein said jurisdictions include federal, state and international law topics relating to a desired topic, so as to provide look up comparisons relating to each of said jurisdictions.

19. The system in accordance with claim 11 further comprising a league table module configured to provide various insurance ratings.

20. The system in accordance with claim 11 further comprising a policy form module configured to provide a table for comparing language in a plurality of prior policy forms so as to show how various policies have treated a certain topic by providing examples of prior forms.

21. A system for providing information on risks and related hedging strategies, said system comprising:
a plurality of client terminals coupled to said system, said client terminals providing access to said system for accessing information on risks and related hedging strategies;
a data aggregation module configured to store financial and risk related information from a plurality of data sources, said data sources including private client data sources and public data sources;
an analytical module coupled to said data aggregation module, said analytical module configured to perform benchmarking estimates based on information retrieved from said private client data sources and said public data sources;
an administrative efficiency tool module coupled to said data aggregation module, said administrative efficiency tool module further comprising a user policy data input module configured to receive information relating to insurance coverages of an organization, wherein said insurance coverage information is stored in said private client data source; and
a workspace administrator module coupled to said analytical module and said administrative efficiency tool and configured to provide a plurality of interface template sets each of said template sets defining a plurality of task assignments provided as a workflow relating to an insurance practice project.

22. The system in accordance with claim 21 wherein one of said template sets relate to claims and loss analysis.

23. The system in accordance with claim 21, wherein one of said template sets relate to mergers and acquisition analysis.

24. The system in accordance with claim 21, wherein one of said template sets relate to a renewal of insurance process.

25. The system in accordance with claim 21, wherein one of said template sets relate to exposure analysis.

26. The system in accordance with claim 21, wherein one of said template sets relate to insurance administration process.

27. The system in accordance with claim 21, wherein one of said template sets relate to researching insurance clients.

28. The system in accordance with claim 21, wherein one of said template sets relate to developing new insurance products.

29. The system in accordance with claim 21, wherein at least one of said template sets is user specific so as to allow a user to define a desired workflow management.
